(19) United States
(12) Patent Application Publication
(10) Pub. No.: US 2014/0005301 A1
(43) Pub. Date: Jan. 2, 2014

(54) SULFONIUM SULFATES, THEIR PREPARATION AND USE

(71) Applicants: Kazuhiko Kunimoto, Kawanishi (JP); Hisatoshi Kura, Takarazuka-shi (JP)

(72) Inventors: Kazuhiko Kunimoto, Kawanishi (JP); Hisatoshi Kura, Takarazuka-shi (JP)

(73) Assignee: BASF SE, Ludwigshafen (DE)

(21) Appl. No.: 14/001,296

(22) PCT Filed: Feb. 22, 2012
(86) PCT No.: PCT/EP2012/053011

§ 371 Date: Aug. 23, 2013

Related U.S. Application Data
(60) Provisional application No. 61/445,569, filed on Feb. 23, 2011.

(30) Foreign Application Priority Data
Feb. 23, 2011 (EP) 11155646.0

(51) Int. Cl. C08G 59/68

(52) U.S. Cl. CPC C08G 59/687
USPC 523/400; 558/24; 558/37; 549/80; 562/36; 560/151; 558/20; 558/31; 549/497; 549/58; 528/90; 427/385.5

(57) ABSTRACT

The present invention relates to a heat-curable composition comprising (a) at least one compound which is capable of undergoing cationic polymerization; and (b) at least one sulfonium sulfate selected from compounds of the formulae Ia and Ib where Yⁿ⁻ is a monovalent or divalent anion selected from (1) where n, M, R¹ to R¹⁰ are as defined in claim 1 and in the description. The present invention also relates to novel sulfonium sulfates of the formulae Ia and Ib, to a process for curing cationically polymerizable material and to the cured material obtained by said process.

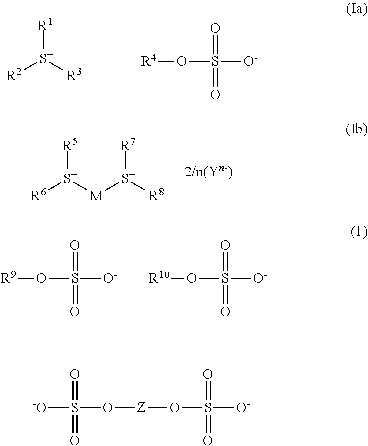

### BACKGROUND OF THE INVENTION

The present invention relates to heat-curable compositions comprising at least one sulfonium sulfate, to novel sulfonium sulfates, to a process for curing cationically polymerizable material and to the cured material obtained by said process.

### DESCRIPTION OF THE RELATED ART

Cationic polymerization is initiated by a cation generated from a cationic polymerization initiator. The catalysts known for cationic polymerization include sulfonium salts. Sulfonium salts showing the highest activity are those in which the anion component of the sulfonium salt is antimony hexafluoride (SbF₆⁻), antimony hexachloride (SbCl₆⁻), and SbF₅(OH)⁻. However, antimony is a highly toxic substance and is not desirable for practical use. Commercially available untoxic sulfonium salts such as sulfonium phosphates have the drawback that their curing performance is insufficient.

WO 2009/047152 discloses sulfonium salts of the general formula [R₁R₂R₃S]⁺[Y] as photoinitiators and their use in photocurable compositions. R₁ and R₂ are optionally substituted phenyl and R₃ is optionally substituted alkyl, alkenyl, cycloalkyl, cycloalkenyl or aryl and Y is an inorganic or organic anion such as halogen or C₁-C₂-alkyl sulfate, or sulfonate. Concrete embodiments for sulfonium sulfphates are not disclosed.

US 2004/0053158 discloses a chemically amplified photoresist composition comprising, (a) a compound which cures upon the action of an acid or a compound whose solubility is increased upon the action of an acid; and (b) as photosensitive acid donor, at least one iodonium or sulfonium salt. Concrete embodiments for sulfonium sulfates are triphenylsulfonium 4-tert-butylphenylsulfate, triphenylsulfonium benzylsulfate and triphenylsulfonium 2-isopropyl-5-methylcyclohexanesulfate

U.S. Pat. No. 5,374,697 discloses diphenylcycloalkylsulfonium compounds which are useful as initiators for the thermal cure of cationically polymerizsable material. The counter ion is a non-nucleophilic anion such as a halide or perchlorate or a complex anion of the structure [M(Hal)ₙ]^{(m-n)}, where M is an atom of the third to fifth main group of the periodic table an Hal means halogen.

U.S. Pat. No. 5,013,814 discloses arylaliphtic sulfonium compounds, where the counterion is selected from SbF₆⁻, AsF₆ and SbF₅(OH)⁻ for use in curable mixtures containing cationically polymerizable compounds.

EP 1400856 relates to a method of making a printing plate from a heat-sensitive PS plate of a positive-working mode for lithographic printing including the steps of exposing the heat-sensitive PS plate to light and developing the PS plate using an alkaline developing solution containing at least one compound selected from the group consisting of cationic surfactants and compounds having three or more of an ethylene oxide-terminal group in the molecule thereof. The cationic surfactant can be an amine salt, ammonium salt, phosphonium salt or sulfonium salt. A concrete embodiment is benzyldodecylmethyl methylsulfate.

EP 0511405 describes compositions containing a cationic polymerization catalyst, a cationically polymerizable organic material and as stabilizer at least one onium salt having a nucleophilic pair anion chosen from halogenide, perchlorate, alkyl sulfate and p-toluenesulfonate ion. The cationic polymerization catalyst is a sulfonium or ammonium hexafluorophosphate or hexafluoroantimonate. The cationic polymerizable organic material is e.g. an epoxy compound, a vinyl compound or cyclic ether. In the concrete embodiments of the onium salts, 3,5-di-tert-butyl-4-hydroxydimethylsulfonium methyl sulfate and compounds of the formula

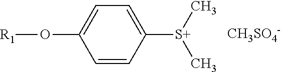

where R₁ is hydrogen, benzyloxycarbonyl, methylcarbonyl, tridecylcarbonyl, 9-fluorenyloxycarbonyl, tert-butyloxycarbonyl or 4-methoxybenzyloxycarbonyl are disclosed.

GB 509,871 describes sulfonium salts in which the anion component of the sulfonium salt is a sulfate such as methylsulfate, n-dodecylsulfate, cetylsulfate or p-chlorethylsulfate. The sulfonium sulfates have foaming, emulsifying and wetting properties. JP 2006 028132 relates to sulfonium compounds with no corrosion of reactors and methods for corrosion inhibition. Concrete examples for sulfonium compounds are 4-acetoxyphenyldimethylsulfonium methylsulfate and 4-hydroxyphenylbenzylmethylsulfonium methylsulfate. JP 2007091702 discloses dimethylarylsulfonium sulfate compounds and their use as thermal polymerization catalyst for cationically-polymerizable monomers.

H. M. Gilow et al. studied in Journal of Organic Chemistry, 1968, 33(1), 230-233 the chlorination and bromination of dimethylphenylsulfonium methylsulfate in the presence of silver ion.

L. Veniard et al. describe in Comptes Rendus des Séances de l'Académie des Sciences, Série C: Sciences chimiques, 1971, 273(18), 1190-1193 propargylsulfonium methylsulfates.

A. A. Abduvkhabov et al., Khimiko-Farmatsevticheskii Zhurnal, 1988, 22(8), 966-969 discloses trialkylsulfonium methylsulfates and their interaction with human erythrocyte acetylcholinesterase and horse serum butyrylcholinesterase.

A. Piccinini et al., in Organic Letters, vol. 12, no. 3, pages 608-611 studied the activity of sulfides as catalysts for sulfonium-ylide mediated methylene transfer to aldehydes. A suitable methylating agent is 1-methyltetrahydrothiophenium methylsulfate.

GB 1,424,148 describes 1,4-dithiane salts as agents for regulating plant growth. The anion component of the sulfonium salt is halide, especially chloride, bromide and iodide, tetrafluoroborate or alkysulfate, especially methylsulfate or ethylsulfate.

U.S. Pat. No. 2,972,571 relates to sulfonium sulfonates and sulfates as brightener in the electrodeposition of bright nickel.

U.S. Pat. No. 4,167,618 relates to a polymerization process for aziridine compounds such as for examples, ethyleneimine (aziridine), substituted aziridines and aziridine derivatives (e.g., 2-ethyleneimino-ethanol, N-butyl-ethyleneimine, ethyleneiminosuccinic aciddimethyl ester, and the like) and other compounds (e.g., polyethers) containing aziridino end groups. Suitable polymerization initiators are trialkylsulfonium salts of the formula

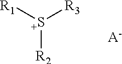

where A⁻ is a non-nucleophilic anion, preferably fluoroborate, sulfonate, nitrate, perchlorate, methosulfate or fluorosulfate, R₁ is C₁-C₁₈-alkyl, R₂ is C₁-C₁₈-alkyl or a phenyl alkyl radical with 7 to 18 carbon atoms, where the alkyl radicals may contain an ester group and/or an ether group and R₃ is an alkyl radical carrying an electron attracting radical on the carbon atom in R-position in relation to the sulfur atom beside at least one hydrogen atom. In the concrete embodiments, R₁ is methyl, R₂ is dodecyl, R₃ is —CH₂—CH₂—COOC₂H and A⁻ is methosulfate; R₁ is ethyl, R₂ is dodecyl, R₃ is —CH₂—CH₂—COOC₈H₁₇ and A⁻ is dodecyl sulfate, ethyl sulfate or 2-ethylhexyl sulfate; R₁ is ethyl, R₂ is CH₂—OC(O)C₁₂H₂₅, R₃ is —CH₂—CH₂—COOC₈H₁₇ and A⁻ is 2-ethylhexyl sulfate; R₁ is ethyl, R₂ is dodecyl, R₃ is 2-cyano-1-methyl-ethyl and A⁻ is dodecyl sulfate, ethyl sulfate or 2-ethylhexyl sulfate.

JP 6199770 describes onium salts and their use in radiation sensitive resin compositions. A suitable onium salt is

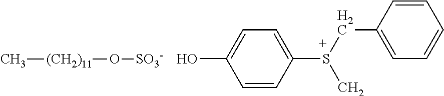

having the Cas No. 160878-60-4.

The sulfonium salt having the registry number 126515-92-2

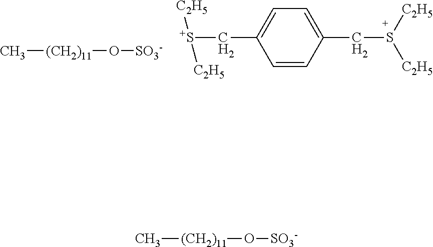

is known from Thin Solid Films, 179 (1989), 191-197. The salt serves as amphiphilic precursor polymer for the preparation of a poly(p-phenylenevinylene) Langmuir-Blodgett film.

There is a great need for non-toxic thermal acid generators (TAG) with good application properties such as a high curing activity. Surprisingly, it has been found that this object is solved by specific sulfonium sulfates as described below.

The present invention is based on the object, therefore, of providing a non-toxic thermal acid generator having a good curing performance.

### SUMMARY OF THE INVENTION

In a first aspect, the invention provides a heat-curable composition comprising
(a) at least one compound which is capable of undergoing cationic polymerization; and
(b) at least one sulfonium sulfate selected from compounds of the formulae Ia and Ib

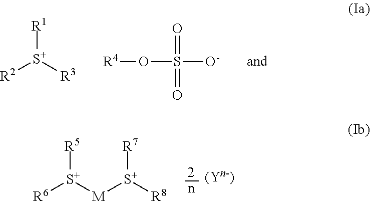

where
Yⁿ⁻ is a mono- or divalent anion selected from

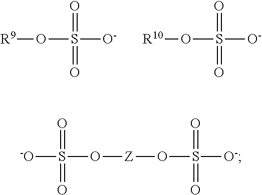

n is 1 or 2;
R¹ is C₁-C₂₀-alkyl, C₃-C₂₀-cycloalkyl, heterocycloalkyl, a group A or a group B,
   where C₁-C₂₀-alkyl may be substituted by one or more identical or different radicals R^{1a} and/or may be interrupted by one or more non-adjacent groups selected from —O—, —S—, —C(O)— and —N(R^{N})—, where
   R^{1a} is F, Cl, Br, I, CN, SR¹⁹, OR²⁰, COR²¹, COOR²², CONR²³R²⁴; C₃-C₂₀— cycloalkyl or heterocycloalkyl, where the two last-mentioned radicals may be interrupted by one or more CO groups, and/or may carry one or more identical or different radicals R^{1ab},
      where
      R^{1ab} is F, Cl, Br, I, C₁-C₁₂-alkyl, C₁-C₁₂-haloalkyl, CN, SR¹⁹, OR²⁰, COR²¹, COOR²² or CONR²³R²⁴;
   where C₃-C₂₀-cycloalkyl and heterocycloalkyl may be interrupted by one or more CO groups and/or may be substituted by one or more identical or different radicals R^{1b},
   where
   R^{1b} is F, Cl, Br, I, C₁-C₁₂-alkyl, C₁-C₁₂-haloalkyl, CN, SR¹⁹, OR²⁰, COR²¹, COOR²² or CONR²³R²⁴;
   where the group of the formula A is

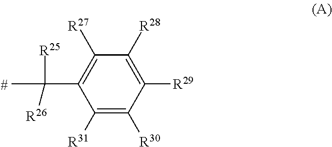

in which
# is the point of attachment to the sulfonium atom,
and where the group of the formula B is

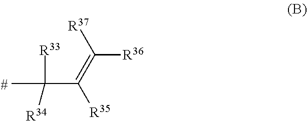

in which
# is the point of attachment to the sulfonium atom,
with the proviso that R¹ is the group A or the group B, if R² and R³ are both selected from the group consisting of C₁-C₂₀-alkyl; C₁-C₂₀-alkyl substituted by one or more radicals R^{2a}; C₁-C₂₀-alkyl which is interrupted by one or more non-adjacent groups selected from —O—, —S—, —C(O)—, and —N(R^{N)}); C₁-C₂₀-alkyl which is interrupted by one or more non-adjacent groups selected from —O—, —S—, —C(O)—, and —N(R^{N)}) and substituted by one or more radicals R^{2a}; C₃-C₂₀-cycloalkyl; C₃-C₂₀-cycloalkyl interrupted by one or more CO groups; C₃-C₂₀-cycloalkyl substituted by one or more radicals R^{2b}; and C₃-C₂₀-cycloalkyl interrupted by one or more CO groups and substituted by one or more radicals R^{2b}.
R² and R³ are selected independently of one another from C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
   where C₁-C₂₀-alkyl, C₂-C₂₀-alkenyl and C₂-C₂₀-alkynyl may be substituted by one or more identical or different radicals R^{2a} and/or may be interrupted by one or more non-adjacent groups selected from —O—, —S—, —C(O)— and —N(R^{N})—, where C₃-C₂₀-cycloalkyl and heterocycloalkyl may be interrupted by one or more CO groups, and/or may carry one or more identical or different radicals R^{2b},
   where C₆-C₂₀-aryl and heteroaryl may be substituted by one or more identical or different radicals R^{2c},
   where
   R^{2a} is selected from F, Cl, Br, I, CN, SR¹⁹, OR²⁰, COR²¹, COOR²², CONR²³R²⁴; C₃-C₂₀-cycloalkyl and heterocycloalkyl, where the two last-mentioned radicals may be interrupted by one or more CO groups and/or may be substituted by one or more identical or different radicals R^{2ab},
      and also from the group consisting of heteroaryl and C₆-C₁₀-aryl, where the two last-mentioned radicals may be substituted by one or more identical or different radicals R^{2ac},
      where
      R^{2ab} has one of the meanings indicated for R^{1ab},
      R^{2ac} is F, Cl, Br, I, C₁-C₁₂-alkyl, C₁-C₁₂-haloalkyl, CN, NO₂, SR¹⁹, OR²⁰, COR²¹, COOR²² or CONR²³R²⁴;
   R^{2b} is F, Cl, Br, I, C₁-C₁₂-alkyl, C₁-C₁₂-haloalkyl, CN, SR¹⁹, OR²⁰, COR²¹, COOR²², CONR²³R²⁴; C₆-C₁₀-aryl or heteroaryl where the two last-mentioned radicals may be substituted by one or more identical or different radicals R^{2bc},
      where
      R^{2bc} has one of the meanings indicated for R^{2ac};
   R^{2c} is F, Cl, Br, I, C₁-C₁₂-alkyl, C₁-C₁₂ haloalkyl, CN, NO₂, SR¹⁹, OR²⁰, COR²¹, COOR²², CONR²³R²⁴, phenyl,
      C₃-C₁₀-cycloalkyl or heterocycloalkyl where the two last-mentioned radicals may be interrupted by one or more CO groups;
         or
R¹ and R² or R¹ and R³ may together form a straight-chain C₂-C₆-alkylene group, a straight-chain C₂-C₆-alkenylene group, or a —(CH₂)ₐ—C₆H₄—(CH₂)_{b} group, where a and b are an integer from 0 to 10 and the sum of a and b is 1 to 10, where alkylene, alkenylene and the alkylene moiety of —(CH₂)ₐ—C₆H₄—(CH₂)_{b} may be substituted by one or more identical or different radicals R³² and/or may be interrupted by one or more non-adjacent groups selected from —O—, —S—, —C(O)— and —N(R^{N})—;
   or
R² and R³ may together form a straight-chain C₂-C₆-alkylene, a straight-chain C₂-C₆-alkenylene, or a straight-chain —(CH₂)_{c}—C₆H₄—(CH₂)d group, where c and d are an integer from 0 to 10 and the sum of c and d is 1 to 10, where alkylene, alkenylene and the alkylene moiety of —(CH₂)_{c}—C₆H₄—(CH₂)d may be substituted by one or more identical or different radicals R³² and/or may be fused to 1 or 2 phenyl rings and/or may be interrupted by one or more non-adjacent groups selected from —O—, —S—, —C(O)— and —N(R^{N})—;
R⁴ is C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² or —N═CR¹³R¹⁴,
   where C₁-C₂₀-alkyl, C₂-C₂₀-alkenyl and C₂-C₂₀-alkynyl may be substituted by one or more identical or different radicals R^{4a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{4b}, and
   where C₆-C₂₀-aryl and heteroaryl may be substituted by one or more identical or different radicals R^{4c}, where
   R^{4a} is selected from F, Cl, Br, I, CN, SR¹⁹, OR²⁰, COR²¹, COOR²², CONR²³R²⁴, C₃-C₂₀-cycloalkyl and heterocycloalkyl where the 2 last-mentioned radicals may be interrupted by one or more CO groups and/or may be substituted by one or more identical or different radicals R^{4ab}, and also from the group consisting of heteroaryl and C₆-C₁₀-aryl, where the two last-mentioned radicals may be substituted by one or more identical or different radicals R^{4ac}, where
      R^{4ab} has one of the meanings indicated for R^{1ab},
      R^{4ac} has one of the meanings indicated for R^{2ac}, and
      in addition, if 2 radicals R^{4a} are geminally bound, the 2 radicals R^{4a} together may also form an N-hydroxyimino group;
   R^{4b} is F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl or heteroaryl, where the two last-mentioned radicals may be substituted by one or more identical or different radicals R^{4bc}, where
      R^{4bc} has one of the meanings indicated for R^{2bc};
   R^{4c} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where two last-mentioned radicals may be interrupted by one or more CO groups;
R⁵, R⁶, R⁷ and R⁸ are selected independently of one another from C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
   where C₁-C₂₀-alkyl, C₂-C₂₀-alkenyl and C₂-C₂₀-alkynyl may be substituted by one or more identical or different radicals R^{5a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{5b},
   where C₆-C₂₀-aryl and heteroaryl may be substituted by one or more identical or different radicals R^{5c}, where
   R^{5a} has one of the meanings indicated for R^{2a},
   R^{5b} has one of the meanings indicated for R^{2b},
   R^{5c} has one of the meanings indicated for R^{2c};
      or
R⁵ and R⁶ and/or R⁷ and R⁸ may together form a straight-chain C₂-C₆-alkylene, a straight-chain C₂-C₆-alkenylene or a straight-chain —(CH₂)_{c}—C₆H₄—(CH₂)d group, where c and d are an integer from 0 to 10 and the sum of c and d is 1 to 10, where alkylene, alkenylene and the alkylene moiety of —(CH₂)_{c}—C₆H₄—(CH₂)d may be substituted by one or more identical or different radicals R³² and/or may be fused to 1 or 2 phenyl rings and/or may be interrupted by one or more non-adjacent groups selected from —O—, —S—, —C(O)— and —N(R^{N})—;
R⁹ and R¹⁰ are independently of one another selected from C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² and —N═CR¹³R¹⁴,
   where C₁-C₂₀-alkyl, C₂-C₂₀-alkenyl and C₂-C₂₀-alkynyl may be substituted by one or more identical or different radicals R^{9a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{9b},
   where C₆-C₂₀-aryl and heteroaryl may be substituted by one or more identical or different radicals R^{9c}, where
   R^{9a} has one of the meanings indicated for R^{4a},
   R^{9b} has one of the meanings indicated for R^{4b},
   R^{9c} has one of the meanings indicated for Roc;
R¹¹ and R¹² are independently of one another selected from hydrogen, C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, C₂-C₂₀-alkanoyl, C₃-C₂₀-alkenoyl and C₆-C₁₀-aroyl,
   where C₁-C₂₀-alkyl, C₂-C₂₀-alkenyl and C₂-C₂₀-alkynyl may be substituted by one or more identical or different radicals R^{11a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or CO groups and/or may be substituted by one or more identical or different radicals R^{11b},
   where C₆-C₂₀-aryl and heteroaryl may be may be substituted by one or more identical or different radicals R^{11c},
   where C₂-C₂₀-alkanoyl and C₃-C₂₀-alkenoyl may be substituted by one or more identical or different radicals R^{11d},
   where C₆-C₁₀-aroyl may be substituted by one or more identical or different radicals R^{11e},
   R^{11a} has one of the meanings indicated for R^{2a},
   R^{11b} has one of the meanings indicated for R^{2b},
   R^{11c} has one of the meanings indicated for R^{2c},
   R^{11d} is F, Cl, Br, I, CN, NO₂, SR¹⁹, OR²⁰, COR²¹, COOR²² or CONR²³R²⁴;
   R^{11e} is F, Cl, Br, I, C₁-C₁₂-alkyl, C₁-C₁₂-haloalkyl, CN, NO₂, SR¹⁹, OR²⁰, COR²¹, COOR²² or CONR²³R²⁴;
      or
R¹¹ and R¹² may together form a straight-chain C₂-C₅-alkylene or a straight-chain C₂-C₅-alkenylene chain, where alkylene and alkenylene may be substituted by one or more identical or different radicals R^{11f} and/or may be interrupted by one or more non-adjacent groups selected from —O—, —S—, —C(O)— and —N(R^{N})—,
   or
R¹¹ and R¹² may together form an o-phenylenedicarbonyl or 1,8-naphthalenedicarbonyl group, where the two last mentioned radicals may be substituted by one or more identical or different radicals R^{11f},
   where
   R^{11f} has one of the meanings indicated for R^{11e};
R¹³ and R¹⁴ are, independently of one another, selected from hydrogen, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aroyl, C₆-C₂₀-aryl and heteroaryl,
   where C₁-C₂₀-alkyl, C₂-C₂₀-alkenyl and C₂-C₂₀-alkynyl may be substituted by one or more identical or different radicals R^{13a} and/or may be interrupted by one or more non-adjacent groups selected from —O—, —S— —C(O)— and —N(R^{N})—,
   where C₃-C₂₀-cycloalkyl and heterocycloalkyl may be interrupted by one or more CO groups and/or may be substituted by one or more identical or different radicals R^{13b},
   where C₆-C₂₀-aroyl, C₆-C₂₀-aryl and C₅-C₂₀-heteroaryl may be substituted by one or more identical or different radicals R^{13c},
   where
   R^{13a} is selected from F, Cl, Br, I, CN, SR¹⁹, OR²⁰, COR²¹, COOR²², CONR²³R²⁴, C₃-C₂₀-cycloalkyl and heterocycloalkyl where the 2 last-mentioned radicals may be interrupted by one or more CO groups and/or may be substituted by one or more identical or different radicals R^{13ab},
      and also from the group consisting of phenyl and phenyl which is substituted by one or more identical or different radicals R^{13ac},
      where
      R^{13ab} has one of the meanings indicated for R^{1ab},
      R^{13ac} has one of the meanings indicated for R^{2ac};
   R^{13b} is F, Cl, Br, I, C₁-C₁₂-alkyl, C₁-C₁₂-haloalkyl, CN, SR¹⁹, OR²⁰, COR²¹, COOR²², CONR²³R²⁴, phenyl or phenyl which is substituted by one or more identical or different radicals R^{13bc}, where
      R^{13bc} has one of the meanings indicated for R^{2ac};
   R^{13c} has one of the meanings indicated for R^{4c};
   or
R¹³ and R¹⁴ may together form a straight-chain C₂-C₆-alkylene or a straight-chain C₂-C₆-alkenylene chain, where alkylene and alkenylene may be substituted by one or more identical or different radicals R³² and/or may be interrupted by one or more non-adjacent groups selected from —O—, —S—, —C(O)— and —N(R^{N})—;
R¹⁹ and R²⁰ are selected independently of one another from hydrogen, C₁-C₂₀-alkyl, C₂-C₁₂-alkenyl,
   C₃-C₁₀-cycloalkyl, heterocycloalkyl, where the two last-mentioned radicals may be interrupted by one or more CO groups,
   C₁-C₂₀-alkyl which is interrupted by one or more non-adjacent groups selected from —O—, —S—, —C(O)— and —N(R^{N})—,
   C₁-C₈-alkyl substituted by one or more identical or different radicals R^{19a},
   —(CH₂CH₂O)ₘH with m being 1-20,
   —(CH₂CH₂O)ₙ(CO)—(C₁-C₈-alkyl) with n being 1-20,
   C₂-C₈-alkanoyl, C₂-C₈-haloalkanoyl, C₃-C₆-alkenoyl, benzoyl where the last-mentioned radical may be substituted by one or more radicals selected independently of one another from F, Cl, Br, I, C₁-C₆-alkyl, OH and C₁-C₄-alkoxy,
   phenyl, naphthyl, where the two last-mentioned radicals may be substituted by one or more identical or different radicals R^{19c},
   or phenyl or naphthyl which forms a 5- or 6-membered ring via the phenyl ring to which SR¹⁹ or OR²⁰, respectively, is attached via a single bond, C₁-C₄-alkylene, O, S, CO or NR²³
   where
   R^{19a} is F, Cl, Br, I, OH, SH, CN, C₃-C₁₀-cycloalkyl, heterocycloalkyl, phenyl, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl),
   R^{19c} is F, Cl, Br, I, C₁-C₁₂-alkyl, C₁-C₁₂-haloalkyl, C₁-C₁₂-alkoxy, phenyl-C₁-C₃-alkyloxy, phenoxy, C₁-C₁₂-alkylsulfanyl, phenylsulfanyl, —(CO)O(C₁-C₈-alkyl), (CO)N(C₁-C₈-alkyl)₂ or phenyl;
R²¹ is selected independently of one another from hydrogen, C₁-C₂₀-alkyl, C₂-C₁₂-alkenyl,
   C₁-C₂₀-alkyl which is interrupted by one or more non-adjacent groups selected from —O—, —S—, —CO— and —N(R^{N})—,
   C₁-C₈-alkyl substituted by one or more identical or different radicals R^{21a},
   —(CH₂CH₂O)ₒH with o being 1-20,
   —(CH₂CH₂O)ₚ(CO)—(C₁-C₈-alkyl) with p being 1-20,
   C₃-C₁₀-cycloalkyl, heterocycloalkyl, where the two last-mentioned radicals may be interrupted by one or more CO groups,
   C₆-C₂₀-aryl and heteroaryl, where the two last-mentioned radicals may be substituted by one or more radicals identical or different radicals R^{21c},
   where
   R^{21a} is F, Cl, Br, I, OH, SH, CN, phenyl, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl), and
   R^{21c} has one of the meanings indicated for R^{19c};
R²² is selected independently of one another from hydrogen, C₁-C₂₀-alkyl, C₂-C₁₂-alkenyl,
   C₂-C₂₀-alkyl which is interrupted by one or more non-adjacent groups selected from —O—, —S—, —C(O)— and —NR^{N}—,
   C₁-C₈-alkyl substituted by one or more identical or different radicals R^{22a},
   —(CH₂CH₂O)_{q}H with q being 1-20,
   —(CH₂CH₂O)ᵣ(CO)—(C₁-C₈-alkyl) with r being 1-20,
   C₃-C₁₀-cycloalkyl, heteroycloalkyl, where the two last-mentioned radicals may be interrupted by one or more CO groups,
   phenyl and naphthyl, where the two last-mentioned radicals may be substituted by one or more identical or different radicals R^{22c},
   where
   R^{22a} is F, Cl, Br, I, OH, SH, CN, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH, —(CO)O(C₁-C₈-alkyl), phenyl or naphthyl, where the two last-mentioned radicals may be substituted by one or more identical or different radicals R^{22ac}, where
      R^{22ac} has one of the meanings indicated for R^{19c};
   R^{22c} has one of the meanings indicated for R^{19c};
R²³ and R²⁴ are, independently of one another, selected from hydrogen, OR²⁰, C₁-C₂₀-alkyl, C₂-C₁₂-alkenyl,
   C₂-C₂₀-alkyl which is interrupted by one or more non-adjacent groups selected from —O—, —S—, —C(O)— and —NR^{N}—,
   C₁-C₈-alkyl substituted by one or more identical or different radicals R^{23a},
   —(CH₂CH₂O)ₛH with s being 1-20,
   —(CH₂CH₂O)ₜ(CO)—(C₁-C₈-alkyl) with t being 1-20,
   C₂-C₈-alkanoyl, C₂-C₈-haloalkanoyl, C₃-C₆-alkenoyl, benzoyl which may be substituted by one or more identical or different radicals selected from F, Cl, Br, I, C₁-C₆-alkyl, —OH and C₁-C₄-alkoxy,
   C₃-C₁₀-cycloalkyl, heterocycloalkyl, where the two last-mentioned radicals may be interrupted by one or more CO groups,
   phenyl and naphthyl, where the two last-mentioned radicals may be substituted by one or more identical or different radicals R^{23c},
   where
   R^{23a} is F, Cl, Br, I, OH, SH, CN, phenyl, C₃-C₆-alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl),
   R^{23c} has one of the meanings indicated for R^{19c};
      or
R²³ and R²⁴ together may form a C₂-C₅-alkylene group, which may be interrupted by one or more non-adjacent groups selected from —O—, —S—, —C(O)— and —N(R^{N})—;
R²⁵ and R²⁶ are, each independently of one another, selected from hydrogen, F, Cl, Br, I, CN, NO₂, SR¹⁹, OR²⁰, COR²¹, COOR²², CONR²³R²⁴, C₁-C₂₀-alkyl, C₃-C₂₀-cycloalkyl, heterocycloalkyl, C₆-C₂₀-aryl and heteroaryl,
   where C₁-C₂₀-alkyl may be interrupted by one or more non-adjacent groups selected from —O—, —S—, —C(O)— and —N(R^{N})— and/or may be substituted by one or more identical or different radicals R^{25a},
   where C₃-C₂₀-cycloalkyl and heterocycloalkyl may be interrupted by one or more CO groups and/or may be substituted by one or more identical or different radicals R^{25b}, and
   where C₆-C₂₀-aryl and heteroaryl may be substituted by one or more identical or different radicals R^{25c}, where
   R^{25a} has one of the meanings indicated for R^{13a};
   R^{25b} has one of the meanings indicated for R^{13b};
   R^{25c} has one of the meanings indicated for R^{13c};
R²⁷, R²⁸, R²⁹, R³⁰ and R³¹ are, each independently of one another, selected from hydrogen, F, Cl, Br, I, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
   where C₁-C₂₀-alkyl, C₂-C₂₀-alkenyl and C₂-C₂₀-alkynyl may be substituted one or more radicals identical or different radicals R^{27a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{27b},
   where C₆-C₂₀-aryl and heteroaryl may be substituted by one or more identical or different radicals R^{27c},
   where
   R^{27a} has one of the meanings indicated for R^{13a};
   R^{27b} has one of the meanings indicated for R^{13b};
   R^{27c} has one of the meanings indicated for R^{13c};
      or
two radicals R²⁷ and R²⁸, R²⁸ and R²⁹, R²⁹ and R³⁰ and/or R³⁰ and R³¹ may together form a straight-chain C₂-C₆-alkylene or a straight-chain C₂-C₆-alkenylene group, where the alkylene group and the alkenylene group may be substituted by one or more identical or different radicals R³² and/or may be fused to 1 or 2 C₆-C₁₀-aryl rings and/or may be interrupted by one or more non-adjacent groups selected from —O—, —S—, —C(O)— and —N(R^{N})—,
   or
R²⁵ and R²⁷ may together form a C₂-C₆-alkylene chain, where alkylene may be substituted by one or more radicals R³² and/or may be interrupted by one or more non-adjacent groups selected from —O—, —S—, —C(O)— and —N(R^{N})—,
   or
R²⁵ and R²⁷ may together form a 1,2-phenylene group, where 1,2-phenylene may be substituted by one or more identical or different radicals R³²;
R³² is F, Cl, Br, I, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl;
   where C₁-C₂₀-alkyl, C₂-C₂₀-alkenyl and C₂-C₂₀-alkynyl may be interrupted by one or more non-adjacent groups selected from —O—, —S—, —C(O)— and —N(R^{N})— and/or may be substituted one or more radicals identical or different R^{32a},
   where C₃-C₂₀-cycloalkyl and heterocycloalkyl may be interrupted by one or more CO groups and/or may be substituted by one or more identical or different radicals R^{32b},
   where C₆-C₂₀-aryl and heteroaryl may be substituted by one or more radicals identical or different R^{32c}, where
   R^{32a} has one of the meanings indicated for R^{13a};
   R^{32b} has one of the meanings indicated for R^{13b}; and
   R^{32c} has one of the meanings indicated for R^{13c};
R³³ and R³⁴ are, each independently of one another are selected from hydrogen, F, Cl, Br, I, CN, NO₂, SR¹⁹, OR²⁰, COR²¹, COOR²², CONR²³R²⁴, C₁-C₂₀-alkyl, C₃-C₂₀-cycloalkyl, heterocycloalkyl, C₆-C₂₀-aryl and heteroaryl,
   where C₁-C₂₀-alkyl may be may be substituted by one or more radicals R^{33a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{33b}, and
   where C₆-C₂₀-aryl and heteroaryl may be substituted by one or more identical or different radicals R^{33c}, where
   R^{33a} has one of the meanings indicated for R^{13a};
   R^{33b} has one of the meanings indicated for R^{13b};
   R^{33c} has one of the meanings indicated for R^{13c};
R³⁵, R³⁶ and R³⁷, each independently of one another are selected from hydrogen, F, Cl, Br, I, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
   where C₁-C₂₀-alkyl, C₂-C₂₀-alkenyl and C₂-C₂₀-alkynyl may be substituted by one or more identical or different radicals R^{35a} and/or may be interrupted by one or more non-adjacent groups selected from —O—, —S—, —C(O)— and —N(R^{N})—,
   where C₃-C₂₀-cycloalkyl and heterocycloalkyl may be substituted by one or more identical or different radicals R^{35b}, and
   where C₆-C₂₀-aryl and heteroaryl may be substituted by one or more identical or different radicals R^{35c}, where
   R^{35a} has one of the meanings indicated for R^{27a};
   R^{35b} has one of the meanings indicated for R^{27b};
   R^{35c} has one of the meanings indicated for R^{27c};
   or
R³⁵ and R³⁶ may together form a straight-chain C₂-C₆-alkylene or a straight-chain C₂-C₆-alkenylene group, where alkylene and alkenylene may be substituted by one or more radicals identical or different R³² and/or may be interrupted by one or more non-adjacent groups selected from —O—, —S—, —C(O)— and —N(R^{N})—,
   or
   two radicals R³³ and R³⁵, R³³ and R³⁷, R³⁴ and R³⁵ and/or R³⁴ and R³⁷ may together form a straight-chain C₂-C₆-alkylene group, where the alkylene group may be substituted by one or more identical or different radicals R³² and/or may be interrupted by one or more non-adjacent groups selected from —O—, —S—, —C(O)— and —N(R^{N})—;
M is a divalent radical selected from C₁-C₂₀-alkylene, C₂-C₂₀-alkenylene, C₂-C₂₀-alkynylene, C₃-C₂₀-cycloalkylene, heterocycloalkylene, C₆-C₂₀-arylene and heteroarylene,
   where C₁-C₂₀-alkylene, C₂-C₂₀-alkenylene and C₂-C₂₀-alkynylene may be substituted by one or more identical or different radicals R^{Ma} and/or may be interrupted by one or more non-adjacent groups R^{Mi},
   where C₃-C₂₀-cycloalkylene and heterocycloalkylene may be interrupted by one or more CO groups and/or may be substituted by one or more radicals R^{Mb};
   where C₆-C₂₀-arylene and heteroarylene may be substituted by one or more radicals R^{Mc},
   where
   R^{Mi} is selected from —O—, —S—, —C(O)—, OC(O)—, —N(R^{N})—, C₃-C₂₀-cycloalkylene, —O—C₃-C₂₀-cycloalkylene, —O—C₃-C₂₀-cycloalkylene-O—, heterocycloalkylene, C₆-C₂₀-arylene, —O—C₆-C₂₀-arylene, —O—C₆-C₂₀-arylene-O—, —S—C₆-C₂₀-arylene, —S—C₆-C₂₀-arylene-S— and heteroarylene,
      where each cycloalkylene and heterocycloalkylene may be interrupted by one or more CO groups and/or may be substituted by one or more identical or different radicals R^{Mib}, and
      where each arylene and heteroarylene may be substituted by one or more radicals R^{Mic},
   R^{Ma} is F, Cl, Br, I, CN, SR¹⁹, OR²⁰, COR²¹, COOR²², CONR²³R²⁴, C₆-C₁₀-aryl or heteroaryl where the 2 last-mentioned radicals may be substituted by one or more identical or different radicals selected from C₁-C₁₂-alkyl, C₁-C₁₂-haloalkyl, F, Cl, Br, I, CN, NO₂, SR¹⁹, OR²⁰, COR²¹, COOR²² and CONR²³R²⁴;
      R^{Mib} is F, Cl, Br, I, C₁-C₁₂-alkyl, C₁-C₁₂-haloalkyl, CN, NO₂, SR¹⁹, OR²⁰, COR²¹, COOR²², CONR²³R²⁴ or phenyl;
   R^{Mic} is F, Cl, Br, I, C₁-C₁₂-alkyl, C₁-C₁₂-haloalkyl, CN, NO₂, SR¹⁹, OR²⁰, COR²¹, COOR²², CONR²³R²⁴ or phenyl;
   R^{Mb} is F, Cl, Br, I, C₁-C₁₂-alkyl, C₁-C₁₂-haloalkyl, CN, SR¹⁹, OR²⁰, COR²¹, COOR²²; CONR²³R²⁴, C₆-C₁₀-aryl or heteroaryl, where the 2 last-mentioned radicals may be substituted by one or more identical or different radicals selected from C₁-C₁₂-alkyl, C₁-C₁₂-haloalkyl, F, Cl, Br, I, CN, NO₂, SR¹⁹, OR²⁰, COR²¹, COOR²² or CONR²³R²⁴;
   R^{Mc} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where the two last-mentioned radicals may be interrupted by one or more CO groups;
Z is C₁-C₂₀-alkylene or C₆-C₂₀-arylene,
   where C₁-C₂₀-alkylene may be interrupted by one or more nonadjacent groups R^{Zi} and/or may be substituted by one or more identical or different radicals R^{Za}, and
   where C₆-C₂₀-arylene may be substituted by one or more radicals R^{Zc},
   where
   R^{Zi} has one of the meanings indicated for R^{Mi},
   R^{Za} has one of the meanings indicated for R^{Ma},
   R^{Zc} has one of the meanings indicated for R^{Mc},
RN is selected independently of one another from hydrogen, C₁-C₂₀ alkyl, C₁-C₁₀-alkanoyl, C₆-C₁₀-aroyl, C₁-C₂₀-alkylsulfonyl, C₂-C₂₀-alkenylsulfonyl, C₆-C₁₀-arylsulfonyl, C₃-C₁₀-cycloalkyl, heterocycloalkyl, C₆-C₁₀-aryl and heteroaryl, where C₃-C₁₀-cycloalkyl and heterocycloalkyl may be interrupted by one or more CO groups.
   and the stereoisomers and tautomers thereof.

In a second aspect, the invention provides novel sulfonium sulfates of the formula Ia

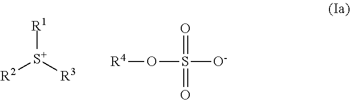

wherein
R¹, R² and R³ are as defined above and
R⁴ is selected from C₁-C₂-alkyl, C₃-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² and —N═CR¹³R¹⁴,
   where C₁-C₂-alkyl is substituted by one or more radicals identical or different radicals R^{4a},
   where C₃-C₂₀-alkyl, C₂-C₂₀-alkenyl and C₂-C₂₀-alkynyl may be substituted by one or more identical or different radicals R^{4a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{4b},
   where C₆-C₂₀-aryl and heteroaryl may be substituted by one or more identical or different radicals Roc, where
   R^{4a} is F, Cl, Br, I, CN, SR¹⁹, OR²⁰, COR²¹, COOR²², CONR²³R²⁴, C₃-C₂₀-cycloalkyl, heterocycloalkyl where the 2 last-mentioned radicals may be interrupted by one or more CO groups and/or may be substituted by one or more identical or different radicals R^{4ab},
   heteroaryl or C₆-C₁₀-aryl, where the two last-mentioned radicals may be substituted by one or more identical or different radicals R^{4ac}, where
   R^{4ab} is as defined above,
   R^{4ac} is as defined above, and
   in addition, if 2 radicals R^{4a} are geminally bound, the 2 radicals R^{4a} together may also form an N-hydroxyimino group;
   R^{ab} is F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl or heteroaryl, where the two last-mentioned radicals may be substituted by one or more identical or different radicals R^{4bc}, where
   R^{4bc} is as defined above,
   R^{4c} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where two last-mentioned radicals may be interrupted by one or more CO groups;
      where R^{N}, R¹¹, R¹², R¹³, R¹⁴, R¹⁹, R²⁰, R²¹, R²², R²³ and R²⁴ are as defined above,
      and the stereoisomers or tautomers thereof,
      except for compounds Ia, where
   R¹ is methyl, R² is benzyl, R³ is 4-hydroxyphenyl and R⁴ is n-dodecyl.

In a further aspect, the invention provides novel sulfonium sulfates of the formula Ib except for compounds Ib, where
R⁵, R⁶, R⁷ and R⁸ are each ethyl, M is 1,4-CH₂—C₆H₄—CH₂ and R⁹ and R¹⁹ are each n-dodecyl.

In a further aspect, the invention provides a method for curing a cationic polymerizable composition, which method comprises applying a composition comprising
(a) at least one compound which is capable of undergoing cationic polymerization, preferably a compound having at least one group selected from an epoxy group, oxetane group and vinyl ether group; and
(b) at least one sulfonium sulfate selected from compounds of the formulae Ia and Ib as defined above
   to a substrate and exposing the composition to treatment with heat.

In a further aspect, the invention provides the use of a heat-curable composition as defined above.

### DESCRIPTION OF THE INVENTION

The term “steroisomers” encompasses both optical isomers, such as enantiomers or diastereomers, the latter existing due to more than one center of chirality in the molecule, as well as geometrical isomers (cis/trans isomers). Depending on the substitution pattern, the compounds of the formulae Ia and Ib may have one or more centers of chirality, in which case they are present as mixtures of enantiomers or diastereomers. The invention provides both the pure enantiomers or diastereomers and their mixtures and the use according to the invention of the pure enantiomers or diastereomers of the compound Ia and Ib or its mixtures. Suitable compounds of the formulae Ia and Ib also include all possible geometrical stereoisomers (cis/trans isomers) and mixtures thereof. Cis/trans isomers may be present with respect to a carbon-carbon double bond.

For the purpose of the present invention the term halogen denotes fluorine, chlorine, bromine or iodine, particularly fluorine or chlorine.

The term “alkyl” as used herein refers to saturated straight-chain or branched hydrocarbon radicals having usually 1 to 4, to 6, to 8, to 12, to 16 or to 20 carbon atoms. Alkyl is preferably C₁-C₁₂-alkyl and more preferably C₁-C₈-alkyl. Examples of alkyl groups are especially methyl, ethyl, n-propyl, isopropyl, n-butyl, isobutyl, sec-butyl, tert-butyl, n-pentyl, neo-pentyl, n-hexyl, n-heptyl, n-octyl, n-nonyl, n-decyl, n-undecyl, n-dodecyl, n-tridecyl, n-tetradecyl, n-hexadecyl, n-octadecyl and n-eicosyl.

Alkyl radicals interrupted by non-adjacent groups selected from —O—, —S— —C(O)— and —NR^{N}— may be interrupted by one or more, e.g. 1, 2, 3, 4, 5, 6, 7, 8 or more than 8 of the above-mentioned groups, i.e, the termini of the alkyl group are formed by carbon atoms. R^{N} is as defined above. If a plurality of those interrupting groups selected from O, S and NR^{N} occurs in the radical alkyl, those heteroatoms are usually identical. Examples for alkyl interrupted by one or more O-atoms are —CH₂—O—CH₃, —CH₂CH₂—O—CH₂CH₃, —[CH₂CH₂O]—CH₃, with y=1-9, —(CH₂CH₂O)₇CH₂CH₃, —CH₂—CH(CH₃)—O—CH₂—CH₂CH₃, and —CH₂—CH(CH₃)—O—CH₂CH₃. A skilled person will readily understand that alkyl interrupted by 1 oxygen atom may also be referred to as alkoxy-alkyl or alkyl interrupted by 2 oxygen atoms may also be referred to as alkoxyalkoxy-alkyl. Likewise, alkyl interrupted by 1 sulfur atom may also be referred to as alkyl-5-alkyl (alkylsulfanyl-alkyl) or, alkyl interrupted by 2 sulfur atoms may also be referred to as alkyl-5-alkyl-S-alkyl (alkylsulfanyl-alkylsulfanyl-alkyl).

Substituted alkyl groups may, depending on the length of the alkyl chain, have one or more (e.g. 1, 2, 3, 4, 5 or more than 5) identical or different substituents. In the case of halogen substituted alkyl, the alkyl group can be partially of fully halogenated and/or may carry further substituents.

Examples for haloalkyl are C₁-C₂₀-fluoroalkyl, C₁-C₂₀ chloroalkyl and C₁-C₂₀-bromoalkyl, such as chloromethyl, trichloromethyl, fluoromethyl, difluoromethyl, trifluoromethyl, 2,2,2,-trifluoroethyl and 2-bromopropyl.

An example for alkyl substituted by cycloalkyl, where cycloalkyl is interrupted by one

CO group and carries one or more alkyl groups is camphoryl, especially camphor-10-yl

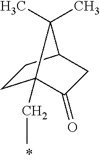

where * is the point of attachment to the remainder of the molecule.

The term “alkoxy” as used herein refers to a saturated straight-chain or branched, alkyl radical having usually 1 to 4, to 6, to 8, to 12, to 16 or to 20 carbon atoms which is attached via an oxygen atom to the remainder of the molecule. Examples are methoxy, ethoxy, propoxy, isopropoxy, n-butyloxy, sec-butyloxy, iso-butyloxy, tert-butyloxy, pentyloxy, hexyloxy, heptyloxy, 2,4,4-trimethylpentyloxy, 2-ethylhexyloxy, octyloxy, nonyloxy, decyloxy, dodecyloxy, hexadecyloxy, octadecyloxy or icosyloxy, in particular methoxy, ethoxy, propoxy, isopropoxy, n-butyloxy, sec-butyloxy, iso-butyloxy, tert-butyloxy, especially methoxy.

The term “phenylalkoxy” as used herein refers to phenyl, which is bound via an alkoxy group having preferably 1 to 4 carbon atoms, in particular a 1 or 2 carbon atoms, to the remainder of the molecule, examples including phenoxymethyl, 1-phenoxyethyl, 2-phenoxyethyl, and the like

The term “alkylsulfanyl” as used herein refers to a saturated straight-chain or branched, alkyl radical having 1 to 4, to 6, to 8, to 12, to 16 or to 20 carbon atoms as defined above which is attached via a sulfur atom to the remainder of the molecule. Examples are methylsulfanyl, ethylsulfanyl, propylsulfanyl, isopropylsulfanyl, n-butylsulfanyl, sec-butylsulfanyl, isobutylsulfanyl and tert-butylsulfanyl.

The term “C₂-C₈-alkanoyl” (C₁-C₇-alkyl-C(═O)—) as used herein refers to a saturated straight-chain or branched alkyl radical having 1 to 7 carbon atoms attached through the carbon atom of the carbonyl group at any position in the alkyl group, for example acetyl, propanoyl, 2-methyl-propanoyl, butanoyl, pentanoyl, hexanoyl.

The term “Cₘ—Cₙ-alkoxycarbonyl” (Cₘ—Cₙ-alkyl-O—C(O)—) as used herein refers to a saturated straight-chain or branched alkoxy radical having m to n carbon atoms as defined above attached through the carbon atom of the carbonyl group to the remainder of the molecule. Examples are methoxycarbonyl, ethoxycarbonyl, propoxycarbonyl, butoxycarbonyl, isobutoxycarbonyl or pentoxycarbonyl.

The term “alkenyl” as used herein refers to mono- or polyunsaturated, straight-chain or branched hydrocarbon radicals having usually 2 to 20, preferably 2 to 16, more preferably 2 to 10 carbon atoms, having one or more, e.g. 1, 2, 3 or more than two double bonds, e.g., C₂-C₆-alkenyl having one double bond such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, or alkadienyl having usually 4 to 10 carbon atoms and two double bonds in any position, for example 1,3-butadienyl, 1,3-pentadienyl, hexa-1,4-dien-1-yl, hexa-1,4-dien-3-yl, hexa-1,4-dien-6-yl, hepta-1,4-dien-7-yl, hepta-1,5-dien-1-yl and the like.

Alkenyl radicals interrupted by non-adjacent groups selected from —O—, —S—, —C(O)— and —NR^{N}— may be interrupted by one or more e.g. 1, 2, 3, 4, 5, 6, 7 or 8, of the above-mentioned groups, i.e, the termini of the alkenyl group are formed by carbon atoms. R^{N} is as defined above. If a plurality of those interrupting heteroatoms or heteroatomic groups selected from O, S and NR^{N} occurs, they are usually identical.

Substituted alkenyl groups may, depending on the length of the alkenyl chain, have one or more (e.g. 1, 2, 3, 4, 5 or more than 5) identical or different substituents. In the case of halogen substituted alkenyl, the alkenyl group can be partially of fully halogenated and/or may carry further substituents.

The term “haloalkenyl” as used herein, which is also expressed as “alkenyl which may be substituted by halogen”, refers to unsaturated straight-chain or branched hydrocarbon radicals having one or more double bonds (as mentioned above), where some or all of the hydrogen atoms in these groups are replaced by halogen atoms as mentioned above, in particular fluorine, chlorine and bromine. Examples for haloalkenyl are C₂-C₂₀-fluoroalkenyl, C₂-C₂₀ chloroalkenyl and C₂-C₂₀-bromoalkenyl.

The term “C₃-C₆-alkenoxy” as used herein refers to a mono- or diunsaturated straight-chain or branched alkenyl radical having 3 to 6 carbon atoms as defined above linked via an oxygen atom to the remainder of the molecule. Examples are vinyloxy, 1-propenyloxy, 2-propenyloxy, 1-methylethenyloxy, 1-butenyloxy, 2-butenyloxy, 3-butenyloxy, 1-methyl-1-propenyloxy, 2-methyl-1-propenyloxy, 1-methyl-2-propenyloxy, 2-methyl-2-propenyloxy, 1-pentenyloxy, 2-pentenyloxy, 3-pentenyloxy, 4-pentenyloxy, 1-methyl-1-butenyloxy, 2-methyl-1-butenyloxy, 3-methyl-1-butenyloxy, 1-methyl-2-butenyloxy, 2-methyl-2-butenyloxy, 3-methyl-2-butenyloxy, 1-methyl-3-butenyloxy, 2-methyl-3-butenyloxy, 3-methyl-3-butenyl, 1,1-dimethyl-2-propenyloxy, 1,2-dimethyl-1-propenyloxy, 1,2-dimethyl-2-propenyloxy, 1-ethyl-1-propenyloxy, 1-ethyl-2-propenyloxy, 1-hexenyloxy, 2-hexenyloxy, 3-hexenyloxy, 4-hexenyloxy and 5-hexenyloxy.

The term “C₃-C₆-alkenoyl (C₂-C₅-alkenyl-C(O)—)” as used herein refers to a mono- or diunsaturated straight-chain or branched alkenyl radical having 2 to 5 carbon atoms as defined above linked attached through the carbon atom of the carbonyl group at any position in the alkenyl group, for example propenoyl, 2-methyl-propenoyl, butenoyl, pentenoyl, 1,3-pentadienoyl, 5-hexenoyl.

The term “C₂-C₂₀-alkynyl” as used herein refers to unsaturated straight-chain or branched hydrocarbon radicals having 2 to 20, preferably 2 to 10 carbon atoms and one or two triple bonds in any position, e.g. ethynyl, propargyl (2-propyn-1-yl), 1-propyn-1-yl, 1-methylprop-2-yn-1-yl), 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like.

Alkynyl radicals interrupted by non-adjacent groups selected from —O—, —S—, —C(O)— and —NR^{N}— may be interrupted by one or more, e.g. 1, 2, 3, 4, 5, 6, 7, 8 or more than 8 of these groups, i.e, the termini of the alkynyl group are formed by carbon atoms. R^{N} is as defined above. If a plurality of those interrupting heteroatoms or heteroatomic groups occurs in the radical alkynyl, they are usually identical.

Substituted alkynyl groups may, depending on the length of the alkynyl chain, have one or more (e.g. 1, 2, 3, 4, 5 or more than 5) identical or different substituents.

In the case of halogen substituted alkynyl, the alkynyl group can be partially of fully halogenated and/or may carry further substituents.

The term “haloalkynyl” as used herein, which is also expressed as “alkynyl which may be substituted by halogen”, refers to unsaturated straight-chain or branched hydrocarbon radicals having one or more triple bonds (as mentioned above), where some or all of the hydrogen atoms in these groups are replaced by halogen atoms as mentioned above, in particular fluorine, chlorine and bromine. Examples for haloalkynyl are C₂-C₂₀-fluoroalkynyl, C₂-C₂₀ chloroalkynyl and C₁-C₂₀-bromoalkynyl.

The term “alkynyloxy” as used herein refers to a mono- or diunsaturated straight-chain or branched alkynyl radical having 3 to 6 carbon atoms as defined above which is attached via an oxygen atom to the remainder of the molecule, for example 2-propynyloxy, 2-butynyloxy, 3-butynyloxy, 1-methyl-2-propynyloxy, 2-pentynyloxy, 3-pentynyloxy, 4-pentynyloxy, 1-methyl-2-butynyloxy, 1-methyl-3-butynyloxy, 2-methyl-3-butynyloxy, 1-ethyl-2-propynyloxy, 2-hexynyloxy, 3-hexynyloxy, 4-hexynyloxy, 5-hexynyloxy, 1-methyl-2-pentynyloxy and 1-methyl-3-pentynyloxy.

The term “cycloalkyl” as used herein refers to a mono- or polycyclic, e.g. bi- or tricyclic aliphatic radical having usually from 3 to 30, preferably 3 to 20, more preferably 3 to 16, or 3 to 12 carbon atoms or in particular 3 to 8 carbon atoms. Examples of monocyclic rings are cyclopropyl, cyclobutyl, cyclopentyl, cyclohexyl, cycloheptyl or cyclooctyl, especially cyclopentyl and cyclohexyl. Examples of polycyclic rings are perhydroanthracyl, perhydronaphthyl, perhydrofluorenyl, perhydrochrysenyl, perhydropicenyl, adamantyl, bicyclo[1.1.1]pentyl, bicyclo[2.2.1]heptyl, bicyclo[4.2.2]decyl, bicyclo[2.2.2]octyl, bicyclo[3.3.0]octyl bicyclo[3.3.2]decyl, bicyclo[4.4.0]decyl, bicyclo[4.3.2]undecyl, bicyclo[4.3.3]dodecyl, bicyclo[3.3.3]undecyl, bicyclo[4.3.1]decyl, bicyclo[4.2.1]nonyl, bicyclo[3.3.1]nonyl, bicyclo[3.2.1]octyl and the like. Cycloalkyl may be interrupted by one or more CO groups, usually one or two groups. If cycloalkyl is interrupted by one or more CO groups, one or more methylene groups are replaced by CO. An example for cycloalkyl interrupted by 1 CO group is 3-oxobicyclo[2.2.1]heptyl. When cycloalkyl is substituted by one or more identical or different radicals, it is for example mono-, di-, tri, tetra- or pentasubstituted, e.g. by C₁-C₄-alkyl. When cycloalkyl is substituted by one or more substituents, it is, for example, mono-, di-, tri-, tetra- or pentasubstituted or more than pentasubstituted.

The term “heterocyclyl” (also referred to as heterocycloalkyl) as used herein includes in general 3-, 4-, 5-, 6-, 7- or 8-membered, in particular 5-, 6-, 7- or 8-membered monocyclic heterocyclic non-aromatic radicals and 8 to 10 membered bicyclic heterocyclic non-aromatic radicals, the mono- and bicyclic non-aromatic radicals may be saturated or unsaturated. The mono- and bicyclic heterocyclic non-aromatic radicals usually comprise 1, 2, 3 or 4 heteroatoms, in particular 1 or 2 heteroatoms selected from N, O and S as ring members, where S-atoms as ring members may be present as S, SO or SO₂. If heterocycloalkyl is interrupted by one or more, e.g. 1 or 2, CO groups, one or more methylene groups are replaced by CO. Examples of saturated or unsaturated 3-, 4-, 5-, 6-, 7- or 8-membered heterocyclic radicals comprise saturated or unsaturated, non-aromatic heterocyclic rings, such as oxiranyl, oxetanyl, thietanyl, thietanyl-5-oxid (S-oxothietanyl), thietanyl-5-dioxid (S-dioxothiethanyl), pyrrolidinyl, pyrazolinyl, imidazolinyl, pyrrolinyl, pyrazolinyl, imidazolinyl, tetrahydrofuranyl, dihydrofuranyl, 1,3-dioxolanyl, dioxolenyl, thiolanyl, S-oxothiolanyl, S-dioxothiolanyl, dihydrothienyl, Soxodihydrothienyl, S-dioxodihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperazinyl, pyranyl, dihydropyranyl, tetrahydropyranyl, 1,3- and 1,4-dioxanyl, thiopyranyl, S-oxothiopyranyl, S-dioxothiopyranyl, dihydrothiopyranyl, Soxodihydrothiopyranyl, S-dioxodihydrothiopyranyl, tetrahydrothiopyranyl, Soxotetrahydrothiopyranyl, S-dioxotetrahydrothiopyranyl, morpholinyl, thiomorpholinyl, S-oxothiomorpholinyl, S-dioxothiomorpholinyl, thiazinyl and the like. Examples for heterocyclic ring also comprising 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like.

If heterocyclyl is substituted by one or more substituents, it is, for example, mono-, di-, tri-, tetra- or pentasubstituted or more than pentasubstituted.

The term “C₆-C₂₀-aryl” as used herein refers to a monovalent aromatic group which is monocyclic, such as phenyl, or condensed polycyclic, for example naphthyl, phenanthryl or anthracenyl. Preferred examples of aryl are phenyl and naphthyl.

The term “C₆-C₁₀-aryl” as used herein refers to phenyl and naphthyl.

The term “heteroaryl” (also referred to as “hetaryl”) includes in general 5- or 6-membered unsaturated monocyclic heterocyclic radicals and 8 to 10 membered unsaturated bicyclic heterocyclic radicals which are aromatic, i.e. they comply with Hückel's rule (4n+2 rule). Hetaryl usually comprise besides carbon atom(s) as ring member(s) 1, 2, 3 or 4 heteroatoms selected from N, O and S as ring members. Examples of 5- or 6-membered heteroaromatic radicals include: 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 3-isoxazolyl, 4-isoxazolyl or 5-isoxazolyl, 3-isothiazolyl, 4-isothiazolyl or 5-isothiazolyl, 1-imidazolyl, 2-imidazolyl, 4-imidazolyl, 2- or 5-(1,3,4]oxadiazolyl, 4- or 5-(1,2,3-oxadiazol)yl, 3- or 5-(1,2,4-oxadiazol)yl, 2- or 5-(1,3,4-thiadiazol)yl, 2- or 5-(1,3,4-thiadiazol)yl, 4- or 5-(1,2,3-thiadiazol)yl, 3- or 5-(1,2,4-thiadiazol)yl, 1H-, 2H- or 3H-1,2,3-triazol-4-yl, 1,3,4-triazol-2-yl, 2H-triazol-3-yl, 1H-, 2H-, or 4H-1,2,4-triazolyl, 1H- or 2H-tetrazolyl 2-pyridinyl, 3-pyridinyl, 4-pyridinyl, 3-pyridazinyl, 4-pyridazinyl, 2-pyrimidinyl, 4-pyrimidinyl, 5-pyrimidinyl and 2-pyrazinyl.

The term “heteroaryl” also includes bicyclic 8- to 10-membered heteroaromatic radicals comprising as ring members 1, 2 or 3 heteroatoms selected from N, O and S, wherein a 5- or 6-membered heteroaromatic ring is fused to a phenyl ring or to a 5- or 6-membered heteroaromatic radical. Examples of a 5- or 6-membered heteroaromatic ring fused to a phenyl ring or to a 5- or 6-membered heteroaromatic radical include benzofuranyl, benzothienyl, indolyl, indazolyl, benzimidazolyl, benzoxathiazolyl, benzoxadiazolyl, benzothiadiazolyl, benzoxazinyl, chinolinyl, isochinolinyl, purinyl, 1,8-naphthyridyl, pteridyl, pyrido[3,2-d]pyrimidyl or pyridoimidazolyl and the like. These fused hetaryl radicals may be bonded to the remainder of the molecule via any ring atom of 5- or 6-membered heteroaromatic ring or via a carbon atom of the fused phenyl moiety.

When heteroaryl is substituted by one or more identical or different radicals, it is for example mono-, di-, tri-, tetra- or pentasubstituted.

The term “C₁-C₂₀-alkylene” (or C₁-C₂₀-alkanediyl) as used herein in each case denotes an alkyl radical having 1 to 20 carbon atoms as defined above, wherein one hydrogen atom at any position of the alkyl radical is replaced by one further binding site, thus forming a bivalent moiety for example —CH₂—, —CH₂CH₂—, —CH(CH₃)—, —CH₂CH₂CH₂—, —CH(CH₃)CH₂—, —CH₂CH₂CH₂CH₂—, —CH₂CH(CH₃)CH₂—, —CH(CH₃)CH(CH₃)—, —CH₂CH₂CH₂CH₂CH₂—, —CH₂(CH₂)₂CH(CH₃)—, —CH₂C(CH₃)₂CH₂—, and the like.

The term C₁-C₂₀-alkylene may be interrupted by one or more, identical or different non-adjacent groups denotes an alkylene chain having 1 to 20 carbon atoms as defined above where at least one internal methylene group of the alkylene chain is replaced by the interrupting group. The alkylene can be interrupted e.g. once, twice, three times, four times or more than four times.

If alkylene is substituted by one or more substituents, it is, for example, mono-, di-, tri-, tetra- or pentasubstituted or more than pentasubstituted.

The term “C₂-C₂₀-alkenylene” (or C₂-C₂₀-alkenediyl) as used herein in each case denotes a straight-chain or branched C₂-C₂₀-alkenyl radical as defined above, wherein one hydrogen atom at any position of the alkenyl radical is replaced by one further binding site, thus forming a bivalent moiety, for example —CH═CH—, —CH═CHCH₂—, —CH═C(H₃)CH₂—CH₂CH═CHCH₂—, —CH═CH—CH═CH—, —CH₂CH═CHCH₂CH₂— and the like.

The term “C₂-C₂₀-alkenylene may be interrupted by one or more identical or different non-adjacent groups” denotes an alkenylene chain having 2 to 20 carbon atoms as defined above where at least one internal methylene group of the alkenylene chain is replaced by a group Wm. The alkenylene can be interrupted e.g. once, twice, three times, four times or more than four times.

If .I alkenylene is substituted by one or more substituents, it is, for example, mono-, di-, tri-, tetra- or pentasubstituted or more than pentasubstituted.

The term “alkynylene” (or alkynediyl) as used herein in each case denotes a straight-chain or branched alkynyl radical as defined above, wherein one hydrogen atom at any position of the alkynyl radical is replaced by one further binding site, thus forming a bivalent moiety. Accordingly, C₂-C₂₀-alkynylene is a divalent straight-chain or branched aliphatic chain having 2 to 20 carbon atoms.

The term C₂-C₂₀-alkynylene may be interrupted by one or more identical or different non-adjacent groups” denotes an alkynylene chain having 2 to 20 carbon atoms as defined above where at least one internal methylene group of the alkynylene chain is replaced by a group The alkynylene can be interrupted e.g. once, twice, three times, four times or more than four times.

The term “C₃-C₂₀-cycloalkylene” (also referred to as cycloalkanediyl) refers to cycloalkyl radical having 3 to 20 carbon atoms as defined above, wherein one hydrogen atom at any position of cycloalkyl is replaced by one further binding site, thus forming a divalent radical. In case of polycyclic cycloalkanediyl, the bonding sites are either situated in the same ring or in different rings. Examples for monocyclic rings are cyclopropylene, cyclobutylene, cyclopentylene, cyclohexylene or cycloheptylen, especially cyclohexylene. Examples of polycyclic rings are perhydroanthracylene, perhydronaphthylene, perhydrofluorenylene, perhydrochrysenylene, perhydropicenylene, adamantylene, bicyclo[1.1.1]pentylen, bicycle[2.2.1]heptylene, bicyclo[4.2.2]decylene, bicyclo[2.2.2]octylene, bicyclo[3.3.2]decylene, bicyclo[4.3.2]undecylene, bicyclo[4.3.3]dodecylene, bicyclo[3.3.3]undecylene, bicyclo[4.3.1]decylene, bicyclo[4.2.1]nonylene, bicyclo[3.3.1]nonylene, bicyclo[3.2.1]octylene and the like. If cycloalkanediyl is substituted by one or more substituents, it is, for example, mono-, di-, tri-, tetra- or pentasubstituted or more than pentasubstituted, e.g. by C₁-C₄-alkyl.

The term “C₆-C₂₀-arylene” (also referred to as arenediyl) as used herein refers to an aryl group as defined above, wherein one hydrogen atom at any position of the aryl group is replaced by one further binding site, thus forming a bivalent radical. In case of polycyclic arylene, the bonding sites are either situated in the same ring or in different rings. Examples of arylene are phenylen, naphthylene, e.g. 1,5-naphthalenediyl, and 1,8-naphthalenediyl, anthracenediyl or phenanthrenediyl. If arylene is substituted by one or more substituents, it is, for example, mono-, di-, tri-, tetra- or pentasubstituted or more than pentasubstituted.

The term “phenylene” refers to 1,2-phenylene (o-phenylene or 1,2-benzenediyl), 1,3-phenylene (m-phenylene, 1,3-benzenediyl) and 1,4-phenylene (p-phenylene or 1,4-benzenediyl). The term “naphthylene” refers to 1,2-naphthylene, 1,3-naphthylene, 1,4-naphthylene, 1,5-naphthylene, 1,8-naphthylene, 2,3-naphthylene and 2,7-naphthylene.

The term “xylylene” refers to 1,2-xylylene (1,2-methylenephenylenemethylene, 1,2-CH₂—C₆H₄—CH₂), 1,3-xylylene (1,3-methylenephenylenemethylene, 1,3-CH₂—C₆H₄—CH₂) and 1,4-xylylene (1,4-methylenephenylenemethylene, 1,4-CH₂—C₆H₄—CH₂).

The term “heteroarylene” (also referred to as heteroarenediyl) refers to a heteroaryl radical as defined above, where one hydrogen atom at any position of the heteroaryl group is replaced by a further binding site, thus forming a divalent radical. In case of polycyclic heteroarenediyl, the bonding sites are either situated in the same ring or in different rings. Heteroarenediyl can be C-attached or N-attached where such is possible. For example, a pyrrolediyl, imidiazolediyl or pyrazolediyl can be N-attached or C-attached. Examples for heteroarenediyl are pyridinediyl, pyrimidinediyl, pyridazinediyl, 1,2,3-triazinediyl, 1,2,4-triazinediyl, 1,2,3,4-tetrazinediyl, furandiyl, thiophenediyl, pyrrolediyl, thiazolediyl, thiadiazolediyl, pyrazolediyl, imidazolediyl, triazolediyl, oxazolediyl, isoxazolediyl, isothiazolediyl, oxadiazolediyl and the like. If heteroarenediyl is substituted by one or more substituents, it is, for example, mono-, di-, tri-, tetra- or pentasubstituted or more than pentasubstituted.

The term “Cₙ-Cₘ-alkoxy-C₀-Cₚ-alkyl” as used herein refers to an alkoxy group, as defined above, having n to m carbon atoms, which is bound to the remainder of the molecule via an alkylene group, as defined above, having o to p carbon atoms. Examples thereof are CH₂—OCH₃, CH₂—OC₂H₅, n-propoxymethyl, CH₂—OCH(CH₃)₂, n-butoxymethyl.

The term “Cₖ-Cₗ-alkoxy-Cₙ-Cₘ-alkoxy-C₀-Cₚ-alkyl” as used herein refers to an alkoxy group, as defined above, having k to l carbon atoms, which is bound to the remainder of the molecule via a Cₙ-Cₘ-alkoxy-C₀-Cₚ-alkyl group, as defined above.

The term “hydroxy-Cₙ-Cₘ-alkoxy-carbonyl” as used herein refers to an alkoxy group carrying usually one hydroxy group and having n to m carbon atoms, which is bound to the remainder of the molecule via a carbonyl group.

The term “arylalkyl” (also referred to as aryl-alkylene) as used herein refers to an aryl radical as defined below which is linked via an alkylene group, in particular via a methylene, 1,1-ethylene or 1,2-ethylene group, e.g. benzyl, 1-phenylethyl and 2-phenylethyl and the like.

The term “Cₙ-Cₘ-cycloalkyl-Cₒ-Cₚ-alkyl” (also referred to as cycloalkyl-alkylene) as used herein refers to a cycloalkyl group, as defined above, having n to m carbon atoms, which is bound to the remainder of the molecule via an alkylene group, as defined above, having o to p carbon atoms. Examples are cyclopropylmethyl, cyclopropylethyl, cyclopropylpropyl, cyclobutylmethyl, cyclobutylethyl, cyclobutylpropyl, cyclopentylmethyl, cycloppentylethyl, cyclopentylpropyl, cyclohexylmethyl, cyclohexylethyl, cyclohexylpropyl, and the like.

The term “heterocycloalkyl-Cₒ-Cₚ-alkyl” (also referred to as heterocycloalkyl-alkylene) as used herein refers to a heterocycloalkyl group, as defined above, which is bound to the remainder of the molecule via an alkylene group, as defined above, having o to p carbon atoms. Examples are heteroarylmethyl, 1-heteroarylethyl or 2-heteroarylethyl.

The term “and/or” or “or/and” are meant to express that not only one of the defined alternatives (substituents) may be present, but also several of the defined alternatives (substituents) together, namely mixtures of different alternatives (substituents).

The term “at least” is meant to define one or more than one, for example one, two, three, preferably one to two.

The term “one or more identical or different radicals” is meant to define one, two, three, four, five, six, seven, eight or more than eight identical or different radicals.

The remarks made below as to preferred embodiments of the variables (substituents) of the compounds of formulae Ia or Ib are valid on their own as well as preferably in combination with each other.

The remarks made below concerning preferred embodiments of the variables further are valid concerning the compounds of formulae Ia or Ib as well as concerning the uses and methods according to the invention and the composition according to the present invention.

With a view to the activity of the compounds of the formulae Ia and Ib according to the invention as thermal curing generator, the substituents (variables) M, R¹, R², R³, R⁴, R⁵, R⁶, R⁷, R⁸, R⁹ and R¹⁰ independently of one another and preferably in combination have the meanings given below:

A preferred embodiment of the invention relates to compositions, compounds, methods and uses, wherein R¹ in formula Ia is the group of the formula A

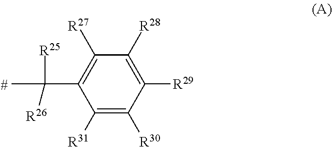

where
# is the point of attachment to the sulfonium atom, and
R²⁵, R²⁶, R²⁷, R²⁸, R²⁹, R³⁹ and R³¹ are as defined above.

More preferably, R¹ is a group of the formula A, where
R²⁵ is hydrogen, C₁-C₁₂-alkyl or phenyl;
R²⁶ is hydrogen, C₁-C₁₂-alkyl or phenyl;
R²⁷ is hydrogen, fluorine, chlorine, NO₂, OR²⁰, COR²¹, COOR²², CONR²³R²⁴, C₁-C₁₂-alkyl, C₂-C₁₂-alkenyl or phenyl, in particular hydrogen, fluorine, chlorine, NO₂, OR²⁰, COR²¹, COOR²², CONR²³R²⁴, or C₁-C₁₂-alkyl;
R²⁸ is hydrogen, fluorine, chlorine, NO₂, OR²⁰, COR²¹, COOR²², CONR²³R²⁴, C₁-C₁₂-alkyl, C₂-C₁₂-alkenyl or phenyl, in particular hydrogen, fluorine, chlorine, NO₂, OR²⁰, COR²¹, COOR²², CONR²³R²⁴ or C₁-C₁₂-alkyl;
R²⁹ is hydrogen, fluorine, chlorine, NO₂, OR²⁰, COR²¹, COOR²², CONR²³R²⁴, C₁-C₁₂-alkyl, C₂-C₁₂-alkenyl or phenyl, in particular hydrogen, fluorine, chlorine, NO₂, OR²⁰, COR²¹, COOR²², CONR²³R²⁴, or C₁-C₁₂-alkyl;
R³⁰ is hydrogen, fluorine, chlorine, NO₂, OR²⁰, COR²¹, COOR²², CONR²³R²⁴, C₁-C₁₂-alkyl, C₂-C₁₂-alkenyl or phenyl, in particular hydrogen, fluorine, chlorine, NO₂, OR²⁰, COR²¹, COOR²², CONR²³R²⁴, or C₁-C₁₂-alkyl; and
R³¹ is hydrogen, fluorine, chlorine, NO₂, OR²⁰, COR²¹, COOR²², CONR²³R²⁴, C₁-C₁₂-alkyl, C₂-C₁₂-alkenyl or phenyl, in particular hydrogen, fluorine, chlorine, NO₂, OR²⁰, COR²¹, COOR²², CONR²³R²⁴, or C₁-C₁₂-alkyl; or
R²⁷ and R²⁸, R²⁸ and R²⁹, R²⁹ and R³⁰ and/or R³⁰ and R³¹ together with the carbon atoms to which they are attached may be together a group selected from —CH₂CH₂CH₂—, —CH₂CH₂CH₂CH₂— and —CH═CH—CH═CH—, thus forming, together with the carbon atoms to which they are bound, a 5- or 6-membered ring, in particular a benzene ring,
   where R²⁰, R²¹, R²³ and R²⁴ are as defined above and preferably have one of the meanings being preferred. In particular R¹ is benzyl, i.e. R²⁵, R²⁶, R²⁷, R²⁸, R²⁹, R³⁰, R³¹ are each hydrogen. Likewise, in particular, R²⁵ and R²⁶ are both hydrogen, and one or two of the radicals R²⁷, R²⁸, R²⁹, R³⁰ and R³¹ are selected from nitro, fluorine, chlorine, C₁-C₄-alkyl, OR²⁰, COOR²², and CONR²³R²⁴ and the other radicals R²⁷, R²⁸, R²⁹, R³⁰ and R³¹ are hydrogen. Likewise, in particular R²⁵, R²⁶, R²⁹, R³⁰ and R³¹ are each hydrogen and R²⁷ and R²⁸ are together —CH═CH—CH═CH—, thus forming, together with the carbon atoms to which they are bound a benzene ring.

According to a specific aspect of this embodiment, R¹ is naphthylmethyl; benzyl or benzyl which is substituted by one or two radicals selected from nitro, fluorine, chlorine, C₁-C₄-alkyl, C₁-C₄-alkoxy, C₁-C₄-alkoxycarbonyl, C(O)O—(C₁-C₄-alkyl-OH) and C(O)N(C₁-C₄-alkyl)₂.

A further preferred embodiment of the invention relates to compositions, compounds, methods and uses, wherein R¹ is the group of the formula B

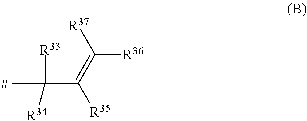

where
# is the point of attachment to the sulfonium atom, and
R³³, R³⁴, R³⁵, R³⁶ and R³⁷ are as defined above.

According to a specific aspect of this embodiment, R¹ is the group of the formula B,

where
R³³ is hydrogen, C₁-C₁₂-alkyl or phenyl;
R³⁴ is hydrogen, C₁-C₁₂-alkyl or phenyl;
R³⁵, R³⁶ and R³⁷ are independently of one another selected from hydrogen, F, Cl, C₁-C₁₂-alkyl, C₂-C₁₂-alkenyl and phenyl.
According to a more specific aspect of this embodiment, R¹ is the group of the formula B, where
R³³ is hydrogen, C₁-C₁₂-alkyl or phenyl;
R³⁴ is hydrogen, C₁-C₁₂-alkyl or phenyl;
R³⁵ is hydrogen, C₁-C₁₂-alkyl, phenyl or C₂-C₁₂-alkenyl;
R³⁶ is hydrogen, C₁-C₁₂-alkyl, phenyl or C₂-C₁₂-alkenyl; and
R³⁷ is hydrogen, fluorine, chlorine, C₁-C₁₂-alkyl, phenyl or C₂-C₁₂-alkenyl.

In particular, R³³ and R³⁴ are both hydrogen, and one or two of the radicals R³⁵, R³⁶ and R³⁷ are C₁-C₄-alkyl or phenyl and the other radicals R³⁵, R³⁶ and R³⁷ are hydrogen.

According to an even more specific aspect of this embodiment, R¹ is prop-2-en-1-yl, 3-phenyl-prop-2-en-1-yl, 2-(C₁-C₄-alkyl)-prop-2-en-1-yl, or 3-(C₁-C₄-alkyl)-prop-2-en-1-yl.

A further preferred embodiment of the invention relates to compositions, compounds, methods and uses, in which R¹ is C₃-C₁₂-cycloalkyl, in particular C₃-C₈-cycloalkyl. Examples are cyclobutyl, cyclopentyl, cyclohexyl, cycloheptyl and cyclooctyl, in particular cyclopentyl or cyclohexyl.

A further preferred embodiment of the invention relates to compositions, compounds, methods and uses, in which R¹ is C₃-C₁₂-cycloalkyl, which is substituted by one or more, e.g. 1, 2 or 3, identical or different radicals selected from F, Cl, Br, I, C₁-C₁₂-alkyl, OR²⁰, COR²¹, COOR²² and CONR²³R²⁴, where R²⁰, R²¹, R²², R²³ and R²⁴ are as defined above and preferably have one of the meanings being preferred. More preferably, R¹ is C₃-C₈-cycloalkyl which is substituted by one, two or three of identical or different radicals selected from F, Cl, Br, I, C₁-C₈-alkyl, OR²⁰, COOR²² and CONR²³R²⁴. In particular R¹ is C₃-C₈-cycloalkyl which is substituted by one, two or three of identical or different radicals selected from F, Cl, Br, I, C₁-C₈-alkyl, C₁-C₄-alkoxy, hydroxy, C₁-C₄-fluoroalkylcarbonyloxy, C₁-C₄-chloroalkylcarbonyloxy, C(O)O—(C₁-C₄-alkyl-OH) and C(O)N(C₁-C₄-alkyl)₂.

A further preferred embodiment of the invention relates to compositions, compounds, methods and uses, in which R¹ is C₁-C₁₂-alkyl. In particular R¹ is C₁-C₆-alkyl such as methyl, ethyl, n-propyl, isopropyl, n-butyl, pentyl or hexyl, in particular methyl.

A further preferred embodiment of the invention relates to compositions, compounds, methods and uses, in which R¹ is C₁-C₁₂-alkyl, which is substituted by one or more, e.g. 1 or 2, identical or different radicals selected from F, Cl, Br, I, OR²⁰, COR²¹, COOR²², CONR²³R²⁴, C₃-C₁₂-cycloalkyl and heterocyclyl, e.g. 5- to 6-membered heterocyclyl, where R²⁰, R²¹, R²³ and R²⁴ are as defined above and preferably have one of the meanings being preferred. Examples are C₁-C₁₂-fluoroalkyl, C₁-C₁₂-chloroalkyl, C₁-C₄-alkoxy-C₁-C₁₂-alkyl, phenoxy-C₁-C₁₂-alkyl, phenylcarbonyl-C₁-C₁₂-alkyl, C₁-C₄-alkoxycarbonyl-C₁-C₁₂-alkyl, C₁-C₄-alkoxy-C₁-C₄-alkoxycarbonyl-C₁-C₁₂-alkyl, C₃-C₁₂-cycloalkyl-C₁-C₁₂-alkyl and 5- or 6-membered heterocyclyl-C₁-C₁₂-alkyl, where the heterocyclyl moiety is a 5- to 6-membered saturated heterocyclic ring comprising besides carbon atoms one or two heteroatoms selected from O, S or N.

Examples for R¹ are phenoxy-C₁-C₆-alkyl, especially phenoxymethyl or 2-phenoxyethyl; C₁-C₄-alkoxycarbonyl-C₁-C₆-alkyl, especially methoxycarbonylmethyl, ethoxycarbonylmethyl, 2-methoxycarbonylethyl, 2-ethoxycarbonylethyl, 3-methoxycarbonylpropyl, 3-ethoxycarbonylpropyl, 4-methoxycarbonylbutyl or 4-ethoxycarbonylbutyl; phenylcarbonyl-C₁-C₆-alkyl, especially benzoylmethyl; C₁-C₄-alkoxy-C₁-C₆-alkyl, especially 2-methoxy-ethyl or 3-methoxypropyl; C₁-C₄-alkoxy-C₁-C₄-alkoxycarbonyl-C₁-C₆-alkyl, especially 3-methoxy-butoxycarbonyl, 2-methoxypropoxycarbonyl, 3-ethoxybutoxycarbonyl or 2-ethoxypropoxycarbonyl; C₃-C₁₂-cycloalkyl-C₁-C₆-alkyl, especially cyclohexylmethyl, 2-cyclohexylethyl, cyclopentylmethyl or 2-cyclopentylethyl; heterocycloalkyl-C₁-C₆₂-alkyl is preferably tetrahydrofuan-2-yl-methyl, tetrahydrofuran-3-yl-methyl, tetrahydrothiophen-2-ylmethyl, tetrahydrothiophen-3-ylmethy, 2-(tetrahydrofuran-2-yl)-ethyl, 2-(tetrahydrofuran-3-yl)ethyl, 2-(tetrahydrothiophen-2-yl)-ethyl or 2-(tetrahydrothiophen-3-yl)-ethyl.

According to a specific embodiment, R¹ in formula Ia is naphthylmethyl; benzyl; benzyl which is substituted by one or two radicals selected from nitro, fluorine, chlorine, C₁-C₄-alkyl, C₁-C₄-alkoxy, C₁-C₄-alkoxycarbonyl, C(O)O—(C₁-C₄-alkyl-OH) and C(O)N(C₁-C₄-alkyl)₂; C₃-C₈-cycloalkyl; C₁-C₆-alkyl; C₁-C₄-alkoxy-(CO)—C₁-C₄-alkyl; (5- or 6-membered saturated heterocycloalkyl)-C₁-C₄-alkyl; phenoxy-C₁-C₄-alkyl; prop-2-en-1-yl, 3-phenylprop-2-en-1-yl, 2-(C₁-C₄-alkyl)-prop-2-en-1-yl; or 3-(C₁-C₄-alkyl)-prop-2-en-1-yl.

In an even more specific aspect of this embodiment R¹ is C₁-C₆-alkyl, C₁-C₄-alkoxy(CO)—C₁-C₄-alkyl, tetrahydrofuranyl-C₁-C₄-alkyl, tetrahydrothiophen-C₁-C₄-alkyl or phenoxy-C₁-C₄-alkyl.

Examples of radicals R¹ are 1-naphthylmethyl, benzyl, 4-methylbenzyl, 4-ethoxycarbonylbenzyl, 4-chlorobenzyl, 2,4-dichlorobenzyl, 3,4-dichlorobenzyl, 4-nitrobenzyl, 4-diisopropylcarbamoylbenzyl, 4-(2-hydroxyethoxycarbonyl)benzyl, 4-(2-methoxy-1-methylethoxycarbonyl)benzyl, 4-ethoxycarbonylbenzyl, 3-methoxybenzyl, 3-methylbenzyl, 2-methylbenzyl, 2-chlorobenzyl, 2-methylprop-2-enyl, 3-methylbut-2-enyl, allyl, (E)-3-phenylprop-2-enyl, (Z)-3-phenylprop-2-enyl, 3-phenylprop-2-enyl, cyclohexyl, methyl, ethyl, n-butyl, n-octyl, 2-methoxycarbonylethyl, 2-phenoxyethyl, 3-methoxybutoxycarbonylmethyl, tetrahydrofuran-2-ylmethyl, tetrahydrothiophen-2-ylmethyl and ethoxycarbonylmethyl.

A further preferred embodiment of the invention relates to compositions, compounds, methods and uses, wherein in formula Ia R² and R³ are independently of one another selected from C₁-C₁₂-alkyl; C₁-C₁₂-alkyl, which is substituted by one or more identical or different radicals R^{2a}, where R^{2a} is as defined above; C₃-C₁₂-cycloalkyl; C₃-C₁₂-cycloalkyl, which is substituted by one or more identical or different radicals R^{2b}, where R^{2b} is as defined above; phenyl; and phenyl, which is substituted by one, two, three, four or five radicals R^{2c}, where R^{2c} is as defined above.

According to a specific aspect of this embodiment, R² and R³ in formula Ia are independently of one another selected from

C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;

C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and

phenyl, which is unsubstituted or substituted by one, two, three, four or five radicals selected from F, Cl, Br, I, C₁-C₁₀-alkyl, SR¹⁹ and OR²⁰;
where R¹⁹, R²⁰, R²², R²³ and R²⁴ are as defined above.

According to a more specific aspect of this embodiment, R² and R³ in formula Ia are independently of one another selected from R² and R³ in formula Ia are independently of one another selected from C₁-C₈-alkyl; phenyl-C₁-C₆-alkyl, where the alkyl moiety of the last mentioned radical is substituted by benzoyl; naphthyl-C₁-C₆-alkyl; (5- or 6-membered saturated heterocyclyl)-C₁-C₆-alkyl, phenoxy-C₁-C₆-alkyl, benzoyl-C₁-C₆-alkyl, C₁-C₄-alkoxy-C(═O)—C₁-C₆-alkyl, C₁-C₄-alkoxy-C₁-C₄-alkoxy-C(═O)—C₁-C₆-alkyl, benzyloxycarbonyl-C₁-C₆-alkyl, phenyl and phenyl-C₁-C₆-alkyl, where the aromatic ring in the two last-mentioned radicals may be substituted by 1, 2, 3, 4 or 5 radicals which, independently of one another, are selected from the group consisting of F, Cl, Br, I, OH, NO₂, C₁-C₁₀-alkyl, C₁-C₄-alkoxy, (5- or 6-membered saturated heterocycloalkyl)-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂.

According to a specific aspect, R² and/or R³ is C₁-C₁₂-alkyl, especially C₁-C₈-alkyl, which is unsubstituted or is partly or completely halogenated and/or has 1, 2 or 3 identical or different radicals R^{2a} selected from OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 identical or different radicals selected from C₁-C₁₂-alkyl, F, Cl, Br, I, NO₂, OR²⁰, COOR²² and CONR²³R²⁴, R²⁰, R²², R²³ and R²⁴ are as defined above and preferably have one of the meanings being preferred.

According to an even more specific aspect of this embodiment, R² and/or R³ is C₁-C₈-alkyl such as methyl, ethyl, n-propyl, isopropyl, n-butyl, sec-butyl, tert-butyl, n-pentyl, or hexyl or n-octyl, in particular methyl, ethyl, n-propyl, n-butyl or n-octyl.

According to a further even more specific aspect of this embodiment R² and/or R³ are C₁-C₆-fluoroalkyl, C₁-C₆-chloroalkyl, C₁-C₄-alkoxy-C₁-C₆-alkyl, phenoxy-C₁-C₆-alkyl, benzoyl-C₁-C₆-alkyl, benzyloxycarbonyl-C₁-C₆-alkyl or phenyl-C₁-C₆-alkyl, where the alkyl moiety of the last-mentioned radical is substituted by benzoyl. According to a more specific aspect of this embodiment, examples for R² and/or R³ are C₁-C₄-alkoxy-C₁-C₂-alkyl, especially are 2-methoxy-ethyl or 3-methoxypropyl; phenoxy-C₁-C₄-alkyl, especially phenoxymethyl, 2-phenoxyethyl or 3-phenoxypropyl; benzoyl-C₁-C₄-alkyl, especially 2-oxo-2-phenylethyl, 3-oxo-3-phenylpropyl or 4-oxo-4-phenylbutyl; benzyloxycarbonyl-C₁-C₄-alkyl, especially 2-benzyloxycarbonyl-ethyl or 2-methyl-2-benzyloxycarbonylethyl;

phenyl-C₁-C₄-alkyl, where the alkyl moiety of phenylalkyl is substituted by benzoyl, especially 2-oxo-1,2-diphenylethyl, 3-oxo-1,3-diphenylpropyl or 4-oxo-1,4-diphenylbutyl.

According to a further more specific aspect of this embodiment, e, R² and/or R³ are C₁-C₄-alkoxycarbonyl-C₁-C₆-alkyl, C₁-C₄-alkoxy-C₁-C₄-alkoxycarbonyl-C₁-C₆-alkyl, C₃-C₈-cycloalkyl-C₁-C₆-alkyl, naphthyl-C₁-C₆-alkyl or heterocyclyl-C₁-C₆-alkyl, wherein heterocyclyl is a 5- to 6-membered saturated heterocyclic ring comprising besides carbon atoms one or two heteroatoms selected from O and S. Examples for R² and/or R³ are C₁-C₄-alkoxycarbonyl-C₁-C₄-alkyl, especially methoxycarbonylmethyl, ethoxycarbonylmethyl, 2-methoxycarbonylethyl, 2-ethoxycarbonylethyl, 3-methoxycarbonylpropyl, 3-ethoxycarbonylpropyl, 4-methoxycarbonylbutyl or 4-ethoxycarbonylbutyl; C₁-C₄-alkoxy-C₁-C₄-alkoxycarbonyl-C₁-C₄-alkyl, especially 3-methoxybutoxycarbonylmethyl, 3-methoxybutoxycarbonylethyl, 3-ethoxybutoxycarbonylmethyl or 3-ethoxybutoxycarbonylethyl; C₃-C₈-cycloalkyl-C₁-C₄-alkyl, especially cyclohexylmethyl, 2-cyclohexylethyl, cyclopentylmethyl or 2-cyclopentylethyl; naphthyl-C₁-C₄-alkyl, especially 1-naphthylmethyl, 2-napthylmethyl, 1-(naphthalene-1-yl)ethyl, 1-(naphthalene-2-yl)ethyl, 2-(naphthalene-1-yl)ethyl or 2-(naphthalene-2-yl)ethyl; heterocyclyl-C₁-C₄-alkyl are tetrahydrofuran-2-ylmethyl, tetrahydrofuran-3-ylmethyl, 2-(tetrahydrofuran-2-yl)ethyl, 2-(tetrahydrofuran-3-yl)ethyl, 3-(tetrahydrofuran-2-yl)propyl, 3-(tetrahydrofuran-3-yl)propyl, tetrahydrothiophen-2-ylmethyl, tetrahydrothiophen-3-ylmethyl, 2-(tetrahydrothiophen-2-yl)ethyl, 2-(tetrahydrothiophen-3-yl)ethyl, 3-(tetrahydrothiophen -2-yl)propyl or 3-(tetrahydrothiophen-3-yl)propyl.

Likewise, in a preferred embodiment, R² and/or R³ is phenyl-C₁-C₆-alkyl, in which the phenyl moiety of phenylalkyl is unsubstituted or substituted by 1, 2, 3, 4 or 5 identical or different radicals selected from F, Cl, Br, I, OH, NO₂, C₁-C₁₀-alkyl, C₁-C₄-alkoxy, heterocyclyl-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂. In particular R² and/or R³ is phenyl-C₁-C₂-alkyl, in which the phenyl moiety of phenylalkyl is unsubstituted or substituted by 1 or 2 identical or different radicals selected from fluorine, chlorine, C₁-C₄-alkyl, C₁-C₄-alkoxy, (C₁-C₄-alkoxy)carbonyl, C(O)O—(C₁-C₄-alkyl-OH), and C(O)N(C₁-C₈-alkyl)₂.

Examples for R² and/or R³ are phenyl-C₁-C₄-alkyl, where the phenyl moiety of phenylalkyl is substituted by 1 or 2 chlorines, especially 2-chlorobenzyl, 3-chlorobenzyl, 4-chlorobenzyl, 2,4-dichlorobenzyl, 3,4-dichlorbenzyl, 3,5-dichlorobenzyl, 2-(2-chlorophenyl)ethyl, 2-(3-chlorophenyl)ethyl, 2-(4-chlorophenyl)ethyl, 2-(2,4-dichlorophenyl)ethyl, 2-(3,5-dichlorophenyl)ethyl or 2-(3,4-dichlorophenyl)ethyl; phenyl-C₁-C₄-alkyl, where the phenyl moiety of phenylalkyl is substituted by hydroxy, especially 2-hydroxybenzyl, 3-hydroxybenzyl, 4-hydroxybenzyl, 2-(2-hydroxyphenyl)ethyl, 2-(3-hydroxyphenyl)ethyl or 2-(4-hydroxyphenyl); phenyl-C₁-C₄-alkyl, where the phenyl moiety of phenylalkyl is substituted by 1 or 2 C₁-C₁₀-alkyl groups, especially 2-, 3- or 4-methylbenzyl, 2-, 3-, 4-ethylbenzyl, 2-, 3-or 4-propylbenzyl, 2-, 3- or 4-butylbenzyl, 2,4-dimethylbenzyl or 3,5-dimethylbenzyl; phenyl-C₁-C₄-alkyl, where the phenyl moiety of phenylalkyl is substituted by 1 or 2 C₁-C₄-alkoxy groups, especially 2-, 3- or 4-methoxybenzyl, 2-, 3-, 4-ethoxybenzyl, 2-, 3-or 4-propoxybenzyl, 2-, 3- or 4-butoxybenzyl, 2,4-dimethoxybenzyl or 3,5-dimethoxybenzyl; phenyl-C₁-C₄-alkyl, where the phenyl moiety of phenylalkyl is substituted by C₁-C₄-alkoxycarbonyl, especially 2-ethoxycarbonylbenzyl, 3-ethoxycarbonylbenzyl, 4-ethoxycarbonylbenzyl, 2-(2-ethoxycarbonylphenyl)ethyl, 2-(3-ethoxycarbonylphenyl)ethyl or 4-(3-ethoxycarbonylphenyl)ethyl; phenyl-C₁-C₄-alkyl, where the phenyl moiety of phenylalkyl is substituted by hydroxy-C₁-C₄-alkoxycarbonyl, especially 4-(2-hydroxyethoxycarbonyl)benzyl, 2-(4-(2-hydroxyethoxycarbonylphenyl)ethyl; phenyl-C₁-C₄-alkyl, where the phenyl moiety of phenylalkyl is substituted by C(═O)N(C₁-C₈-alkyl)₂, especially 4-dimethylcarbamoylbenzyl, 4-diethylcarbamoylbenzyl, 4-diisopropylcarbamoylbenzyl, 2-(4-dimethylcarbamoylphenyl)ethyl, 2-(4-diethylcarbamoylphenyl)ethyl or 2-(4-diisopropylcarbamoylphenyl)ethyl.

Likewise, in a preferred embodiment, R² and/or R³ are C₃-C₁₂-cycloalkyl, which is un-substituted or has 1, 2 or 3 identical or different radicals R^{2b} selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals may be substituted by 1, 2, 3, 4, or 5 different or identical radicals selected from F, Cl, Br, I, NO₂, C₁-C₁₂-alkyl, OR²⁰, COOR²² and CONR²³R²⁴, R²⁰, R²², R²³ and R²⁴ are as defined above and preferably have one of the meanings being preferred. In a particular preferred embodiment, R² and/or R³ are C₃-C₈-cycloalkyl such as cyclopropyl, cyclobutyl, cyclopentyl, cyclohexyl or cyclheptyl. Likewise, in a particular preferred embodiment, R² and/or R³ are C₃-C₈-cycloalkyl which is substituted by one, two or three of identical or different radicals selected from F, Cl, Br, I, C₁-C₈-alkyl, OR²⁰, COOR²² and CONR²³R²⁴, where R²⁰, R²², R²³ and R²⁴ are as defined above.

Likewise, in a preferred embodiment, R² and/or R³ are phenyl, which is unsubstituted or has 1, 2, 3, 4 or 5 identical or different radicals R^{2c} selected from F, Cl, Br, I, C₁-C₁₀-alkyl, SR¹⁹ and OR²⁰. R¹⁹ and R²⁰ are as defined above and preferably have one of the meanings being preferred. More preferably, R² and/or R³ are phenyl which is unsubstituted or substituted by 1, 2, 3, 4 or 5 identical or different radicals which are selected from the group consisting of F, Cl, Br, I, OH, NO₂, C₁-C₁₀-alkyl, C₁-C₄-alkoxy, heterocyclyl-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂. In particular R² and/or R³ are phenyl which is unsubstituted or substituted by 1 or 2 identical or different radicals selected from fluorine, chlorine, hydroxy, nitro, C₁-C₁₀-alkyl, C₁-C₄-alkoxy, C₁-C₄-fluoralkylcarbonyloxy and (heterocyclyl)C₁-C₄-alkoxy, where the heterocyclyl moiety is a 5- to 6-membered saturated heterocyclic ring comprising besides carbon atoms one or two heteroatoms selected from O or S.

In this embodiment, examples for R² and/or R³ are phenyl; phenyl substituted by one, two, three or four C₁-C₁₀ alkyl groups, especially 2-methylphenyl, 3-methylphenyl, 4-methylphenyl, 2-ethylphenyl, 3-ethylphenyl, 4-ethylphenyl, 2-, 3-, 4-n-propylphenyl, 2-, 3-, 4-isopropylphenyl, 2-, 3-, 4-butylphenyl, 2-(1,1,3,3-tetramethylbutyl)phenyl, 3-(1,1,3,3-tetramethylbutyl)phenyl, 4-(1,1,3,3-tetramethylbutyl)phenyl, 2,4-dimethylphenyl, 3,5-dimethylphenyl, 3,5-diisopropylphenyl; phenyl substituted by OH, especially 2-hydroxyphenyl, 3-hydroxyphenyl and 4-hydroxyphenyl; phenyl substituted by one, two, three or four groups selected from OH and C₁-C₁₀ alkyl, especially are 2-hydroxy-5-(1,1,3,3-tetramethylbutyl)phenyl, 3,5-diisopropyl-4-hydroxyphenyl, 5-tert-butyl-4-hydroxy-2-methylphenyl or 3,5-di-tert-butyl-4-hydroxyphenyl; phenyl substituted by heterocyclyl-C₁-C₄-alkoxy, especially 2-(tetrahydrofuran-2-ylmethoxy)phenyl, 3-(tetrahydrofuran-2-ylmethoxy)phenyl, 4-(tetrahydrofuran-2-ylmethoxy)phenyl, 2-(tetrahydrofuran-3-ylmethoxy)phenyl, 3-(tetrahydrofuran-3-ylmethoxy)phenyl, 4-(tetrahydrofuran-3-ylmethoxy)phenyl, 2-(tetrahydrothiophen-2-ylmethoxy)phenyl, 3-(tetrahydrothiophen-2-ylmethoxy)phenyl, 4-(tetrahydrothiophen-2-ylmethoxy)phenyl, 2-(tetrahydrothiophen-3-ylmethoxy)phenyl, 3-(tetrahydrothiophen-3-ylmethoxy)phenyl or 4-(tetrahydrothiophen -ylmethoxy)phenyl; phenyl substituted by C₁-C₄-fluoroalkanoyloxy, especially 2,2,2-trifluoroacetoxyphenyl or 3,3,3-trifluoropropionyloxyphenyl.

Examples for radicals R² and R³ are benzyl, 4-methoxybenzyl, 4-methylbenzyl, 4-ethoxycarbonylbenzyl, 4-chlorobenzyl, 2,4-dichlorobenzyl, 3,4-dichlorobenzyl, 4-nitrobenzyl, 4-diisopropylcarbamoylbenzyl, 4-(2-hydroxyethoxycarbonyl)benzyl, 4-(2-methoxy-1-methylethoxycarbonyl)benzyl, 4-ethoxycarbonylbenzyl, 4-benzyloxycarbonylbenzyl, 3-methoxybenzyl, 3-methylbenzyl, 3-chlorobenzyl, 2-methylbenzyl, 2-chlorobenzyl, 1-naphthylmethyl, 2-naphthylmethyl, 2-methoxycarbonylethyl, 2-phenoxyethyl, 2-oxo-1,2-diphenylethyl, 2-oxo-2-phenylethyl, 2-benzyloxycarbonyl-ethyl, 2-benzyloxycarbonylpropyl, methyl, ethyl, n-butyl, 1-phenylethyl, 2-phenylethyl, 3-methoxybutoxycarbonylmethyl, tetrahydrofuran-2-ylmethyl, tetrahydrothiophen-2-ylmethyl, ethoxycarbonylmethyl, 2-hydroxy-5-(1,1,3,3-tetramethylbutyl)phenyl, 4-hydroxyphenyl, 4-methylphenyl, 4-isopropoxyphenyl, 4-(tetrahydrofuran-2-ylmethoxy)phenyl, 2,2,2-trifluoroacetoxyphenyl, 3,5-diisopropyl-4-hydroxy-phenyl, 3,5-di-tert-butyl-4-hydroxyphenyl, 3-methyl-4-hydroxyphenyl, 2-methyl-4-hydroxyphenyl, 5-tert-butyl-4-hydroxy-2-methylphenyl, 4-(tetrahydrofuran-2-ylmethoxy)phenyl, 4-(tetrahydrofuran-3-ylmethoxy)phenyl, 4-(tetrahydrothiophen-2-ylmethoxy)phenyl, or 4-(tetrahydrothiophen-3-ylmethoxy)phenyl.

Specific examples for R² are
C₁-C₈-alkyl such as methyl, n-butyl, n-octyl;
C₁-C₄-alkoxy-C₁-C₄-alkyl such as ethoxycarbonylmethyl, methoxycarbonylethyl, methoxycarbonylmethyl;
C₁-C₄-alkoxy-C₁-C₄-alkoxy-C(═O)—C₁-C₆-alkyl such as 3-methoxybutoxycarbonylmethyl;
(5-or 6-membered heterocycloalkyl)-C₁-C₄-alkyl such as tetrahydrofuran-2-ylmethyl;
naphthalene-C₁-C₄-alkyl such as naphthalene-1-ylmethyl;
phenyl-C₁-C₄-alkyl such as benzyl, 1-phenylethyl, phenethyl;
phenyl-C₁-C₄-alkyl, where the alkyl moiety is substituted by benzoyl such as 2-oxo-1,2-diphenylethyl;
phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl, C(═O)N(C₁-C₈-alkyl)₂ such as 2-chlorobenzyl, 2-methylbenzyl, 3-methylbenzyl, 3,4-dichlorobenzyl, 3,5-dichlorobenzyl, 3-hydroxybenzyl, 3-methoxybenzyl, 3-methoxybenzyl, 4-methylbenzyl, 4-nitrobenzyl, 4-(diisopropylaminocarbonyl) benzyl, 2-methoxy-1-methyl-ethoxycarbonylbenzyl, 4-(2-ethoxycarbonyl)benzyl, 4-(2-hydroxyethoxycarbonyl)benzyl, 4-(2-methoxy-1-methylethoxycarbonyl)benzyl, 4-benzyloxycarbonylbenzyl, 4-chlorobenzyl;
benzoyl-C₁-C₄-alkyl such as 2-oxo-2-phenylethyl;
phenoxy-C₁-C₄-alkyl such as 2-phenoxyethyl,
benzyloxycarbonyl-C₁-C₄-alkyl such as 2-benzyloxycarbonylpropyl;
phenyl;
phenyl which is substituted by 1, 2, 3, 4 or 5 radicals selected from OH and C₁-C₁₀-alkyl such as 4-hydroxyphenyl, 4-isopropoxyphenyl, 4-hydroxy-2-methyl-5-tert-butylphenyl, 4-hydroxy-3-methyl-phenyl, or 2-hydroxy-5(1,1,3,3-tetramethylbutyl)-phenyl.

Specific examples for R³ are
C₁-C₈-alkyl such as methyl, n-butyl, n-octyl;
C₁-C₄-alkoxy-C₁-C₆-alkyl such as methoxycarbonylethyl;
benzyloxycarbonyl-C₁-C₄-alkyl such as 2-benzyloxycarbonylpropyl;
phenyl;
phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy, and C₁-C₁₀-alkyl such as 2-hydroxy-5(1,1,3,3-tetramethylbutyl)-phenyl, 4-(2,2,2-trifluoroacetoxy)phenyl, 3,5-diisopropyl-4-hydroxyphenyl, 3-methoxyphenyl, 4-(tetrahydrofuran-2-ylmethoxy)phenyl, 4-hydropxyphenyl, 4-hydroxy-2-methyl-5-tert-butyl-phenyl, 4-hydroxy-2-methyl-phenyl, 4-hydroxy-3-methyl-phenyl, 4-hydroxyphenyl, 4-isopropoxyphenyl;
phenyl-C₁-C₄-alkyl such as benzyl;
phenyl-C₁-C₄-alkyl, where the phenyl moiety is substituted by 1, 2, 3, 4 or 5 radicals selected from C₁-C₄-alkyl such as 4-methylbenzyl.

A further preferred embodiment of the invention relates to compositions, compounds, methods and uses, wherein R² and R³ are identical. A further preferred embodiment of the invention relates to compositions, compounds, methods and uses, wherein R² is different from R³.

A further preferred embodiment of the invention relates to compositions, compounds, methods and uses, wherein where R¹ and R² or R² and R³ or R¹ and R³ together form a straight-chain C₄-C₅ alkylene chain, thus forming, together with the sulfur atom to which they are bound, a 5- or 6-membered saturated heterocyclic ring which may be fused to one phenyl ring. In particular, R¹ and R² together with the sulfur atom to which they are bound form a tetrahydrothiophen-1-yl or 1,3-dihydrobenzo[c]thiophen-2-yl radical.

A further preferred embodiment of the invention relates to compounds, wherein R⁴ is C₃-C₁₂-alkyl. A further preferred embodiment of the invention relates to compositions, methods and uses, wherein R⁴ is C₁-C₁₂-alkyl.

A further preferred embodiment of the invention relates to compositions, compounds, methods and uses, wherein R⁴ is —NR¹¹R¹², —N═CR¹³R¹⁴, C₁-C₁₂-alkyl which is substituted by one or more identical or different radicals R^{4a}; C₂-C₁₂-alkenyl; C₂-C₁₂-alkenyl which is substituted by one or more identical or different radicals R^{4a}; C₃-C₁₂-cycloalkyl; C₃-C₁₂-cycloalkyl which is substituted by one or more identical or different radicals R^{4b}; heterocyclyl; heterocycyl which is substituted by one or more identical or different radicals R^{4b}; phenyl; or phenyl which is substituted by one or more identical or different radicals R^{4c}, where R¹¹, R¹², R¹³, R¹⁴, R^{4a}, R^{4b} and R^{4c} are as defined and have preferably the meanings being preferred and where cycloalkyl and heterocyclyl may be interrupted by one or more CO groups and

in addition 2 geminally bound radicals R^{4a} together may also form an N-hydroxyimino group.

According to a specific aspect of this embodiment, R⁴ in formula Ia is selected from NR¹¹R¹²; —N═CR¹³R¹⁴; C₂-C₁₂-alkenyl; C₁-C₁₂-alkyl, C₂-C₁₂-alkenyl, where the two last-mentioned radicals are substituted by one or more identical or different radicals R^{4a} selected from F, Cl, Br, I, OR²⁰, COR²¹, COOR²², C₃-C₂₀-cycloalkyl, heterocycloalkyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴; and where cycloalkyl and heterocycloalkyl may be interrupted by one or more CO groups and in addition 2 geminally bound radicals R^{4a} together may also form an N-hydroxyimino group; and

phenyl, which may be substituted by one or more C₁-C₁₂-alkyl, F, Cl, Br, I, NO₂ or COOR²²,
where R¹¹, R¹², R¹³, R¹⁴, R¹⁹, R²⁰, R²¹, R²², R²³ and R²⁴ are as defined in claim 1

According to a specific aspect of this embodiment, R⁴ is preferably selected from
NR¹¹R¹²;
—N═CR¹³R¹⁴;
C₂-C₁₂-alkenyl;
C₁-C₁₂-alkyl, which is substituted by one or more, e.g. 1, 2, 3, 4, 5, or more than 5, F, Cl, Br, I, OR²⁰, COR²¹, COOR²², heterocyclyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴;
C₂-C₁₂-alkenyl, which is substituted by one or more, e.g. 1, 2, 3, 4, 5, or more than 5, F, Cl, Br, I, OR²⁰, COR²¹, COOR²², heterocyclyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴;
phenyl; and
phenyl, which is substituted by one or more, e.g. 1, 2, 3, 4 or 5, C₁-C₁₂-alkyl, F, Cl, Br, I, NO₂ or COOR²²;
   where R¹¹, R¹², R¹³, R¹⁴, R¹⁹, R²⁰, R²¹, R²², R²³ and R²⁴ are as defined above and preferably have one of the meanings being preferred.

According to a specific aspect of this embodiment R⁴ is selected from C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenyl-C₁-C₆-alkyl; phenoxy-C₁-C₆-alkyl; (C₁-C₄-alkyl)-phenyl-C₁-C₆-alkyl; nitrophenyl-C₁-C₆-alkyl; C₁-C₆-alkyl which is substituted one, two, three or four radicals selected from hydroxy, N-hydroxyimino and benzoyl; C₃-C₁₂-cycloalkyl; C₃-C₁₂-cycloalkyl which is substituted by 1, 2, 3, 4, or 5 radicals selected from C₁-C₄-alkyl, especially C₃-C₈-cycloalkyl which is substituted by one or two C₁-C₆-alkyl groups; phenyl-C₃-C₆-alkenyl; and phenyl-C₃-C₆-alkenyl in which the phenyl moiety is substituted by 1, 2, 3, 4, or 5 radicals selected from C₁-C₄-alkyl.

According to a specific aspect of this embodiment R⁴ is a radical of the formula NR¹¹R¹², in which R¹¹ and R¹² are independently of one another selected from hydrogen, C₁-C₁₂-alkyl, C₃-C₁₂-cycloalkyl, heterocyclyl, benzoyl and phenyl,

where C₁-C₁₂-alkyl may be substituted by one or more identical or different radicals R^{11a} and/or may be interrupted by one or more non-adjacent heteroatoms selected from O and S,
where C₃-C₁₂-cycloalkyl and heterocyclyl may be substituted by one or more identical or different radicals Rub, and
where phenyl may be substituted by one or more identical or different radicals R^{11c} and R^{11a}, R^{11b}, R^{11c} are as defined above. According to a more specific aspect of this embodiment, R¹¹ is phenyl and R¹² is benzoyl.

According to a further specific aspect of this embodiment R⁴ is a radical of the formula NR¹¹R¹², in which R¹¹ and R¹² together form a straight-chain C₄-C₅-alkylene or a straight-chain C₄-C₅-alkenylene chain, where alkylene and alkenylene may be substituted by one or more radicals R^{11f} and/or may be interrupted by one or more non-adjacent heteroatoms selected from —O—, and —S— and/in addition one or more CH₂ groups of alkylene or alkenylene may be replaced by a C═O group, or

R¹¹ and R¹², may together form an o-phenylenedicarbonyl or 1,8-naphthalenedicarbonyl group, where the two last mentioned radicals may be substituted by one or more radicals R^{11f}, where R^{11f} is as defined above.

According to a further specific aspect of this embodiment R⁴ is a radical of the formula —N═CR¹³R¹⁴, in which

R¹³ and R¹⁴ are independently of one another are selected from hydrogen, CN, NO₂, SR¹⁹, OR²⁰, COR²¹, COOR²², CONR²³R²⁴, C₁-C₁₂-alkyl, C₂-C₁₂-alkenyl, C₂-C₁₂-alkynyl, C₃-C₁₂-cycloalkyl, heterocycloalkyl and phenyl,

where C₁-C₁₂-alkyl, C₂-C₁₂-alkenyl and C₂-C₁₂-alkynyl may be substituted by one or more identical or different radicals R^{13a}, where R^{13a} is as defined above,
where C₃-C₁₂-cycloalkyl and heterocycloalkyl may be substituted by one or more radicals R^{13b}, where R^{13b} is as defined above,
where phenyl may be substituted by one or more radicals R^{13c}, where R^{13c} is as defined above
or

R¹³ and R¹⁴ may together form a straight-chain C₂-C₆-alkylene or a straight-chain C₂-C₆-alkenylene chain, where alkylene and alkenylene may be substituted by one or more radicals R³² and/or may be interrupted by one or more non-adjacent heteroatoms selected from —O—, and in addition one or more CH₂ groups of alkylene or alkenylene may be replaced by a C═O group

where R¹⁹, R²⁰, R²¹, R²², R²³, R²⁴ and R³² are as defined above and have preferably one of the meanings being preferred.

More preferably, R¹³ and R¹⁴ are independently of one another selected from
C₁-C₈-alkyl, such as methyl, ethyl, n-propyl, isopropyl, n-butyl, n-pentyl or n-hexyl;
C₁-C₄-alkoxycarbonyl-C₁-C₄-alkyl such as methoxycarbonylmethyl or ethoxycarbonyl-carbonylmethyl;
phenyl;
phenylsulfanyl;
C₁-C₄-alkoxycarbonyl such as methoxycarbonyl or ethoxycarbonyl;
benzoyl;
benzyloxycarbonyl;
benzoyl which is substituted by phenylsulfanyl such as 4-(phenylsulfanyl)-benzoyl;
phenyl which is substituted by phenylsulfanyl or C₁-C₄-alkylsulfanyl, such as 4-methlythiophenyl; or
R¹³ and R¹⁴ together with the carbon atom to which they are attached form a C₅-C₈-cycloalkyl ring, such as a cyclohexyl ring.

Examples for R⁴ are benzyl, 4-nitrobenzyl, naphthalene-1-ylmethyl, 1,1-diphenylmethyl, thiophen-2-ylmethyl, 1-phenylethyl, 2-oxo-1,2-diphenylethyl, 2-hydroxy-1,2-diphenylethyl, 1,1-dimethyl-2-oxo-2-phenyl-ethyl, 2-hydroxyimino-1,2-diphenylethyl, 1-methoxycarbonyl-1-methyl-ethyl, 2,2,2-trifluoroethyl, 2-methoxyethyl, 2-methoxy-1-methyl-ethyl, 2-phenoxyethyl, 3-phenylallyl, 4-tert-butylphenyl, 4-isopropylphenyl, cyclohexyl, cyclododecyl, 2-isopropyl-5-methyl-cyclohexyl, 4-tert-butylcylohexyl, (R) 4-tert-butylcylohexyl, (S) 4-tert-butylcylohexyl, 2,2,3,3-tetrafluoropropyl,

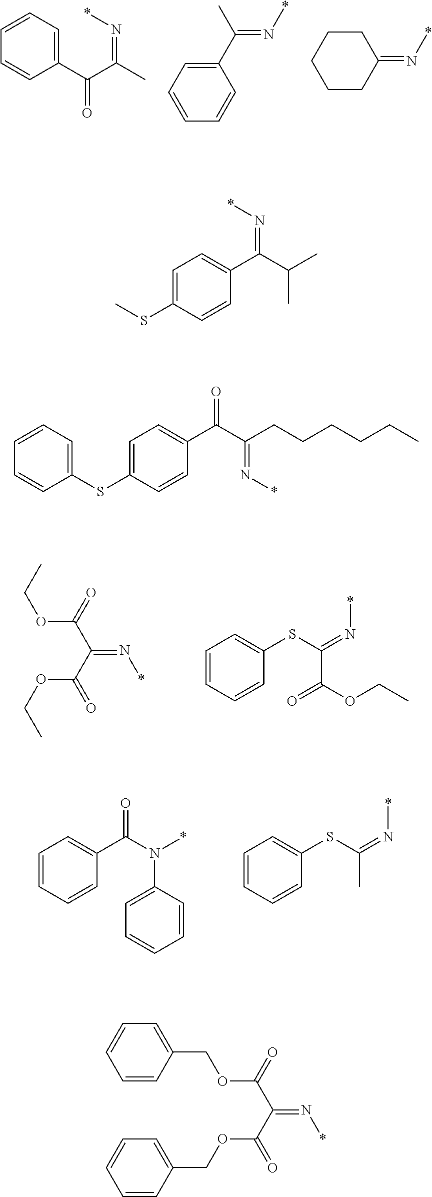

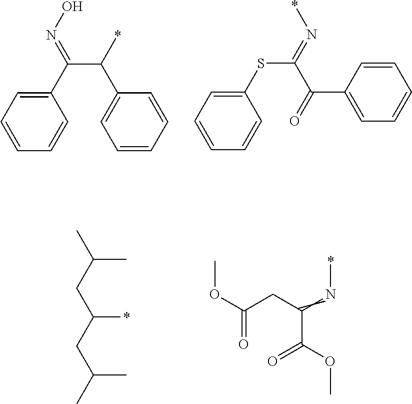

where * denotes the point of attachment to the oxygen atom of the sulfate group.

With respect to the intended use of the compounds of formula Ia, the substituents R¹, R², R³ and R⁴ independently of one another and preferably in combination have the following meanings:

R¹ is selected from
the group of the formula A, preferably a group A

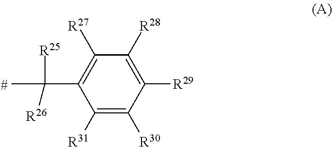

where
R²⁵ and R²⁶ are each independently of one another selected from hydrogen, C₁-C₁₂-alkyl and phenyl; and
R²⁷, R²⁸, R²⁹, R³⁹ and R³¹ are each independently of one another selected from hydrogen, F, Cl, Br, I, NO₂, OR²⁰, COOR²², CONR²³R²⁴, C₁-C₁₂ alkyl, C₂-C₁₂-alkenyl and phenyl or
two radicals R²⁷ and R²⁸, and/or R²⁸ and R²⁹ and/or R²⁹ and R³⁰ and/or R³⁰ and
R³¹ bound on adjacent carbon atoms may be together a group selected from —CH₂CH₂CH₂—, —CH₂CH₂CH₂CH₂— and —CH═CH—CH═CH—, thus forming, together with the carbon atoms to which they are bound, a 5- or 6-membered ring;
the group of the formula B, preferably a group B

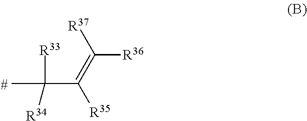

where
R³³ and R³⁴ are each independently of one another selected from hydrogen, C₁-C₁₂-alkyl and phenyl; and
R³⁵, R³⁶ and R³⁷ are independently of one another selected from hydrogen, F, Cl, C₁-C₁₂-alkyl, C₂-C₁₂-alkenyl and phenyl;
C₃-C₁₂-cycloalkyl which may be substituted by one or more radicals selected from F, Cl, Br, I, C₁-C₁₂-alkyl, OR²⁰, COR²¹, COOR²² and CONR²³R²⁴, preferably C₃-C₈-cycloalkyl;
C₁-C₁₂-alkyl which may be substituted by one or more radicals selected from F, Cl, Br, I, OR²⁰, COR²¹, COOR²², CONR²³R²⁴, C₃-C₁₂-cycloalkyl and heterocyclyl, preferably C₁-C₆-alkyl, C₁-C₄-alkoxy-(CO)—C₁-C₄-alkyl; (5- or 6-membered saturated heterocycloalkyl)-C₁-C₄-alkyl or phenoxy-C₁-C₄-alkyl;

R² and R³ are independently of one another selected from
C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;
C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and
phenyl, which is unsubstituted or substituted by one, two, three, four or five radicals selected from F, Cl, Br, I, C₁-C₁₀-alkyl, SR¹⁹ and OR²⁰;
or R¹ and R² or R² and R³ or R¹ and R³ in formula Ia together with the sulfur atom to which they are bound, form a 5- or 6-membered, saturated heterocycle, which may be fused to one phenyl ring;

R⁴ is
NR¹¹R¹²;
—N═CR¹³R¹⁴, wherein R¹³ and R¹⁴ are, independently of one another, selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, phenylsulfanyl-benzoyl or R¹³ and R¹⁴ together with the carbon atom to which they are bound form a C₅-C₈-cycloalkyl ring
C₁-C₁₂-alkyl, C₂-C₁₂-alkenyl, where the two last-mentioned radicals may be substituted by one or more identical or different radicals R^{4a} selected from F, Cl, Br, I, OR²⁰, COR²¹, COOR²², C₃-C₂₀-cycloalkyl, heterocycloalkyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴ and where cycloalkyl and heterocycloalkyl may be interrupted by one or more CO groups and in addition 2 geminally bound radicals R^{4a} together may also form an N-hydroxyimino group,
phenyl, which may be substituted by one or more C₁-C₁₂-alkyl, F, Cl, Br, I, NO₂ or COOR²²
   where R¹¹, R¹², R¹⁹, R²⁰; R²², R²³ and R²⁴ are as defined above
   with the proviso that R¹ is the group A or the group B, if R² and R³ are selected from the group consisting of C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;

According to a specific aspect of this embodiment:
R¹ is a group of the formula A as defined above; a group of the formula B as defined above; C₃-C₈-cycloalkyl; C₁-C₆-alkyl; C₁-C₄-alkoxy-(CO)—C₁-C₄-alkyl; (5- or 6-membered saturated heterocycloalkyl)-C₁-C₄-alkyl; or phenoxy-C₁-C₄-alkyl;
R² C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; phenyl; phenyl which is substituted by 1, 2, 3, 4 or 5 radicals selected from OH and C₁-C₁₀-alkyl;
R³ is C₁-C₈-alkyl; C₁-C₄-alkoxy-C₁-C₆-alkyl; benzyloxycarbonyl-C₁-C₄-alkyl; phenyl; phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy and C₁-C₁₀-alkyl; phenyl-C₁-C₄-alkyl; phenyl-C₁-C₄-alkyl, where the phenyl moiety is substituted by 1, 2, 3, 4 or 5 radicals selected from C₁-C₄-alkyl such as 4-methylbenzyl;
R⁴ is C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)phenyl-C₁-C₆-alkyl; nitro-phenyl-C₁-C₆-alkyl; C₁-C₁₂-alkyl which may be substituted by 1, 2, 3 or 4 radicals selected from OH, N-hydroxyimino, benzoyl, phenyl and phenoxy;
   phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl;
   NR¹¹R¹², where R¹¹ and R¹² are as defined above;
   —N═CR¹³R¹⁴, wherein R¹³ and R¹⁴ are as defined above;
      with the proviso that R¹ is the group A or the group B, if
   R² is selected from C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; and
   R³ is selected from C₁-C₈-alkyl; C₁-C₄-alkoxy-C₁-C₆-alkyl; benzyloxycarbonyl-C₁-C₄-alkyl; phenyl-C₁-C₄-alkyl; phenyl-C₁-C₄-alkyl, where the phenyl moiety is substituted by 1, 2, 3, 4 or 5 radicals selected from C₁-C₄-alkyl such as 4-methylbenzyl.

According to a more specific aspect of this embodiment,
R¹ is naphthylmethyl; benzyl; benzyl which is substituted by one or two radicals selected from nitro, fluorine, chlorine, C₁-C₄-alkyl, C₁-C₄-alkoxy, C₁-C₄-alkoxycarbonyl, C(O)O—(C₁-C₄-alkyl-OH) and C(O)N(C₁-C₄-alkyl)₂; C₃-C₈-cycloalkyl; C₁-C₆-alkyl; C₁-C₄-alkoxy-(CO)—C₁-C₄-alkyl; (5- or 6-membered saturated heterocycloalkyl)-C₁-C₄-alkyl; phenoxy-C₁-C₄-alkyl; prop-2-en-1-yl, 3-phenyl-prop-2-en-1-yl, 2-(C₁-C₄-alkyl)-prop-2-en-1-yl; or 3-(C₁-C₄-alkyl)-prop-2-en-1-yl;
R² C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; phenyl; phenyl which is substituted by 1, 2, 3, 4 or 5 radicals selected from OH and C₁-C₁₀-alkyl;
R³ is C₁-C₈-alkyl; C₁-C₄-alkoxy-C₁-C₆-alkyl; benzyloxycarbonyl-C₁-C₄-alkyl; phenyl; phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy, and C₁-C₁₀-alkyl such as 2-hydroxy-5(1,1,3,3-tetramethylbutyl)-phenyl, 4-(2,2,2-trifluoroacetoxy)phenyl, 3,5-diisopropyl-4-hydroxyphenyl, 3-methoxyphenyl, 4-(tetrahydrofuran-2-ylmethoxy)phenyl, 4-hydropxyphenyl, 4-hydroxy-2-methyl-5-tert-butyl-phenyl, 4-hydroxy-2-methyl-phenyl, 4-hydroxy-3-methyl-phenyl, 4-hydroxyphenyl and 4-isopropoxyphenyl; phenyl-C₁-C₄-alkyl; phenyl-C₁-C₄-alkyl, where the phenyl moiety is substituted by 1, 2, 3, 4 or 5 radicals selected from C₁-C₄-alkyl such as 4-methylbenzyl;
R⁴ is C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)phenyl-C₁-C₆-alkyl; nitro-phenyl-C₁-C₆-alkyl; C₁-C₆-alkyl which may be substituted by 1, 2, 3 or 4 radicals selected from OH, N-hydroxyimino, benzoyl, phenyl and phenoxy;
   phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl;
   NR¹¹R¹², where R¹¹ and R¹² are as defined above;
   —N═CR¹³R¹⁴, wherein R¹³ and R¹⁴ are, independently of one another, selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, phenylsulfanyl-benzoyl or R¹³ and R¹⁴ together with the carbon atom to which they are bound form a C₅-C₈-cycloalkyl ring.

According to an further specific aspect of this embodiment,
R¹ is a group of the formula A or a group of the formula B, where the group of the formula A and the group B are as defined above and preferably have one of the preferred meanings;
R² C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; phenyl; phenyl which is substituted by 1, 2, 3, 4 or 5 radicals selected from OH and C₁-C₁₀-alkyl;
R³ is C₁-C₈-alkyl; C₁-C₄-alkoxy-C₁-C₆-alkyl; benzyloxycarbonyl-C₁-C₄-alkyl; phenyl; phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy and C₁-C₁₀-alkyl; phenyl-C₁-C₄-alkyl; phenyl-C₁-C₄-alkyl, where the phenyl moiety is substituted by 1, 2, 3, 4 or 5 radicals selected from C₁-C₄-alkyl such as 4-methylbenzyl;
R⁴ is C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)phenyl-C₁-C₆-alkyl; nitro-phenyl-C₁-C₆-alkyl; C₁-C₁₂-alkyl which may be substituted by 1, 2, 3 or 4 radicals selected from OH, N-hydroxyimino, benzoyl, phenyl and phenoxy;
   phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl;
   NR¹¹R¹², where R¹¹ and R¹² are as defined above and preferably have one of the preferred meanings; or
   —N═CR¹³R¹⁴, wherein R¹³ and R¹⁴ are as defined above and preferably have one of the preferred meanings.

According to an even more specific aspect of this embodiment,
R¹ is benzyl, C₁-C₄-alkyl, C₅-C₈-cycloalkyl, 3-methylbut-2-enyl or tetrahydrofuran-2-ylmethyl;
R² is benzyl;
R³ is benzyl;
R⁴ is benzyl.

According to a further even more specific aspect of this embodiment,
R¹ is benzyl, C₁-C₄-alkyl, C₅-C₈-cycloalkyl, 3-methylbut-2-enyl or tetrahydrofuran-2-ylmethyl;
R² is benzyl;
R³ is benzyl;
R⁴ is 1-phenylethyl.

According to a further even more specific aspect of this embodiment,
R¹ is benzyl, C₁-C₄-alkyl, C₃-C₈-cycloalkyl, 3-methylbut-2-enyl or tetrahydrofuran-2-ylmethyl;
R² is benzyl;
R³ is benzyl;
R⁴ is 2-oxo-2-phenylethyl.

According to a further even more specific aspect of this embodiment,
R¹ is benzyl;
R² is C₁-C₄-alkyl;
R³ is C₁-C₄-alkyl;
R⁴ is benzyl,

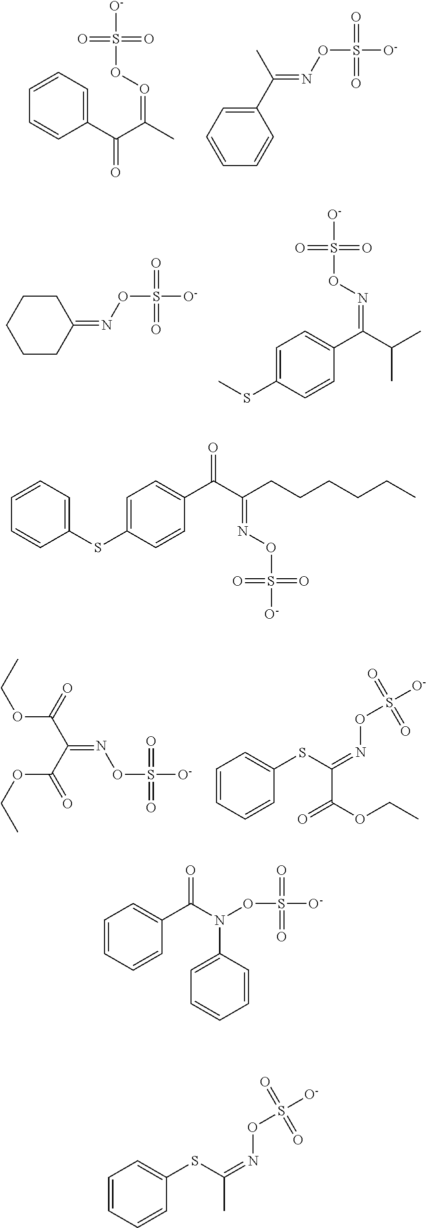

A further preferred embodiment of the invention relates to compositions, compounds, methods and uses, where in the compound of the formula Ib, R⁵, R⁶, R⁷ and R⁸ can be identical or different. Preferably, R⁵ and R⁷ are identical and R⁶ and R⁸ are identical.

A further preferred embodiment of the invention relates to compositions, compounds, methods and uses, where R⁵, R⁶, R⁷ and R⁸ are independently of one another selected from C₁-C₁₂-alkyl; C₁-C₁₂-alkyl, which is substituted by one or more identical or different radicals Rya, where Rya is as defined above; C₃-C₁₂-cycloalkyl; C₃-C₁₂-cycloalkyl, which is substituted by one or more identical or different radicals R^{5b}, where R^{5b} is as defined above; phenyl; and phenyl, which is substituted by one, two, three, four or five radicals R^{5c}, where R^{5c} is as defined above.

According to a preferred aspect of this embodiment, R⁵, R⁶, R⁷ and R⁸ in formula Ib are independently of one another selected from

C₁-C₁₂-alkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 identical or different radicals selected from F, Cl, Br, I, NO₂, C₁-C₁₂-alkyl, OR²⁰, COOR²² and CONR²³R²⁴,

C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴, and

phenyl, which is unsubstituted or substituted by one, two, three, four or five radicals selected from F, Cl, Br, I, C₁-C₁₀-alkyl, SR¹⁹ and OR²⁰,
where R¹⁹, R²⁰, R²², R²³ and R²⁴ are as defined above.

According to an even more preferred aspect of this embodiment R⁵ and/or R⁶ and/or R⁷, and/or R⁸ are C₁-C₁₂-alkyl which is unsubstituted or is partly or completely halogenated and/or has 1, 2 or 3 identical or different radicals Rya selected from OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 identical or different radicals selected from C₁-C₁₂-alkyl, F, Cl, Br, I, NO₂, OR²⁰, COOR²² and CONR²³R²⁴. R²⁰, R²², R²³ and R²⁴ are as defined above and preferably have one of the meanings being preferred. Examples are C₁-C₆-alkyl such as methyl, ethyl, n-propyl, isopropyl, n-butyl, sec-butyl, tert-butyl, n-pentyl or hexyl, in particular methyl, ethyl, n-propyl or n-butyl.

According to a further even more preferred aspect of this embodiment R⁵ and/or R⁶ and/or R⁷, and/or R⁸ are C₁-C₆-fluoroalkyl; C₁-C₆-chloroalkyl; C₁-C₄-alkoxy-C₁-C₆-alkyl; phenoxy-C₁-C₆-alkyl; benzoyl-C₁-C₆-alkyl; phenyl-C₁-C₆-alkyl, where the alkyl moiety of phenylalkyl is substituted by benzoyl; C₁-C₄-alkoxycarbonyl-C₁-C₆-alkyl; C₁-C₄-alkoxy-C₁-C₄-alkoxycarbonyl-C₁-C₆-alkyl; C₃-C₈-cycloalkyl-C₁-C₆-alkyl; naphthyl-C₁-C₆-alkyl; heterocyclyl-C₁-C₆-alkyl, wherein heterocyclyl is a 5- to 6-membered saturated heterocyclic ring comprising besides carbon atoms one or two heteroatoms selected from O and S; phenyl-C₁-C₆-alkyl, in which the phenyl moiety of phenylalkyl is unsubstituted or substituted by 1, 2, 3, 4 or 5 identical or different radicals selected from F, Cl, Br, I, OH, NO₂, C₁-C₁₀-alkyl, C₁-C₄-alkoxy, heterocyclyl-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂. Examples are C₁-C₄-fluoroalkyl; C₁-C₄-chloroalkyl; C₁-C₄-alkoxy-C₁-C₈-alkyl such as 2-methoxy-ethyl or 3-methoxypropyl; phenoxy-C₁-C₄-alkyl such as phenoxymethyl, 2-phenoxyethyl or 3-phenoxypropyl; benzoyl-C₁-C₄-alkyl such as 2-oxo-2-phenylethyl, 3-oxo-3-phenylpropyl or 4-oxo-4-phenylbutyl; phenyl-C₁-C₄-alkyl, where the alkyl moiety of phenylalkyl is substituted by benzoyl such as 2-oxo-1,2-diphenylethyl, 3-oxo-1,3-diphenylpropyl or 4-oxo-1,4-diphenylbutyl; C₁-C₄-alkoxycarbonyl-C₁-C₄-alkyl such as methoxycarbonylmethyl, ethoxycarbonylmethyl, 2-methoxycarbonylethyl, 2-ethoxycarbonylethyl, 3-methoxycarbonylpropyl, 3-ethoxycarbonylpropyl, 4-methoxycarbonylbutyl or 4-ethoxycarbonylbutyl; C₁-C₄-alkoxy-C₁-C₄-alkoxycarbonyl-C₁-C₄-alkyl such as 3-methoxybutoxycarbonylmethyl, 3-methoxybutoxycarbonylethyl, 3-ethoxybutoxycarbonylmethyl or 3-ethoxybutoxycarbonylethyl; C₃-C₈-cycloalkyl-C₁-C₆-alkyl such as cyclohexylmethyl, 2-cyclohexylethyl, cyclopentylmethyl or 2-cyclopentylethyl; naphthyl-C₁-C₄-alkyl such as 1-naphthylmethyl, 2-napthylmethyl, 1-(naphthalene-1-yl)ethyl, 1-(naphthalene-2-yl)ethyl, 2-(naphthalene-1-yl)ethyl or 2-(naphthalene-2-yl)ethyl; heterocyclyl-C₁-C₄-alkyl such as tetrahydrofuran-2-ylmethyl, tetrahydrofuran-3-ylmethyl, 2-(tetrahydrofuran-2-yl)ethyl, 2-(tetrahydrofuran-3-yl)ethyl, 3-(tetrahydrofuran-2-yl)propyl, 3-(tetrahydrofuran-3-yl)propyl, tetrahydrothiophen-2-ylmethyl, tetrahydrothiophen-3-ylmethyl, 2-(tetrahydrothiophen-2-yl)ethyl, 2-(tetrahydrothiophen-3-yl)ethyl, 3-(tetrahydrothiophen-2-yl)propyl or 3-(tetrahydrothiophen-3-yl)propyl; phenyl-C₁-C₂-alkyl, in which the phenyl moiety of phenylalkyl is unsubstituted or substituted by 1 or 2 identical or different radicals selected from fluorine, chlorine, C₁-C₄-alkyl, C₁-C₄-alkoxy, (C₁-C₄-alkoxy)carbonyl, C(O)O —(C₁-C₄-alkyl-OH), and C(O)N(C₁-C₈-alkyl)₂; phenyl-C₁-C₄-alkyl, where the phenyl moiety of phenylalkyl is substituted by 1 or 2 chlorines such as 2-chlorobenzyl, 3-chlorobenzyl, 4-chlorobenzyl, 2,4-dichlorobenzyl, 3,4-dichlorbenzyl, 3,5-dichlorobenzyl, 2-(2-chlorophenyl)ethyl, 2-(3-chlorophenyl)ethyl, 2-(4-chlorophenyl)ethyl, 2-(2,4-dichlorophenyl)ethyl, 2-(3,5-dichlorophenyl)ethyl or 2-(3,4-dichlorophenyl)ethyl; phenyl-C₁-C₄-alkyl, where the phenyl moiety of phenylalkyl is substituted by hydroxy such as 2-hydroxybenzyl, 3-hydroxybenzyl, 4-hydroxybenzyl, 2-(2-hydroxyphenyl)ethyl, 2-(3-hydroxyphenyl)ethyl or 2-(4-hydroxyphenyl); phenyl-C₁-C₄-alkyl, where the phenyl moiety of phenylalkyl is substituted by 1 or 2 C₁-C₁₀-alkyl groups such as 2-, 3- or 4-methylbenzyl, 2-, 3-, 4-ethylbenzyl, 2-, 3-or 4-propylbenzyl, 2-, 3- or 4-butylbenzyl, 2,4-dimethylbenzyl or 3,5-dimethylbenzyl; phenyl-C₁-C₄-alkyl, where the phenyl moiety of phenylalkyl is substituted by 1 or 2 C₁-C₄-alkoxy groups such as 2-, 3- or 4-methoxybenzyl, 2-, 3-, 4-ethoxybenzyl, 2-, 3-or 4-propoxybenzyl, 2-, 3- or 4-butoxybenzyl, 2,4-dimethoxybenzyl or 3,5-dimethoxybenzyl; phenyl-C₁-C₄-alkyl, where the phenyl moiety of phenylalkyl is substituted by C₁-C₄-alkoxycarbonyl such as 2-ethoxycarbonylbenzyl, 3-ethoxycarbonylbenzyl, 4-ethoxycarbonylbenzyl, 2-(2-ethoxycarbonylphenyl)ethyl, 2-(3-ethoxycarbonylphenyl)ethyl or 4-(3-ethoxycarbonylphenyl)ethyl, phenyl-C₁-C₄-alkyl, where the phenyl moiety of phenylalkyl is substituted by hydroxy-C₁-C₄-alkoxycarbonyl such as 4-(2-hydroxyethoxycarbonyl)benzyl, 2-(4-(2-hydroxyethoxycarbonylphenyl)ethyl; phenyl-C₁-C₄-alkyl, where the phenyl moiety of phenylalkyl is substituted by C(═O)N(C₁-C₈-alkyl)₂ such as 4-dimethylcarbamoylbenzyl, 4-diethylcarbamoylbenzyl, 4-diisopropylcarbamoylbenzyl, 2-(4-dimethylcarbamoylphenyl)ethyl, 2-(4-diethylcarbamoylphenyl)ethyl or 2-(4-diisopropylcarbamoylphenyl)ethyl.

According to an even more preferred aspect of this embodiment R⁵ and/or R⁶ and/or R⁷, and/or R⁸ are C₃-C₁₂-cycloalkyl, which is unsubstituted or has 1, 2 or 3 identical or different radicals R^{5b} selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals may be substituted by 1, 2, 3, 4, or 5 different or identical radicals selected from F, Cl, Br, I, NO₂, C₁-C₁₂-alkyl, OR²⁰, COOR²² and CONR²³R²⁴. R²⁰, R²², where R²³ and R²⁴ are as defined above and preferably have one of the meanings being preferred. Examples are C₃-C₈-cycloalkyl such as cyclopropyl, cyclobutyl, cyclopentyl, cyclohexyl or cyclheptyl; C₃-C₈-cycloalkyl which is substituted by one, two or three of identical or different radicals selected from F, Cl, Br, I, C₁-C₈-alkyl, OR²⁰, COOR²² and CONR²³ where R²⁰, R²², R²³ and R²⁴ are as defined above.

According to an even more preferred aspect of this embodiment R⁵ and/or R⁶ and/or R⁷, and/or R⁸ are phenyl, which is unsubstituted or has 1, 2, 3, 4 or 5 identical or different radicals R^{5c} selected from F, Cl, Br, I, C₁-C₁₀-alkyl, SR¹⁹ and OR²⁰. R¹⁹ and R²⁰ are as defined above and preferably have one of the meanings being preferred. More preferably, R⁵ and/or R⁶ and/or R⁷, and/or R⁸ are phenyl which is unsubstituted or substituted by 1, 2, 3, 4 or 5 identical or different radicals which are selected from the group consisting of F, Cl, Br, I, OH, NO₂, C₁-C₁₀-alkyl, C₁-C₄-alkoxy, heterocyclyl-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂. Examples are phenyl which is unsubstituted or substituted by 1 or 2 identical or different radicals selected from fluorine, chlorine, hydroxy, nitro, C₁-C₁₀-alkyl, C₁-C₄-alkoxy, C₁-C₄-fluoralkylcarbonyloxy and (heterocyclyl)-C₁-C₄-alkoxy, where the heterocyclyl moiety is a 5- to 6-membered saturated heterocyclic ring comprising besides carbon atoms one or two heteroatoms selected from O or S. Examples are phenyl substituted by one, two, three or four C₁-C₁₀ alkyl groups such as 2-methylphenyl, 3-methylphenyl, 4-methylphenyl, 2-ethylphenyl, 3-ethylphenyl, 4-ethylphenyl, 2-, 3-, 4-n-propylphenyl, 2-, 3-, 4-isopropylphenyl, 2-, 3-, 4-butylphenyl, 2-(1,1,3,3-tetramethylbutyl)phenyl, 3-(1,1,3,3-tetramethylbutyl)phenyl, 4-(1,1,3,3-tetramethylbutyl)phenyl, 2,4-dimethylphenyl, 3,5-dimethylphenyl or 3,5-diisopropylphenyl; phenyl substituted by OH such as 2-hydroxyphenyl, 3-hydroxyphenyl or 4-hydroxyphenyl; phenyl substituted by one, two, three or four groups selected from OH and C₁-C₁₀ alkyl such as 2-hydroxy-5-(1,1,3,3-tetramethylbutyl)phenyl, 3,5-diisopropyl-4-hydroxyphenyl, 5-tert-butyl-4-hydroxy-2-methylphenyl and 3,5-di-tert-butyl-4-hydroxyphenyl; phenyl which is substituted by heterocyclyl-C₁-C₂-alkoxy such 2-(tetrahydrofuran-2-ylmethoxy)phenyl, 3-(tetrahydrofuran-2-ylmethoxy)phenyl, 4-(tetrahydrofuran-2-ylmethoxy)phenyl, 2-(tetrahydrofuran-3-ylmethoxy)phenyl, 3-(tetrahydrofuran-3-ylmethoxy)phenyl, 4-(tetrahydrofuran-3-ylmethoxy)phenyl, 2-(tetrahydrothiophen-2-ylmethoxy)phenyl, 3-(tetrahydrothiophen-2-ylmethoxy)phenyl, 4-(tetrahydrothiophen-2-ylmethoxy)phenyl, 2-(tetrahydrothiophen-3-ylmethoxy)phenyl, 3-(tetrahydrothiophen-3-ylmethoxy)phenyl or 4-(tetrahydrothiophen -3-ylmethoxy)phenyl; phenyl substituted by C₁-C₄-fluoroalkanoyloxy such as 2,2,2-trifluoroacetoxyphenyl or 3,3,3-trifluoropropionyloxyphenyl.

In particular R⁵, R⁶, R⁷, and R⁸ are independently of one another selected from C₁-C₄-alkyl, phenyl and phenyl, which is substituted by one or more radicals selected from OH and C₁-C₄-alkyl, in particular methyl, ethyl, n-butyl, phenyl and 4-hydroxyphenyl.

A further preferred embodiment relates to compositions, compounds, methods and uses, where R⁹ and R¹⁰ are independently of one another —NR¹¹R¹², —N═CR¹³R¹⁴, C₁-C₁₂-alkyl, C₁-C₁₂-alkyl which is substituted by one or more identical or different radicals R^{9a}, C₂-C₁₂-alkenyl which is substituted by one or more identical or different radicals R^{9a}, C₃-C₁₂-cycloalkyl, C₃-C₁₂-cycloalkyl which is substituted by one or more identical or different radicals R^{9b}, heterocyclyl, heterocycyl which is substituted by one or more identical or different radicals R^{9b}, phenyl or phenyl which is substituted by one or more identical or different radicals R^{9c}, where R¹¹, R¹², R¹³, R¹⁴, R^{9a}, R^{9b} and R^{9c} are as de fined and have preferably the meanings being preferred.

According to a specific aspect of this embodiment, R⁹ and R¹⁰ are independently of one another selected from
NR¹¹R¹²;
—N═CR¹³R¹⁴;
C₁-C₁₂-alkyl, in particular C₃-C₁₂-alkyl;
C₂-C₁₂-alkenyl;
C₁-C₁₂-alkyl, which is substituted by one or more, e.g. 1, 2 or 3, identical or different F, Cl, Br, I, SR¹⁹, OR²⁰, COR²¹, COOR²², C₃-C₂₀-cycloalkyl, heterocycloalkyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴, and where cycloalkyl and heterocycloalkyl may be interrupted by one or more CO groups;
C₂-C₁₂-alkenyl, which is substituted by one or more, e.g. 1, 2 or 3, identical or different F, Cl, Br, I, OR²⁰, COR²¹, COOR²², C₃-C₂₀-cycloalkyl, heterocycloalkyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴, and where cycloalkyl and heterocycloalkyl may be interrupted by one or more CO groups;
phenyl; and
phenyl, which is substituted by one or more, e.g. 1, 2, 3, 4 or 5, identical or different C₁-C₁₂-alkyl, F, Cl, Br, I, NO₂ or COOR²²;
   where R¹¹, R¹², R¹³, R¹⁴, R¹⁹, R²⁰, R²¹, R²², R²³ and R²⁴ are as defined above and preferably have one of the meanings being preferred.

According to a preferred aspect, R⁹ and R¹⁰ are identical.

According to a specific aspect of this embodiment R⁹ and R¹⁰ are independently of one another selected from C₁-C₆-alkyl, C₁-C₆-fluoroalkyl, phenyl-C₁-C₆-alkyl, phenoxy-C₁-C₆-alkyl, naphthyl-C₁-C₆-alkyl, (C₁-C₄-alkyl)-phenyl-C₁-C₆-alkyl, (5- or 6-membered heteroaryl)-C₁-C₆-alkyl, C₁-C₄-alkoxy-C₁-C₆-alkyl, C₁-C₄-alkylsulfanyl-C₁-C₆-alkyl, C₁-C₄-alkoxycarbonyl-C₁-C₆-alkyl and C₁-C₆-alkyl which is substituted one, two, three or four radicals selected from hydroxy, N-hydroxyimino, phenyl, benzoyl, nitrophenyl and (C₁-C₄-alkyl)-phenyl.

According to a further specific aspect of this embodiment, R⁹ and R¹⁰ are
C₃-C₁₂-cycloalkyl;
C₃-C₈-cycloalkyl which is substituted by one or two C₁-C₆-alkyl groups;
C₂-C₁₂-alkenyl which is substituted by phenyl; or
phenyl which is substituted by C₁-C₄-alkyl.

According to a further specific aspect of this embodiment, R⁹ and/or R¹⁰ are a radical of the formula NR¹¹R¹², in which R¹¹ and R¹² are independently of one another selected from hydrogen, C₁-C₁₂-alkyl, C₃-C₁₂-cycloalkyl, heterocyclyl and phenyl,

where C₁-C₁₂-alkyl may be substituted by one or more identical or different radicals R^{11a} and/or may be interrupted by one or more heteroatoms selected from O and S,
where C₃-C₁₂-cycloalkyl and heterocyclyl may be substituted by one or more identical or different radicals Rub, and
where phenyl may be substituted by one or more identical or different radicals R^{11c} and R^{11a}, R^{11b}, R^{11c} are as defined above.

According to a further specific aspect, R⁹ and/or R¹⁰ are a radical of the formula NR¹¹R¹², in which R¹¹ and R¹² together form a straight-chain C₄-C₅-alkylene or a straight-chain C₄-C₅-alkenylene chain, where alkylene and alkenylene may be substituted by one or more radicals R^{11f} and/or may be interrupted by one or more heteroatoms selected from —O—, and —S— and/in addition one or more CH₂ groups of alkylene or alkenylene may be replaced by a C═O group, or

R¹¹ and R¹², may together form an o-phenylenedicarbonyl or 1,8-naphthalenedicarbonyl group, where the two last mentioned radicals may be substituted by one or more radicals R^{11f}, where R^{11f} is as defined above.

In particular, R¹¹ and R¹² are independently of one another selected from benzoyl and phenyl.

According to a further specific aspect, R⁹ and/or R¹⁰ are a radical of the formula —N═CR¹³R¹⁴, in which

R¹³ and R¹⁴ are independently of one another are selected from hydrogen, CN, NO₂, SR¹⁹, OR²⁰, COR²¹, COOR²², CONR²³R²⁴, C₁-C₁₂-alkyl, C₂-C₁₂-alkenyl, C₂-C₁₂-alkynyl, C₃-C₁₂-cycloalkyl, heterocycloalkyl and phenyl,

where C₁-C₁₂-alkyl, C₂-C₁₂-alkenyl and C₂-C₁₂-alkynyl may be substituted by one or more identical or different radicals R^{13a}, where R^{13a} is as defined above,
where C₃-C₁₂-cycloalkyl and heterocycloalkyl may be substituted by one or more radicals R^{13b}, where R^{13b} is as defined above,
where phenyl may be substituted by one or more radicals R^{13c}, where R^{13c} is as defined above
or

R¹³ and R¹⁴ may together form a straight-chain C₂-C₆-alkylene or a straight-chain C₂-C₆-alkenylene chain, where alkylene and alkenylene may be substituted by one or more radicals R³² and/or may be interrupted by one or more heteroatoms selected from —O—, and in addition one or more CH₂ groups of alkylene or alkenylene may be replaced by a C═O group

where R¹⁹, R²⁰, R²¹, R²², R²³, R²⁴ and R³² are as defined above and have preferably one of the meanings being preferred.

More preferably, R¹³ and R¹⁴ are independently of one another selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl and phenyl which is substituted by phenylsulfanyl or C₁-C₄-alkylsulfanyl or R¹³ and R¹⁴ together with the carbon atom to which they are attached form a cyclohexyl ring.

Examples for R⁹ and R¹⁰ are benzyl, 4-nitrobenzyl, naphthalene-1-ylmethyl, 1,1-diphenylmethyl, thiophen-2-ylmethyl, 1-phenylethyl, 2-oxo-1,2-diphenylethyl, 2-hydroxy-1,2-diphenylethyl, 1,1-dimethyl-2-oxo-2-phenyl-ethyl, 2-hydroxyimino-1,2-diphenylethyl, 1-methoxycarbonyl-1-methyl-ethyl, 2,2,2-trifluoroethyl, 2-methoxyethyl, 2-methoxy-1-methyl-ethyl, 2-phenoxyethyl, 3-phenylallyl, 4-tert-butylphenyl, 4-isopropylphenyl, cyclohexyl, cyclododecyl, 2-isopropyl-5-methyl-cyclohexyl, 4-tert-butylcylohexyl, (R) 4-tert-butylcylohexyl, (S) 4-tert-butylcylohexyl, 2,2,3,3-tetrafluoropropyl,

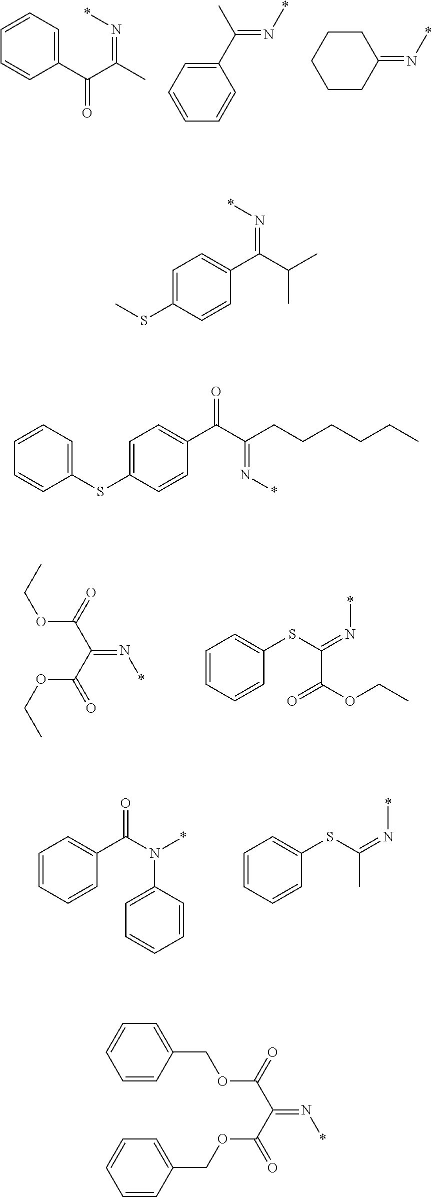

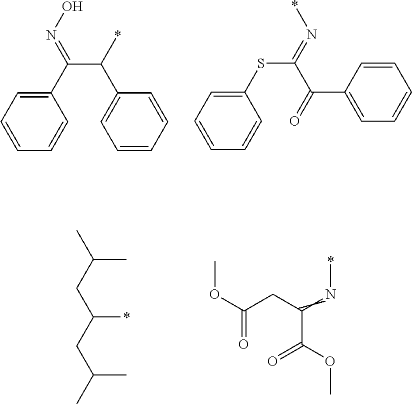

A further preferred embodiment relates to compositions, compounds, methods and uses, where M in formula Ib is
C₁-C₁₂-alkylene, which may be substituted by one or more identical or different radicals R^{Ma} and/or may be interrupted by one or more non-adjacent groups R^{Mi}, or
phenylene which may be substituted by one or more radicals R^{Mc},
   where R^{Ma} and R^{Mc} are as defined above.

In particular M is
C₁-C₁₂-alkylene;
C₁-C₁₂-alkylene, which is substituted by one or more, e.g. 1, 2 or 3, identical or different radicals selected from F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl, heteroaryl or C₆-C₁₀-aryl which is substituted by one or more identical or different radicals selected from F, Cl, Br, I, C₁-C₁₂-alkyl, C₁-C₁₂-haloalkyl, CN, NO₂, SR¹⁹, OR²⁰, COR²¹, COOR²² and CONR²³R²⁴;
C₁-C₁₂-alkylene, interrupted by one or more, e.g. 1, 2 or 3, identical or different non-adjacent groups selected from —O—, —S—, —O-phenylene or phenylene where the 2 last-mentioned groups may be substituted by one or more radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl;
C₁-C₁₂-alkylene, which is substituted by one or more, e.g. 1, 2 or 3, identical or different radicals selected from F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl, heteroaryl or C₆-C₁₀-aryl which is substituted by one or more identical or different radicals selected from F, Cl, Br, I, C₁-C₁₂-alkyl, C₁-C₁₂-haloalkyl, CN, NO₂, SR¹⁹, OR²⁰, COR²¹, COOR²² and CONR²³R²⁴, and interrupted by one or more snon-adjacent groups selected from —O—, —S—, —O-phenylene or phenylene where the 2 last-mentioned groups may be substituted by one or more radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl, or
phenylene which may be substituted by one or more, e.g. 1, 2 or 3, identical aor different radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl;
   where R¹⁹, R²⁰, R²², R²³ and R²⁴ are as defined above and have preferably one of the preferred meanings.

More preferably, M is C₂-C₈-alkylene interrupted by one, two, three, four, five or six non-adjacent groups selected from —O—, —S—, —O-phenylen and phenylene, where the last mentioned groups may be substituted by 1, 2, 3 or 4 radicals selected from C₁-C₁₂alkyl, C₁-C₁₂-haloalkyl, CN, NO₂, SR¹⁹, OR²⁰, COR²¹, COOR²², CONR²³R²⁴ and phenyl. In particular, M is C₂-C₈-alkylene which is interrupted by one phenylen group or C₂-C₈-alkylene which is interrupted by 1, 2, 3 or four groups selected from oxygen and —O-phenylene. Even more preferably, M is —CH₂—C₆H₄—O—CH₂CH₂CH₂O—C₆H₄—CH₂—, or —CH₂—C₆H₄—CH₂—.

A further preferred embodiment relates to compositions, compounds, methods and uses, where Z is C₁-C₁₀-alkylene or C₁-C₁₀-alkylene which is substituted by one or more, e.g. 1, 2 or 3, non-adjacent groups R^{Zi} selected from O, S, phenylen, —O-phenylen and —O-phenylen-O; in particular R^{Zi} is phenylen.

A further preferred embodiment relates to compositions, compounds, methods and uses, where Z is phenylene or naphthylene.

A further preferred embodiment relates to compositions, compounds, methods and uses, wherein in the compound of the formula Ib, Yⁿ⁻ is a monovalent anion. This sulfonium sulfate is also referred to as compound of formula Ib.1, wherein R⁵, R⁶, R⁷, R⁸, R⁹, R¹⁰ and M are as defined hereinabove.

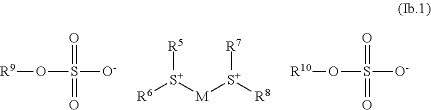

A skilled person will readily understand that the preferences given for R⁵, R⁶, R⁷, R⁸, R⁹, R¹⁹ and M in connection with compounds of formula Ib also apply for formula Ib.1.

With respect to the intended use of the compounds of formula Ib.1, particular preference is given to the following meanings of the substituents R⁵, R⁶, R⁷, R⁸, R⁹, R¹⁰ and M:
R⁵, R⁶, R⁷ and R⁸ are independently of one another selected from
   C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;
   C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and
   phenyl, which is unsubstituted or substituted by one, two, three, four or five radicals selected from F, Cl, Br, I, C₁-C₁₀-alkyl, SR¹⁹ and OR²⁰;
   or R⁵ and R⁶ or R⁷ and R⁸ together with the sulfur atom to which they are bound, form a 5- or 6-membered, saturated heterocycle, which may be fused to one phenyl ring;
R⁹, R¹⁰ are
   NR¹¹R¹²;
   —N═CR¹³R¹⁴, wherein R¹³ and R¹⁴ are, independently of one another, selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, phenylsulfanyl-benzoyl or R¹³ and R¹⁴ together with the carbon atom to which they are bound form a C₅-C₈-cycloalkyl ring
   C₁-C₁₂-alkyl, C₂-C₁₂-alkenyl, where the two last-mentioned radicals may be substituted by one or more identical or different radicals R^{4a} selected from F, Cl, Br, I, OR²⁰, COR²¹, COOR²², C₃-C₂₀-cycloalkyl, heterocycloalkyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴ and where cycloalkyl and heterocycloalkyl may be interrupted by one or more CO groups and in addition 2 geminally bound radicals R^{4a} together may also form an N-hydroxyimino group,
   phenyl, which may be substituted by one or more C₁-C₁₂-alkyl, F, Cl, Br, I, NO₂ or COOR²²;
M is C₂-C₈-alkylene interrupted by one, two, three, four, five or six non-adjacent groups selected from —O—, —S—, —O-phenylen and phenylene, where the last mentioned groups may be substituted by 1, 2, 3 or 4 radicals selected from C₁-C₁₂alkyl, C₁-C₁₂-haloalkyl, CN, NO₂, SR¹⁹, OR²⁰, COR²¹, COOR²², CONR²³R²⁴ and phenyl. In particular, M is C₂-C₈-alkylene which is interrupted by one phenylen group or C₂-C₈-alkylene which is interrupted by 1, 2, 3 or four groups selected from oxygen and —O-phenylene,
   where R¹¹, R¹², R¹⁹, R²⁰, R²², R²³ and R²⁴ are as defined above.

A further preferred embodiment relates to compositions, compounds, methods and uses, wherein in the formula Ib, Yⁿ⁻ is a divalent anion. This sulfonium sulfate is also referred to as compound of formula Ib.2, wherein R⁵, R⁶, R⁷, R⁸, Z and M are as defined hereinabove

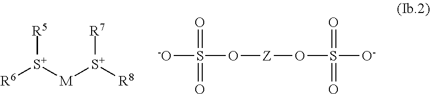

A skilled person will readily understand that the preferences given for R⁵, R⁶, R⁷, R⁸, Z and M in connection with compounds of formula Ib also apply for formula Ib.2.

According to a specific aspect of this embodiment R⁵, R⁶, R⁷, R⁸, Z and M have the following meanings:
R⁵, R⁶, R⁷ and R⁸ are independently of one another selected from
   C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;
   C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and
   phenyl, which is unsubstituted or substituted by one, two, three, four or five radicals selected from F, Cl, Br, I, C₁-C₁₀-alkyl, SR¹⁹ and OR²⁰;
   or R⁵ and R⁶ or R⁷ and R⁸ together with the sulfur atom to which they are bound, form a 5- or 6-membered, saturated heterocycle, which may be fused to one phenyl ring;
M is C₂-C₈-alkylene interrupted by one, two, three, four, five or six non-adjacent groups selected from —O—, —S—, —O-phenylen and phenylene, where the last mentioned groups may be substituted by 1, 2, 3 or 4 radicals selected from C₁-C₁₂-alkyl, C₁-C₁₂-haloalkyl, CN, NO₂, SR¹⁹, OR²⁰, COR²¹, COOR²², CONR²³R²⁴ and phenyl. In particular, M is C₂-C₈-alkylene which is interrupted by one phenylen group or C₂-C₈-alkylene which is interrupted by 1, 2, 3 or four groups selected from oxygen and —O-phenylene,
Z is C₁-C₁₀-alkylene or C₁-C₁₀-alkylene which is substituted by one or more, e.g. 1, 2 or 3, non-adjacent groups R^{Zi} selected from O, S, phenylene, —O-phenylene and —O-phenylene-O; in particular R^{Zi} is phenylen.

Apart from that, the variables R^{N}, R¹⁹, R²⁰, R²¹, R²², R²³, R²⁴ and R³², independently of each other, preferably have one of the following meanings:
R¹⁹ is hydrogen; C₁-C₁₂-alkyl; C₃-C₁₀-cycloalkyl which may be interrupted by 1 or 2 CO groups; phenyl-C₁-C₄-alkyl; phenyl; C₁-C₁₂-alkyl which is interrupted by one or more, e.g. 1, 2 or 3, non-adjacent O; heterocycloalkyl, which may be interrupted by 1 or 2 CO groups; C₃-C₁₀-cycloalkyl-C₁-C₁₂-alkyl; C₂-C₈-alkanoyl, C₂-C₄-haloalkanoyl or benzoyl which optionally is substituted by one or more C₁-C₆-alkyl, fluorine, chlorine, bromine, iodine or C₁-C₄-alkoxy;
R²⁰ is hydrogen; C₁-C₁₂-alkyl; C₃-C₁₀-cycloalkyl which may be interrupted by 1 or 2 CO groups; phenyl-C₁-C₄-alkyl; phenyl; C₁-C₁₂-alkyl which is interrupted by one or more, e.g. 1, 2 or 3, non-adjacent O; heterocycloalkyl, which may be interrupted by 1 or 2 CO groups; C₃-C₁₀-cycloalkyl-C₁-C₁₂-alkyl; C₂-C₈-alkanoyl, C₂-C₄-haloalkanoyl or benzoyl which optionally is substituted by one or more C₁-C₆-alkyl, fluorine, chlorine, bromine, iodine or C₁-C₄-alkoxy;
R²¹ hydrogen; C₁-C₁₂alkyl; benzyl; phenyl, where the 2 last-mentioned radicals may be i substituted by one or more identical or different halogen, C₁-C₁₂-alkyl, C₁-C₄-haloalkyl, C₁-C₁₂-alkoxy, phenyl-C₁-C₃-alkoxy, phenoxy, C₁-C₁₂-alkylsulfanyl, phenylsulfanyl, —(CO)O(C₁-C₈-alkyl) or (CO)N(C₁-C₈alkyl)₂;
R²² C₁-C₁₂-alkyl; C₁-C₄-haloalkyl; phenyl-C₁-C₄-alkyl; heterocyclyl, C₃-C₁₀cycloalkyl where the 2 last-mentioned radicals may be interrupted by 1 or 2 CO; C₁-C₈alkyl substituted by one or more, e.g. 1 or 2 OH; or phenyl, which is unsubstituted or substituted by one or more identical or different halogen, C₁-C₁₂-alkyl, C₁-C₄-haloalkyl, C₁-C₁₂-alkoxy or —(CO)O(C₁-C₈alkyl);
R²³ and R²⁴ are, independently of one another, selected from hydrogen, C₁-C₁₂-alkyl, C₃-C₁₀-cycloalkyl, benzyl or phenyl;
R^{N} is haydrogen, C₁-C₁₀-alkyl, C₂-C₆-alkanoyl, benzoyl, C₁-C₁₀-alkylsulfonyl, orphenylsulfonyl.

Compounds of the formula Ia

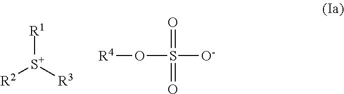

where
R¹ is as defined as defined above;
R² and R³ are as defined;
R⁴ is selected from C₁-C₂-alkyl, C₃-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² and —N═CR¹³R¹⁴,
   where C₁-C₂-alkyl is substituted by one or more radicals identical or different radicals R^{4a},
   where C₃-C₂₀-alkyl, C₂-C₂₀-alkenyl and C₂-C₂₀-alkynyl may be substituted by one or more identical or different radicals R^{4a} and/or may be interrupted by one or more non-adjacent groups selected from —O—, —S—, —C(O)— and —N(R^{N})—,
   where C₃-C₂₀-cycloalkyl and heterocycloalkyl may be interrupted by one or more CO groups and/or may be substituted by one or more identical or different radicals R^{4b},
   where C₆-C₂₀-aryl and heteroaryl may be substituted by one or more identical or different radicals R^{4c}, where
   R^{4a} is F, Cl, Br, I, CN, SR¹⁹, OR²⁰, COR²¹, COOR²², CONR²³R²⁴, C₃-C₂₀-cycloalkyl, heterocycloalkyl where the 2 last-mentioned radicals may be interrupted by one or more CO groups and/or may be substituted by one or more identical or different radicals R^{4ab},
      heteroaryl or C₆-C₁₀-aryl, where the two last-mentioned radicals may be substituted by one or more identical or different radicals R^{4ac}, where
      R^{4ab} is as defined above,
      R^{4ac} is as defined above, and
      in addition, if 2 radicals R^{4a} are geminally bound, the 2 radicals R^{4a} together may also form an N-hydroxyimino group;
   R^{4b} is F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl or heteroaryl, where the two last-mentioned radicals may be substituted by one or more identical or different radicals R^{4bc}, where
      R^{4bc} is as defined above,
   R^{4c} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where two last-mentioned radicals may be interrupted by one or more CO groups;
      where R^{N}, R¹¹, R¹², R¹³, R¹⁴, R¹⁹, R²⁰, R²¹, R²², R²³ and R²⁴ are as defined above.
      are novel and thus form also part of the invention, except of compounds of the formula Ia, where
   R¹ is methyl, R² is benzyl, R³ is 4-hydroxyphenyl and R⁴ is n-dodecyl.

R¹, R² and R³ in formula Ia have preferably one of the preferred meanings mentioned above and
R⁴ is preferably C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)-phenyl-C₁-C₆-alkyl; nitro-phenyl-C₁-C₆-alkyl; C₁-C₆-alkyl which may be substituted by 1, 2, 3 or 4 radicals selected from OH, N-hydroxyimino, benzoyl, phenyl and phenoxy;
   phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl;
   NR¹¹R¹², where R¹¹ and R¹² are as defined above;
   —N═CR¹³R¹⁴, wherein R¹³ and R¹⁴ are, independently of one another, selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, phenylsulfanyl-benzoyl or R¹³ and R¹⁴ together with the carbon atom to which they are bound form a C₅-C₈-cycloalkyl ring.

Compounds of the formula Ib.1 are novel and thus form also part of the invention, except of compounds of the formula Ib, where
R⁵, R⁶, R⁷ and R⁸ are each ethyl, M is 1,4-CH₂—C₆H₄—CH₂ and R⁹ and R¹⁰ are each n-dodecyl.

As to preferred embodiments of M, R⁵, R⁶, R⁷, R⁸, R⁹ and R¹⁰, references is made to what is said above.

Compounds of the formula Ib.2 are also novel and thus form also part of the invention. As to preferred embodiments of M, Z, R⁵, R⁶, R⁷ and R⁸, reference is made to what is said above.

The sulfonium sulfates of the general formulae Ia, Ib, Ib.1 and Ib.2 can generally be prepared by ion-exchange reaction, for example, between the desired sulfonium chloride, bromide, iodide, hydrogen sulfate, sulfate, tetrafluoroborate, trifluoroacetate, tosylate, methanesulfonate or methylsulfate and the desired sulfate salts having ammonium, tetramethylammonium, pyridinium, sodium, lithium, potassium or silver as cation. These reactions are usually carried out in an inert solvent, for example water, an alkanol such as methanol or ethanol, a halogenated hydrocarbons such as dichloromethane, trichloromethane or chlorobenzene, an aliphatic hydrocarbon, such as pentane, hexane, cyclohexane and petroleum ether, an aromatic hydrocarbon, such as toluene, o-, m- and p-xylene, an ether, such as diethyl ether, methyl ethyl ketone, diisopropyl ether, tert-butyl methyl ether, dioxane, anisole and tetrahydrofuran, a nitrile, such as acetonitrile and propionitrile, a ketone such as acetone, methyl ethyl ketone, diethyl ketone and tert-butyl methyl ketone, and also ethyl acetate or dimethylformamide (DMF), or mixture of such solvents. The combination of solvents, for example water and ethyl acetate, affords a two phase system. Such two phase systems are also suitable for the ion-exchange reaction. These reactions are well known to those skilled in the art, and are generally carried out at temperatures in the range of 0 to 120° C., preferably 0 to 60° C.

The sulfonium salts required as starting materials can be obtained by a variety of methods described, for instance, by George Andrew Olah in Onium ions, p. 167 or by J. V. Crivello in Advances in Polymer Science 62, 1-48, (1984). General methods for preparation of trialkyl(aryl)sulfonium involve alkylation or arylation of dialkyl, diaryl, and alkylaryl sulfides with alkyl halides, or with alkyl halides/silver tetrafluoroborate, alkyl halides/HCl, dialkyl sulfates, sulfonic acid esters, alcohols in the presence of strong protic acids, esters/trifluoromethanesulfonic acid, benzyl halides/Lewis acids, or trialkyl(aryl)oxonium salts as respective alkylating (arylating) agents.

The desired sulfonium salts can, for example, be prepared by condensation of sulfoxides with aryl compounds in the presence of strong acids such as sulfuric acid, polyphosphoric acid, methanesulfonic acid or the like so that sulfonium salts of the strong acid used are formed.

The sulfate salts required as starting materials can be obtained by a variety of methods described in standard chemistry textbooks (for instance in Comprehensive Organic Chemistry, Vol. 3, Pergamon, 1979), for example, the sulfation of alkenes and alcohols. Sulfuric acid, sulfur trioxide and its amine and ether adducts, chlorosulfuric acid, and sulfamic acid are the common sulfating reagents. One of the most convenient methods is, for example the reaction of alcohol with a sulfur trioxide/amine complex in inert solvents like DMF, THF, methylene chloride, acetone, methyl ethyl ketone, chloroform, chlorobenzene, tert-butyl methyl ether, di-iso-propyl ether, ethyl acetate, hexane, toluene or mixtures of such solvents. These reactions are generally carried out at temperatures in the range of 0 to 120° C., preferably 20 to 80° C.

Sulfonium sulfates can be also prepared by alkylation of the corresponding sulfide with dialkyl sulfate or by trans-esterification of sulfonium alkylsulfate with the desired non-volatile alcohol in the presence of acid catalyst like methanesulfonic acid as described in Green Chemistry, 8(10), 887-894; 2006.

### Compound (a)

compound having at least one group selected from an epoxy group, oxetane group and vinyl ether group; and

Suitable compounds (a) are:
compounds comprising an oxygen- or sulphur-containing saturated heterocycle,
ethylenically unsaturated compounds which are polymerisable by a cationic mechanism,
prepolymers of phenol-formaldehyde resins, acrylic resins, alkyd resins or polyester resins containing heat curable functional groups,
mixtures of heat curable compounds and compounds polymerisable by a different mechanism, e.g. free radicals or UV irradiation,
mixtures thereof.

Compounds (a) which comprise an oxygen- or sulphur-containing saturated heterocycle preferably comprise at least one heterocycle having 3, 4, 5 or 6 ring members.

Preferred compounds (a) which comprise an oxygen- or sulphur-containing saturated heterocycle are selected from compounds containing at least one epoxy group, oxetanes, oxolanes, cyclic acetals, cyclic lactones, thiiranes, thietanes and mixtures thereof.

Suitable compounds (a) containing one epoxy group are ethylene oxide, propylene oxide, styrene oxide, phenyl glycidyl ether, butyl glycidyl ether, etc.

In a preferred embodiment of the invention, compound (a) is selected from epoxy resins. The term “epoxy resin” as utilized in the description of the curable compositions of the present invention, is understood in a broad sense and includes any monomeric, dimeric, oligomeric or polymeric epoxy material containing a plurality (2, 3, 4, 5, 6 or more than 6) of epoxy groups. The term “epoxy resins” also encompasses prepolymers which comprise two or more epoxide groups, wherein some of the epoxide groups (oxiran rings) may also have been opened to a hydroxyl group. The term also identifies part-cured epoxy resins, i.e., epoxy resins which have been crosslinked by means of suitable hardeners. If component (a) is a part cured epoxy resin, it still contains heat curable epoxy groups that are still capable of undergoing cationic polymerization. The term “epoxy resins” also encompasses modified epoxy resins, such as esterified or etherified epoxy resins, obtainable for example by reaction with carboxylic acids or alcohols. Again, modified epoxy resins that are employed in a composition according to the invention still contain heat curable epoxy groups that are still capable of undergoing cationic polymerization. A complete definition of the term “epoxy resins” is found for example in Ullmann's Encyclopedia of Industrial Chemistry, 5th edition, on CD-ROM, 1997, Wiley-VCH, in the “Epoxy Resins” section.

The majority of commercial epoxy resins are prepared by coupling epichlorohydrin onto compounds which possess at least two reactive hydrogen atoms, such as polyphenols, monoamines and diamines, aminophenols, heterocyclic imides and amides, aliphatic diols or polyols or dimeric fatty acids. Epoxy resins derived from epichlorohydrin are referred to as glycidyl-based resins.

The majority of epoxy resins available commercially at the present time derive from the diglycidyl ether of bisphenol A (DGEBA resins) and possess the general formula

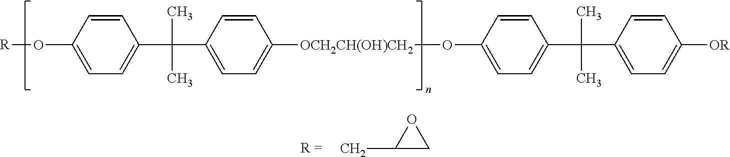

in which n stands for 0 to approximately 40.

Other important epoxy resins are phenol-based and cresol-based epoxy novolaks, examples being epoxy resins which derive from the diglycidyl ether of bisphenol F. Novolaks are prepared by the acid-catalyzed condensation of formaldehyde and phenol or cresol. The epoxidation of the novolaks leads to epoxy novolaks.

Other classes of glycidyl-based epoxy resins derive from glycidyl ethers of aliphatic diols, such as butane-1,4-diol, hexane-1,6-diol, pentaerythritol or hydrogenated bisphenol A; aromatic glycidylamines, an example being the triglycidyl adduct of p-aminophenol or the tetraglycidylamine of methylenedianilide; heterocyclic glycidylimides and amides, e.g., triglycidyl isocyanurate; and glycidyl esters, such as the diglycidyl ester of dimeric linoleic acid, for example.

The epoxy resins (a) may also derive from other epoxides (non-glycidyl ether epoxy resins). Examples are the diepoxides of cycloaliphatic dienes, such as 3,4-epoxycyclohexylmethyl 3,4-epoxycyclohexanecarboxylate and 4-epoxyethyl-1,2-epoxycyclohexane.

Examples of commercially available epoxy resins are bisphenol A type epoxy resin such as Epiculon N-3050, N-7050, N-9050 produced by Dainippon Ink & Chemicals Inc., XAC-5005, GT-7004, 6484T, 6099; bisphenol S type epoxy resin such as BPS-200 produced by Nippon Kayaku Co., Ltd., EPX-30 produced by ACR Co., Epiculon EXA-1514 produced by Dainippon Ink & Chemicals Inc., etc.; bisphenol F type epoxy resin such as YDF-2004, YDF2007 produced by Tohto Kasei Co., etc.; bisphenol fluorene type epoxy resin such as OGSOL PG, PG-100, EG, EG-210 produced by Osaka Gas Chemicals; a diglycidyl phthalate resin such as Blemmer DGT produced by Nippon Oil and Fats Co., Ltd., etc.; heterocyclic epoxy resin such as TEPIC produced by Nissan Chemical Industries, Ltd., Araldite PT810 produced by Huntsman, etc.; a bixylenol type epoxy resin such as YX-4000 produced by Yuka Shell Co., etc.; biphenol type epoxy resin such as YL-6056 produced by Yuka Shell Co., etc.; tetraglycidyl xylenoylethane resin such as ZX-1063 produced by Tohto Kasei Co., etc.; novolak type epoxy resin such as EPPN-201, EOCN-103, EOCN-1020, EOCN-1025 and BRRN produced by Nippon Kayaku Co., Ltd., ECN-278, ECN-292 and ECN-299 produced by Asahi Chemical Industry Co., Ltd., GY-1180, ECN-1273 and ECN-1299 produced by Ciba Specialty Chemicals Inc., YDCN-220L, YDCN-220HH, YDCN-702, YDCN-704, YDPN-601 and YDPN-602 produced by Tohto Kasei Co., Epiculon-673, N-680, N-695, N-770 and N-775 produced by Dainippon Ink & Chemicals Inc., etc.; novolak type epoxy resin of bisphenol A such as EPX-8001, EPX-8002, EPPX-8060 and EPPX-8061 produced by Asahi Chemical Industry Co., Ltd., Epiculon N-880 produced by Dainippon Ink & Chemicals Inc., etc.; chelate type epoxy resin such as EPX-49-69 and EPX-49-30 produced by Adeka, etc.; glyoxal type epoxy resin such as YDG-414 produced by Tohto Kasei Co., etc.; amino group-containing epoxy resin such as YH-1402 and ST-110 produced by Tohto Kasei Co., YL-931 and YL-933 produced by Yuka Shell Co., etc.; rubber-modified epoxy resin such as Epiculon TSR-601 produced by Dainippon Ink & Chemicals Inc., EPX-84-2 and EPX-4061 produced by Adeka, etc.; dicyclopentadiene phenolic type epoxy resin such as DCE-400 produced by Sanyo-Kokusaku Pulp Co., Ltd., etc.; silicone-modified epoxy resin such as X-1359 produced by Adeka, etc.; ∈-caprolactone-modified epoxy resin such as Plaque G-402 and G-710 produced by Dicel Chemical Industries, Ltd., etc. and others.

Other important epoxy resins are copolymers of ethylenically unsaturated compounds which comprise at least one epoxide group in the molecule such as glycidyl acrylate, glycidyl methacrylate, 3,4-epoxybutyl acrylate, 3,4-epoxybutyl methacrylate, vinylbenzyl glycidyl ether and allyl glycidyl ether and ethylenically unsaturated compounds which comprise no epoxide group in the molecule.

Examples of the ethylenically unsaturated compounds which comprise no epoxide group in the molecule are unsubstituted and substituted alkyl esters of acrylic and methacrylic acid which comprise 1 to 20 carbon atoms in the alkyl radical, more particularly methyl acrylate, methyl methacrylate, ethyl acrylate, ethyl methacrylate, butyl acrylate, butyl methacrylate, 2-ethylhexyl acrylate, 2-ethylhexyl methacrylate, 2-hydroxyethyl acrylate, 2-hydroxyethyl methacrylate, 2-hydroxypropyl acrylate, 2-hydroxypropyl methacrylate, 4-hydroxybutyl acrylate, 4-hydroxybutyl methacrylate, 1,2-dihydroxyethyl acrylate, and 1,2-dihydroxyethyl methacrylate.

Further examples of the ethylenically unsaturated compounds which comprise no epoxide groups in the molecule are unsaturated acids, such as acrylic acid and methacrylic acid, acid amides, such as acrylamide and methacrylamide, vinyl aromatic compounds, such as styrene, methylstyrene, hydroxystyrene and vinyltoluene, nitriles, such as acrylonitrile and methacrylonitrile, vinyl halides and vinylidine halides, such as vinyl chloride and vinylidine fluoride, vinyl esters, such as vinyl acetate, and hydroxyl-containing monomers, such as hydroxyethyl acrylate and hydroxyethyl methacrylate.

Further examples of the ethylenically unsaturated compounds which comprise no epoxide groups in the molecule are N-phenylmaleimide, N-cyclohexylmaleimide and N-benzylmaleimide.

Suitable oxetanes (a) are trimethylene oxide, 3,3-dimethyloxetane, 3,3-di(chloromethyl) oxetane, 3-ethyl-3-hydroxymethyl oxetane, 2-ethylhexyloxetane, xylene bisoxetane, 3-ethyl-3[[(3-ethyloxetane-3-yl)methoxy]methyl]oxetane, etc.

Examples of commercially available oxetanes are for example Aron Oxetane OXT-101, OXT-212, OXT-121, OXT-221 from Toagosei Co., Ltd.

Other important oxetane resins are copolymers of ethylenically unsaturated compounds which comprise at least one oxetane group in the molecule such as 3-methyl-3-acryloyloxymethyl oxetane, 3-methyl-3-methacryloyloxymethyl oxetane, 3-ethyl-3-acryloyloxymethyl oxetane, and 3-ethyl-3-methacryloyloxymethyl oxetane and ethylenically unsaturated compounds which comprise no epoxide group in the molecule as mentioned above.

Suitable oxolanes (a) are tetrahydrofuran, 2,3-dimethyltetrahydrofuran, etc.

Suitable cyclic acetals (a) are trioxan, 1,3-dioxolane, 1,3,6-trioxacyclooctane, etc.

Suitable cyclic lactones (a) are β-propiolactone, β-caprolactone, the alkyl derivatives of β-propiolactone and ∈-caprolactone, etc.

Suitable thiiranes (a) are ethylene sulfide, 1,2-propylene sulfide, thioepichlorohydrin, etc.

Suitable thietanes (a) are 1,3-propylene sulfide, 3,3-dimethylthietane, etc.

Further suitable compounds (a) are ethylenically unsaturated compounds which are polymerisable by a cationic mechanism, selected from mono- and diolefins, styrene, allylbenzene, vinylcyclohexane, vinyl ethers, vinyl esters, dihydropyran derivatives and mixtures thereof.

Suitable mono- and diolefins (a) are isobutene, 1-octene, butadiene, isoprene, etc.

Suitable vinyl ethers (a) are vinyl methyl ether, vinyl isobutyl ether, ethylene glycol divinyl ether, etc.

Suitable vinyl esters (a) are vinyl acetate, vinyl stearate, etc.

Suitable dihydropyran derivatives (a) are 3,4-dihydro-2H-pyran-2-carboxylic acid esters, 2-hydroxymethyl-3,4-dihydro-2H-pyran, etc.

Further suitable compounds (a) are mixtures of heat curable compounds and compounds polymerisable by a different mechanism, e.g. free radicals or UV irradiation. Suitable are e.g. mixtures of epoxy resins with monomeric or oligomeric acrylic or methacrylic acid esters. In this case, the polymerisation takes place by a cationic mechanism and a different mechanism, e.g. free radical polymerization or UV cure.

The heat curable composition according to the invention may comprise at least one further component selected from
solvents,
reactive diluents,
ethylenically unsaturated compounds, being different from reactive diluents,
binder resins being different from compounds (a), reactive diluents and from ethylenically unsaturated compounds,
photoinitiators,
free radical initiators,
sensitizers,
pigments,
fillers,
dispersants,
thermal curing promoters being different from compounds of formulae Ia and Ib,
further additives, and
mixtures thereof.

Below, compounds which may be derived from acrylic acid and methacrylic acid are in some cases abbreviated by adding the syllable “(meth)” in the compound derived from acrylic acid.

### Solvents

The heat curable compositions of the invention may be either solvent-based or aqueous based. Solvent-based in this context means that the volatile constituents of the coating composition comprise substantially, i.e., to an extent of at least 51% by weight, preferably at least 60% by weight, based on the volatile constituents overall, of organic solvents (including reactive diluents if present). Water-based in this context means that the volatile constituents of the coating composition comprise substantially, i.e., to an extent of at least 51% by weight, preferably at least 60% by weight, more particularly at least 80% by weight, based on the volatile constituents overall, of water. Coating compositions are composed in principle of volatile and nonvolatile constituents. The non-volatile fraction of the coating compositions can be determined to DIN EN ISO 3251 with the following test conditions: initial mass of (1±0.1) g, then 24 hours of drying at 23° C., thereafter (in accordance with DIN EN ISO 3251 appendix B1) 1 hour at 105° C. The volatile fraction is given by the difference between total amounts and nonvolatile fraction.

In contrast to solvent-based coating compositions, aqueous coating compositions have substantially water as their solvent, and little or no quantities of organic solvents. In the aqueous coating compositions the fraction of organic solvents is preferably not more than 30% by weight, more preferably not more than 20% by weight, and more particularly not more than 10% by weight, based on the total weight of the volatile constituents comprised in the coating composition.

Suitable solvents for solvent-based coating compositions are aliphatic, alicyclic, heterocyclic, aromatic, and heteroaromatic hydrocarbons, esters of aliphatic carboxylic acids with C₂-C₁₀ alkanols or polyalkylene glycols, ketones, lactones, lactams, ethers, monohydric or polyhydric alcohols, and mixtures thereof. The solvents are then preferably selected from toluene, xylenes, solvent naphtha, white spirit, ligroin, ethyl acetate, propyl acetate, butyl acetate, amyl acetate, methoxyethyl acetate, methoxypropyl acetate, ethoxyethyl acetate, ethoxypropyl acetate, ethyl ethoxypropionate, acetone, methyl ethyl ketone, methyl isobutyl ketone, cyclopentanone, cyclohexanone, N-methylpyrrolidone, dipropylene glycol, dibutylglycol, methanol, ethanol, n-propanol, isopropanol, butanol, propylene glycol monomethyl ether acetate, prolylene glycol monomethyl ether, γ-butyrolactone, ethyl lactate and mixtures thereof.

Preferably the boiling point of the solvent is such, that in the course of the curing of the heat curable composition they evaporate from the resin composition.

In an alternative embodiment, the polymerization can also be carried out solventless (in the molten state).

### Reactive Diluents

Sometimes the use of solvents results in an unwanted reduction in volume of the obtained resin (shrinking) or in the formation of pores, which may have a negative influence on the mechanical properties of the cured material, such as the fracture resistance or the surface properties.

The disadvantages of the conventional solvents can be circumvented through the use of reactive diluents. Similarly to solvents, reactive diluents are substances of low molecular mass, but differ from conventional solvents in having functional groups which are able to react with complementary functional groups of the employed component (a) and/or with the functional groups of an additional hardener, to form covalent bonds. Reactive diluents likewise lower the viscosity of the resin. They do not evaporate in the course of curing, and therefore, in the course of curing, are incorporated covalently into the resin matrix as it forms. Suitable reactive diluents are low molecular weight compounds having a molecular weight of preferably not more than 250 daltons, e.g., in the range from 100 to 250 daltons. The reactive diluents preferably contain oxirane groups, more preferably glycidyl groups, in the form, for example, of glycidyl ether groups, glycidyl ester groups or glycidyl amide groups. The epoxide functionality, i.e., the number of epoxide groups per molecule, in the case of the reactive diluents is typically in the range from 1 to 4, more particularly in the range from 1.1 to 3, in particular 1.2 to 2.5. Preferred among these are, in particular, glycidyl ethers of aliphatic or cycloaliphatic alcohols which have preferably 1, 2, 3 or 4 OH groups and 2 to 20 or 4 to 20 C atoms, and also glycidyl ethers of aliphatic polyetherols which have 4 to 20 C atoms. Examples of such are as follows:
glycidyl ethers of saturated alkanols having 2 to 20 C atoms, such as C₂-C₂₀-alkyl glycidyl ethers such as 2-ethylhexyl glycidyl ether, for example;
glycidyl ethers of saturated alkanepolyols having 2 to 20 C atoms, examples being the glycidyl ethers of 1,4-butanediol, of 1,6-hexanediol, trimethylolpropane or of pentaerythritol, the aforementioned glycidyl ether compounds generally having an epoxide functionality in the range from 1 to 3.0 and preferably in the range from 1.2 to 2.5;
glycidyl ethers of polyetherols having 4 to 20 C atoms, examples being glycidyl ethers of diethylene glycol, triethylene glycol, tetraethylene glycol, dipropylene glycol, and tripropylene glycol;
glycidyl ethers of cycloaliphatic alcohols having 5 to 20 C atoms, such as, for example, bisglycidyl ethers of cyclohexane-1,4-diyl, the bisglycidyl ether of ring-hydrogenated bisphenol A or of ring-hydrogenated bisphenol F;
glycidyl ethers of polyalkylene oxides having 2 to 4 C atoms such as polyethylene oxide or polypropylene oxide;
   and mixtures of the above substances.

An overview over reactive diluents can be found in P.K.T. Oldring (Editor), Chemistry & Technology of UV & EB Formulations for Coatings, Inks & Paints, Vol. II, Chapter III: Reactive Diluents for UV & EB Curable Formulations, Wiley and SITA Technology, London 1997. The disclosure of this document is incorporated herein by reference.

### Ethylenically Unsaturated Compounds

The heat curable composition according to the invention may comprise at least one ethylenically unsaturated compound. The resulting composition is curable not only by heat but also a different curing mechanism, in particular UV irradiation. UV- and heat-curable compositions are also called dual cure compositions.

Suitable ethylenically unsaturated compounds may additionally comprise at least one heat curable functional group. Preferred are ethylenically unsaturated compounds which comprises in the molecule at least one epoxide group, more particularly in the form of a glycidyl ether group. Suitable ethylenically unsaturated compounds may also comprises no epoxide group in the molecule. Preferred are esters of acrylic acid or methacrylic acid.

Examples of the ethylenically unsaturated monomers which comprise at least one epoxide group in the molecule are glycidyl acrylate, glycidyl methacrylate, and allyl glycidyl ether.

Examples of ethylenically unsaturated monomers which comprise no epoxide group in the molecule are alkyl esters of acrylic and methacrylic acid which comprise 1 to 20 carbon atoms in the alkyl radical, more particularly methyl acrylate, methyl methacrylate, ethyl acrylate, ethyl methacrylate, butyl acrylate, butyl methacrylate, 2-ethylhexyl acrylate, and 2-ethylhexyl methacrylate.

Further examples of ethylenically unsaturated monomers which comprise no epoxide groups in the molecule are unsaturated acids, such as acrylic acid and methacrylic acid, acid amides, such as acrylamide and methacrylamide, vinyl aromatic compounds, such as styrene, methylstyrene, and vinyltoluene, nitriles, such as acrylonitrile and methacrylonitrile, vinyl halides and vinylidine halides, such as vinyl chloride and vinylidine fluoride, vinyl esters, such as vinyl acetate, and hydroxyl-containing monomers, such as hydroxyethyl acrylate and hydroxyethyl methacrylate.

Examples of monomers with at least two ethylenically unsaturated double bonds and no epoxide groups in the molecule are esters of acrylic acid which are derived from diols or polyols, preferably aliphatic polyhydric polyalcohols and alkoxylation products thereof. They are preferably selected from hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol di(meth)acrylate, bis(hydroxymethylethyl)cyclohexane di(meth)acrylate, trimethylolethane tri(meth)acrylate, trimethylolpropane tri(meth)acrylate, pentaerythritol tetra(meth)acrylate, dipentaerythritol penta(meth)acrylate, dipentaerythritol hexa(meth)acrylate and mixtures thereof.

### Binder Resins

The heat curable composition according to the invention may comprise at least one binder resin being different from the afore-mentioned compounds (a), reactive diluents and ethylenically unsaturated compounds.

The additional binder resins may be physically drying polymer compositions, self-crosslinking polymer compositions, UV-curable polymer compositions, thermosetting polymer compositions, polymer compositions crosslinkable by addition of a crosslinker (2-component dispersions), or dual-cure systems.

Self-crosslinking or crosslinkable polymers contain reactive groups which react with one another or with a crosslinker substance comprised therein, with formation of bonds. The self-crosslinking polymers may be based on ethylenically unsaturated monomers. Also suitable are polyurethane-based polymers, which through incorporation of corresponding monomers and/or through selection of the stoichiometry of the polyurethane-forming monomers contain the desired functional groups.

In the case of thermosetting polymer compositions, the composition may be based on a polyurethane or based on a polymer of ethylenically unsaturated monomers, the polymer component containing hydroxyl groups, keto groups, urea groups, epoxide groups and/or carboxyl groups, and at least one low molecular mass or polymeric crosslinker having at least two reactive groups as specified above.

Examples of binder resisns are homo- and co-polymers of acrylates and methacrylates, for example copolymers of methyl methacrylate/ethyl acrylate/methacrylic acid, poly(methacrylic acid alkyl esters), poly(acrylic acid alkyl esters); phenolic resins, cellulose derivatives, such as cellulose esters and ethers, for example cellulose acetate, cellulose acetate butyrate, methyl cellulose, ethyl cellulose; polyvinyl butyral, polyvinyl formal, polyolefins, cyclised rubber, polyethers, such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, copoly(ethylene/vinyl acetate), polymers such as polycaprolactame and poly(hexamethyleneadipamide), polyesters such as poly(ethylene glycol terephtha-late) and poly(hexamethylene glycol succinate); and polyamides.

### Photoinitiators

Photoinitiators are preferably used in an amount of from 0.001% to 15% by weight, more preferably from 0.01 to 10% by weight, based on the total weight of the heat curable composition according to the invention.

Suitable photoinitiators for the heat curable compositions according to the invention are so called cationic photoinitiator that produce reactive cations (e.g. Lewis or Bronsted acids) under the action of light and thus are suitable to initiate cationic polymerization. Suitable cationic photoinitiators are derived from stable organic onium salts, particularly with nitrogen, phosphorus, oxygen, sulfur, selenium or iodine as central atom of the cation. Preferred are aromatic sulfonium and iodonium salts with complex anions, phenacylsulfonium salts, hydroxylphenylsulfonium salts and sulfoxonium salts. It is also possible to employ organic silicon compounds which release a silanol upon UV irradiation in the presence of an aluminous organic compound.

Initiators of this kind are, for example, the products available commercially under the brand names Irgacure® 250 from BASF SE, CYRACURE® UVI-6990, CYRACURE® UVI-6974 from Union Carbide, DEGACURE® KI 85 from Degussa, SP-55, SP-150, SP-170 from Adeka, GE UVE 1014 from General Electric, SarCat® CD 1012, SarCat® KI-85, SarCat® CD 1010; SarCat® CD 1011 from Sartomer.

Suitable cationic photoinitiator are also onium salts which are excited via a sensitizer. Suitable sensitizers are mentioned in the following.

UV-curable compositions generally comprise at least one photoinitiator (radical photoinitiator) which is able to initiate the polymerization of ethylenically unsaturated double bonds. They include, for example, benzophenone and its derivatives, such as 4-phenylbenzophenone and 4-chlorobenzophenone, Michler's ketone, anthrone, acetophenone derivatives, such as 1-benzoylcyclohexan-1-ol, 2-hydroxy-2,2-dimethylacetophenone, benzoin and benzoin ethers, such as methyl, ethyl, and butyl benzoin ether, benzil ketals, such as benzil dimethyl ketal, 2-methyl-1-(4-methylthiophenyl)-2-morpholinopropan-1-one, (4-morpholinobenzoyl)-1-benzyl-1-dimethylaminopropane, (4-morpholinobenzoyl)-1-(4-methylbenzyl)-1-dimethylaminopropane, anthraquinone and its derivatives, such as β-methylanthraquinone and tert-butylanthraquinone, oxime esters, such as 1,2-octanedione 1-[4-(phenylthio)phenyl]-2-(O-benzoyloxime) and ethanone 1-[9-ethyl-6-(2-methylbenzoyl)-9H-carbazol-3-yl]-1-(O-acetyloxime), acylphosphine oxides, such as 2,4,6-trimethylbenzoyldiphenylphosphine oxide, ethyl 2,4,6-trimethylbenzoylphenylphosphinate, and bisacylphosphine oxides, such as bis(2,4,6-trimethylbenzoyl)phenylphosphine oxide. Initiators of this kind are, for example, the products available commercially under the brand names Irgacure® 184, Darocur® 1173, Irgacure® 127, Irgacure® 2959, Irgacure® 651, Irgacure® 907, Irgacure® 369, Irgacure® 379, Irgacure® OXE01, Irgacure® OXE02, Lucirin® TPO, Irgacure® 819, Irgacure® 784, Irgacure® 754 from BASF SE, Adeka Optomer N-series N-1414, N-1717, N-1919 from Adeka or Genocure® from Rahn

### Free-Radical Initiators

Suitable free-radical initiators for the heat curable compositions according to the invention are the peroxo and/or azo compounds customary for the purpose, examples being alkali metal or ammonium peroxidisulfates, diacetyl peroxide, dibenzoyl peroxide, succinyl peroxide, di-tert-butyl peroxide, tert-butyl perbenzoate, tert-butyl perpivalate, tert-butyl peroxy-2-ethylhexanoate, tert-butyl permaleate, cumene hydroperoxide, diisopropyl peroxidicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, 2,2′-azobis(2-amidinopropane) dihydrochloride or 2,2′-azobis(2-methylbutyronitrile). Mixtures of these initiators are suitable as well.

Compositions according to the invention based on compounds which contain ethylenically unsaturated double bonds may comprise at least one, which on exposure to elevated temperature produces polymerization of these groups and hence free-radical crosslinking. They include thermolabile free-radical initiators, such as organic peroxides, organic azo compounds, or C—C-cleaving initiators such as dialkyl peroxides, peroxocarboxylic acids, peroxodicarbonates, peroxide esters, hydroperoxides, ketone peroxides, azo dinitriles or benzpinacol silyl ethers.

Free radical initiators are preferably used in an amount of from 0.001% to 15% by weight, more preferably from 0.01 to 10% by weight, based on the total weight of the heat curable composition according to the invention.

### Sensitizers

Sensitizers are preferably used in an amount of from 0.001% to 15% by weight, more preferably from 0.01 to 10% by weight, based on the total weight of the heat curable composition according to the invention.

Suitable sensitizers are usually employed in combination with at least one of the aforementioned cationic photoinitiators or radical photoinitiators. Preferred sensitizers for cationic photoinitiatorsare polycyclic aromatic compounds, such as anthracene, naphthalene and derivatives thereof (see also U.S. Pat. No. 6,313,188, EP 0927726, WO 2006/073021, U.S. Pat. No. 4,997,717, U.S. Pat. No. 6,593,388, and WO 03/076491). A preferred combination comprises at least one sensitizer, selected from polycyclic aromatic compounds, and at least one iodonium photoinitiator. Preferred sensitizers for radical photoinitiators are aromatic compounds, such as thioxanthone, benzophenone, coumarin and derivatives thereof.

### Pigments

The heat curable composition of the invention may comprise at least one pigment. Suitable in principle are inorganic pigments, organic pigments, and mixtures thereof. The pigments may be color pigments, effect pigments, transparent pigments or mixtures thereof.

Examples of suitable inorganic pigments include white pigments such as titanium dioxide, preferably in the rutile form, barium sulfate, zinc oxide, zinc sulfide, basic lead carbonate, antimony trioxide, lithopones (zinc sulfide+barium sulfate) or colored pigments, examples being iron oxides, carbon black, graphite, zinc yellow, zinc green, ultramarine, manganese black, antimony black, manganese violet, Paris blue or Schweinfurt green. Suitable organic color pigments may come from a wide variety of dye classes with different chromophores, examples being anthraquinone dyes, monoazo and diazo dyes, indigo and indigoid dyes, quinophthalones, methine and azamethine dyes, naphthalimide dyes, naphthoquinone dyes, nitro dyes, quinacridone pigments, phthalocyanine pigments, isoindolinone pigments, and metal complex pigments, etc. Examples of suitable organic color pigments are indanthrene blue, chromophthal red, Irgazine orange, and Heliogen green.

Effect pigments used may be metal flake pigments such as commercial aluminum bronzes as per DE-A-36 36 183, chromated aluminum bronzes, and commercial stainless steel bronzes, and also nonmetallic effect pigments, such as pearlescent pigments and interference pigments, for example. Also suitable are synthetic white pigments with air inclusions for increasing light scattering, such as the Rhopaque® dispersions. Other examples of suitable effect pigments are apparent from Römpp-Lexikon, Lacke und Druckfarben, Georg Thieme Verlag, 1998, page 176.

The fraction of the pigments as a proportion of the heat curable composition may vary very widely. Advantageously the fraction is 1% to 95%, preferably 2% to 90%, more preferably 3% to 85%, and more particularly 4% to 80%, by weight, based in each case on the total weight of the heat curable composition of the invention.

### Fillers

Suitable fillers are organic and inorganic fillers, examples being aluminosilicates, such as feldspars, silicates, such as kaolin, talc, mica, magnesite, alkaline earth metal carbonates, such as calcium carbonate, in the form of calcite or chalk, for example, magnesium carbonate, dolomite, alkaline earth metal sulfates, such as calcium sulfate, silicon dioxide, etc. Suitable organic fillers are, for example, textile fibers, cellulose fibers, polyethylene fibers or wood flour. In coating materials, of course, finely divided fillers are preferred. The fillers may be used as individual components. In practice, mixtures of fillers have also proven particularly appropriate, examples being calcium carbonate/kaolin, calcium carbonate/talc. For further details refer to Römpp-Lexikon, Lacke und Druckfarben, Georg Thieme Verlag, 1998, pages 250 ff., “fillers”.

The fraction of the fillers as a proportion of the coating composition is preferably 0% to 95%, more preferably 0.5% to 90%, more particularly 1% to 75%, and especially 4% to 80%, by weight, based in each case on the total weight of the coating composition of the invention.

### Dispersants

The heat curable composition of the invention may also comprise at least one dispersant. Suitable dispersants are in principle known emulsifiers and protective colloids (surface active substances).

Suitable emulsifiers are anionic, nonionic, and cationic emulsifiers. Dispersants are used in particular if the heat curable composition comprises an aqueous medium. The term “aqueous medium” denotes water and mixtures of water and at least one water-miscible organic solvent. In a special embodiment, the heat curable composition is formulated as an aqueous coating composition.

Preferred are emulsifiers, whose relative molecular weights, in contrast to the protective colloids, are typically below 2000. They may be anionic, cationic or nonionic, preference being given to anionic emulsifiers and to a combination thereof with nonionic emulsifiers. The anionic emulsifiers include alkali metal salts and ammonium salts of alkyl sulfates (alkyl radical: C₈-C₁₂), of sulfuric monoesters with ethoxylated alkanols (EO degree: 2 to 50, alkyl radical: C₁₂-C₁₈) and with ethoxylated alkylphenols (EO degree: 3 to 50, alkyl radical: C₄-C₉), of alkylsulfonic acids (alkyl radical: C₁₂-C₁₈), of alkylarylsulfonic acids (alkyl radical: C₉-C₁₉), and of mono- and dialkyldiphenyl ether sulfonates, as are described in U.S. Pat. No. 4,269,749, for example. Suitable nonionic emulsifiers are araliphatic or aliphatic nonionic emulsifiers, examples being ethoxylated mono-, di-, and trialkylphenols (EO degree: 3 to 50, alkyl radical: C₄-C₉), ethoxylates of long-chain alcohols (EO degree: 3 to 50, alkyl radical: C₈-C₃₆), and polyethylene oxide/polypropylene oxide block copolymers. Preference is given to ethoxylates of long-chain alkanols (alkyl radical: C₁₀-C₂₂, average degree of ethoxylation: 3 to 50) and, of these, particular preference to those based on oxo process alcohols and natural alcohols having a linear or branched C₁₂-C₁₈ alkyl radical and a degree of ethoxylation of 8 to 50.

Suitable protective colloids are, for example, polyvinyl alcohols, starch derivates and cellulose derivatives, or copolymers comprising vinylpyrrolidone. A comprehensive description of further suitable protective colloids is found in Houben-Weyl, Methoden der organischen Chemie, volume XIV/1, Makromolekulare Stoffe, Georg-Thieme-Verlag, Stuttgart 1961, pp. 411-420.

Other examples of sutable dispersants are polymeric dispersants.

Polymeric dispersants include high molecular weight polymers with pigment affinic groups. Examples are: statistical co-polymers comprised from, for instance, styrene derivatives, (meth)acrylates and (meth)acrylamides, and such statistical co-polymers modified by post modification; block co-polymers and/or comb polymers comprised from, for instance, styrene derivatives, (meth)acrylates and (meth)acrylamides, and such block co-polymers and/or comb polymers modified by post modification; polyethylenimines, which for instance is crafted with polyesters; polyamines, which for instance is crafted with polyesters; and many kinds of (modified) polyurethanes.

Polymeric dispersants may also be employed. Suitable polymeric dispersants are, for example, BYK's DISPERBYK® 101, 115, 130, 140, 160, 161, 162, 163, 164, 166, 168, 169, 170, 171, 180, 182, 2000, 2001, 2009, 2020, 2025, 2050, 2090, 2091, 2095, 2096, 2150, Ciba's Ciba® EFKA® 4008, 4009, 4010, 4015, 4046, 4047, 4050, 4055, 4060, 4080, 4300, 4310, 4330, 4340, 4400, 4401, 4402, 4403, 4406, 4500, 4510, 4520, 4530, 4540, 4550, 4560, Ajinomoto Fine Techno's PB®711, 821, 822, 823, 824, 827, Lubrizol's SOLSPERSE® 1320, 13940, 17000, 20000, 21000, 24000, 26000, 27000, 28000, 31845, 32500, 32550, 32600, 33500, 34750, 36000, 36600, 37500, 39000, 41090, 44000, 53095 and combinations thereof.

It is preferred to use Ciba® EFKA® 4046, 4047, 4060, 4300, 4310, 4330, 4340, DISPERBYK® 161, 162, 163, 164, 165, 166, 168, 169, 170, 2000, 2001, 2020, 2050, 2090, 2091, 2095, 2096, 2105, 2150, PB®711, 821, 822, 823, 824, 827, SOLSPERSE® 24000, 31845, 32500, 32550, 32600, 33500, 34750, 36000, 36600, 37500, 39000, 41090, 44000, 53095 and combinations thereof as dispersant.

Suitable texture improving agents are, for example, fatty acids such as stearic acid or behenic acid, and fatty amines such as laurylamine and stearylamine. In addition, fatty alcohols or ethoxylated fatty alcohols, polyols such as aliphatic 1,2-diols or epoxidized soy bean oil, waxes, resin acids and resin acid salts may be used for this purpose.

Suitable pigment derivatives are, for example, copper phthalocyanine derivatives such as Ciba's Ciba® EFKA® 6745, Lubrizol's SOLSPERSE® 5000, 12000, BYK's SYNERGIST 2100 and azo derivatives such as Ciba® EFKA® 6750, SOLSPERSE® 22000 and SYNERGIST 2105.

The above mentioned dispersants and surfactants for pigments are for example employed in compositions of the present invention which are used as resist formulations, in particular in color filter formulations.

Where the heat curable compositions of the invention comprise at least one surface-active substance, the fraction thereof is typically 0.01% to 10% by weight, preferably 0.1% to 5% by weight, based on the total weight of the composition.

Thermal Curing Promoters being Different from Compounds of Formulae Ia and Ib

The heat curable composition according to the invention may comprise one or more additional thermal curing promotors, which are guided in a known way by the nature of the reactive functional groups in the binder.

Suitable thermal curing promotors catalysts are sulfonium and phosphonium salts of organic or inorganic acids, imidazole and imidazole derivatives, quaternary ammonium compounds, and amines.

Examples of commercially available thermal curing promoters are San-Aid SI series, SI-60L, SI-80L, SI-100L, SI-110L, SI-145, SI-150, SI-160, SI-180L produced by Sanshin Chemical.

The thermal curing promotors, where desired, are preferably used in an amount of from 0.001% by weight to about 10% by weight, based on the total weight of the heat curable composition according to the invention.

In a preferred embodiment there is no need for thermal curing promoters being different from compounds of formulae Ia and Ib.

### Further Additives

It is allowable to add a variety of known additives such as the following to the heat curable composition of this invention to modify certain application properties in view of a desired application.

Suitable further additives are selected from hardeners, crosslinkers, reinforcing materials, dyes, flow control assistants, UV stabilizers, heat stabilizers, weatherability improvers, rheology modifiers, flame retardants, antioxidants, discoloration inhibitors, biocides, antistatic agents, plasticizers, lubricants, slip additives, wetting agents, film-forming assistants, adhesion promoters, corrosion inhibitors, antifreeze agents, defoamers, mold release agents, photolatent acids, etc., and mixtures thereof.

They are each comprised in the quantities typical for such additives.

### Hardeners

The composition according to the invention may contain at least one hardener.

Hardeners are used in particular, if the compound (a) comprises an epoxy resin.

Suitable hardeners include aliphatic and aromatic polyamines, polyamidoamines, urons, amides, guanidines, aminoplasts and phenoplasts, polycarboxylic polyesters, polycarboxylic acids and polycarboxylic acid anhydrides, dihydroxy and polyhydroxy compounds, thiols, imidazoles, imidazolines, and certain isocyanates, and also latent polyfunctional hardeners.

Polyamine hardeners crosslink epoxy resins through reaction of primary or secondary amino functions of polyamines with terminal epoxide groups of the epoxy resins. Suitable polyamines are, for example, aliphatic polyamines such as ethylenediamine, 1,2- and 1,3-propylenediamine, neopentanediamine, hexamethylenediamine, octamethylenediamine, 1,10-diaminodecane, 1,12-diaminododecane, diethylenetriamine, triethylenetetramine, tetraethylenepentamine, and the like; cycloaliphatic diamines, such as 1,2-diaminocyclohexane, 1,3-bis(aminomethyl)cyclohexane, 1-methyl-2,4-diaminocyclohexane, 4-(2-aminopropan-2-yl)-1-methylcyclohexan-1-amine, isophoronediamine, 4,4′-diaminodicyclohexylmethane, 3,3′-dimethyl-4,4′-diaminodicyclohexylmethane, norbornanediamine, menthanediamine, menthenediamine and the like; aromatic diamines, such as tolylenediamine, xylylenediamine, more particularly meta-xylylenediamine, bis(4-aminophenyl)methane (MDA or methylenedianiline), bis(4-aminophenyl) sulfone (also known as DADS, DDS or dapsone), and the like; cyclic polyamines, such as piperazine, N-aminoethylpiperazine and the like; polyetherdiamines, examples being the reaction product of polypropylene oxide or polyethylene oxide or butylene oxide or pentylene oxide or poly(1,4-butanediol) or polytetrahydrofuran or mixtures of the 5 last-mentioned alkylene oxides with propylene oxide with ammonia, e.g., 4,7,10-trioxamidecane-1,3-diamine, 4,7,10-trioxamidecane-1,13-diamine, XTJ-500, XTJ-501, XTJ-511, XTJ-542, XTJ-559, XTJ-566, XTJ-568 (Huntsman), 1,8-diamino-3,6-dioxaoctane (XTJ-504 from Huntsman), 1,10-diamino-4,7-dioxadecane (XTJ-590 from Huntsman), 1,12-diamino-4,9-dioxadodecane (BASF), 1,3-diamino-4,7,10-trioxamidecane (BASF), polyetheramine T 5000, Jeffamines and the like; and polyamide diamines (amidopolyamines), which are obtainable through the reaction of dimeric fatty acids (e.g., dimeric linoleic acid) with low molecular mass polyamines, such as diethylenetriamine or triethylenetetramine.

A further class of suitable hardeners are those known as urons (urea derivatives), such as 3-(4-chlorophenyl)-1,1-dimethylurea (monuron), 3-(3,4-dichlorophenyl)-1,1-dimethylurea (diuron), 3-phenyl-1,1-dimethylurea (fenuron), 3-(3-chloro-4-methylphenyl)-1,1-dimethylurea (chlortoluron), and the like.

Suitable hardeners are also carbamides, such as tolyl-2,4-bis(N,N-dimethylcarbamide), and tetraalkylguanidines, such as N,N,N′N′-tetramethylguanidine.

Melamine-, urea-, and phenol-formaldehyde adducts, which are also referred to as aminoplasts or phenoplasts, respectively, form a further class of suitable hardeners.

Polycarboxylic polyesters as hardeners are being employed increasingly in powder coatings. The crosslinking takes place by virtue of the reaction of the free carboxyl groups e.g. with the epoxide groups of an epoxy resin.

Further polyfunctional hardeners comprise aromatic compounds having two or more hydroxyl groups. Examples of such are resins obtainable by the reaction of phenol or alkylated phenols, such as cresol, with formaldehyde, examples being phenol novolaks, cresol novolaks and dicyclopentadiene novolaks; furthermore, resins of nitrogen-containing heteroaromatics, such as benzoguanamine-phenol-formaldehyde resins or benzoguanamine-cresol-formaldehyde resins, acetoguanamine-phenol-formaldehyde resins or acetoguanamine-cresol-formaldehyde resins, and melaminephenol-formaldehyde resins or melamine-cresol-formaldehyde resins, and also hydroxylated arenes, such as hydroquinone, resorcinol, 1,3,5-trihydroxybenzene, 1,2,3-trihydroxybenzene (pyrogallol), 1,2,4-trihydroxybenzene (hydroxyhydroquinone), 3,4,5-trihydroxybenzoic acid (gallic acid) or derivatives thereof, 1,8,9-trihydroxyanthracene, (dithranol or 1,8,9-anthracenetriol), 1,2,10-trihydroxyanthracene (anthrarobin) and 2,4,5-trihydroxypyrimidine; additionally, alkanes substituted by hydroxylated arenes, such as triphenolmethane, triphenolethane and tetraphenolethane. Further examples are phosphinates and phosphonates derived from hydroquinone and naphthoquinone, as described in WO 2006/034445, hereby fully incorporated by reference.

Further polyfunctional hardeners comprise thiols, imidazoles, such as imidazole, 1-methylimidazole, 2-methylimidazole, 2-ethyl-4-methylimidazole, 1-cyanoethylimidazole and 2-phenylimidazole, and imidazolines, such as 2-phenylimidazoline.

Blocked isocyanates have more recently been used as latent hardeners for water-based coatings.

Dicyandiamide (dicy), HN═C(NH₂)(NHCN), is a latent polyfunctional hardener frequently employed in powder coatings and electrical laminates.

Also suitable are reaction products of dicy with amines, known as bisguanidines, such as HAT 2844 from Vantico.

Further suitable latent polyfunctional hardeners are boron trifluoride-amine adducts such as BF₃-monoethylamine, and quaternary phosphonium compounds.

### Crosslinkers

The composition according to the invention may contain at least one crosslinkers.

Suitable hardeners further include melamine compounds, for example melamine, monomethyrol melamine, dimethyrol melamine, trimethyrol melamine, tetramethyrol melamine, pentamethyrol melamine, hexamethyrol melamine, monobutyrol melamine, dibutyrol melamine, tributyrol melamine, tetrabutyrol melamine, pentabutyrol melamine, hexabutyrol melamine, monomethoxymethyl melamine, dimethoxymethyl melamine, trimethoxymethyl melamine, tetramethoxymethyl melamine, pentamethoxymethyl melamine, hexamethoxymethyl melamine, monobutoxymethyl melamine, dibutoxymethyl melamine, tributoxymethyl melamine, tetrabutoxymethyl melamine, pentabutoxymethyl melamine, hexabutoxymethyl melamine and guanamine compounds, for example acetoguanamine, benzoguanamine, monomethyrol benzoguanamine, dimethyrol benzoguanamine, trimethyrol benzoguanamine, tetramethyrol benzoguanamine and alkylated methyrol benzoguanamines.

### Dyes

The heat curable composition of the invention may also comprise at least one dye as additive. The dyes in question may be, for example, the molecularly dispersely soluble dyes that are typical for such compositions, or solvent dye.

### Flow Control Assistants

Suitable flow control assistants are, for example, modified silicone oils such as the Byk® products of Altana-Byk, or high molecular mass polyacrylates, such as the Resiflow® products of Worlée.

### UV Stabilizers

UV stabilizers (light stabilizers) suitable as additive are, for example, 4,4-diarylbutadienes, cinnamic esters, triazoles, triazines, benzophenones, diphenylcyanoacrylates, oxamides (oxalamides), oxanilides, etc. Suitable sterically hindered amines are, for example, 2,2,6,6-tetramethylpiperidine, 2,6-di-tert-butylpiperidine or derivatives thereof, an example being bis(2,2,6,6-tetramethyl-4-piperidyl) sebacate. UV stabilizers are used typically in an amount of 0.1% to 5.0%, and preferably of 0.5% to 3.5%, by weight, based on the total weight of the heat curable composition.

### Wetting Agents

Suitable wetting agents are, for example, siloxanes, fluorine-containing compounds, carboxylic monoesters, phosphoric esters, polyacrylic acids and their copolymers, or polyurethanes.

### Film-Forming Assistants

Examples of suitable film-forming assistants are cellulose derivatives.

### Rheology Control Additives

The coating composition of the invention may also comprise as additive at least one rheology control additive. Suitable rheology control additives are described in, for example, WO 94/22968, EP-A-0 276 501, EP-A-0 249 201 or WO 97/12945. Also suitable are crosslinked polymeric microparticles of the kind disclosed in EP-A-0 008 127, for example; inorganic phyllosilicates, preferably smectites, more particularly montmorillonites and hectorites, such as aluminum magnesium silicates, sodium magnesium phyllosilicates and sodium magnesium fluorine lithium phyllosilicates of the montmorillonite type, or inorganic phyllosilicates such as aluminum magnesium silicates, sodium magnesium phyllosilicates and sodium magnesium fluorine lithium phyllosilicates of the montmorillonite type, silicas such as Aerosils, or synthetic polymers with ionic and/or associative groups, such as polyvinyl alcohol, poly(meth)acrylamide, crosslinked poly(meth)acrylic acid, polyvinylpyrrolidone, styrene-maleic anhydride or ethylene-maleic anhydride copolymers and their derivatives, or hydrophobically modified polyacrylates, or else polyurethane-based associative thickeners, of the kind described in Römpp-Lexikon, Lacke and Druckfarben, Georg Thieme Verlag, Stuttgart, New York, 1998, “thickeners”, pp. 599-600, and in the textbook “Lackadditive” by Johan Bieleman, Wiley-VCH, Weinheim, New York, 1998, pp. 51-59 and 65.

### Photolatent Acids

Examples of suitable photolatent acids are quinonediazide compounds, for example 1,2-quinonediazidesulfonic acid ester compounds of polyhydroxy compounds. Preferred are compounds having a 1,2-quinonediazidesulfonyl group, e.g. a 1,2-benzoquinonediazide-4-sulfonyl group, a 1,2-naphthoquinonediazide-4-sulfonyl group, a 1,2-naphthoquinonediazide-5-sulfonyl group, a 1,2-naphthoquinonediazide-6-sulfonyl group or the like. Particularly preferred are compounds having a 1,2-naphthoquinonediazide-4-sulfonyl group or a 1,2-naphthoquinonediazide-5-sulfonyl group. In particular suitable are 1,2-quinonediazidesulfonic acid esters of (poly)hydroxyphenyl aryl ketones such as 2,3,4-trihydroxybenzophenone, 2,4,6-trihydroxybenzophenone, 2,3,4,4′-tetrahydroxybenzophenone, 2,2′,3,4-tetrahydroxybenzophenone, 2,3,4,4′-tetrahydroxybenzophenone, 2,2′,4,4′-tetrahydroxybenzophenone 2,2′,3,4,4′-pentahydroxybenzophenone, 2,2′3,2,6′-pentahydroxybenzophenone, 2,3,3′,4,4′5′-hexahydroxybenzophenone, 2,3′,4,4′,5′6-hexahydroxybenzophenone and the like; 1,2-quinonediazidesulfonic acid esters of bis-[(poly)hydroxyphenyl]alkanes such as bis(4-hydroxyphenyl)ethane, bis(2,4-dihydroxyphenyl)ethane, 2,2-bis(4-hydroxyphenyl)propane, 2,2-bis(2,4-dihydroxyphenyl)propane, 2,2-bis-(2,3,4-tridroxyphenyl)propane and the like; 1,2-quinonediazidesulfonic acid esters of (poly)hydroxyphenylalkanes such as 4,4′-dihydroxytriphenylmethane, 4,4′4″-trihydroxytriphenylmethane, 4,4′5,5′-tetramethyl-2,2′2″-trihydroxytriphenylmethane, 2,2,5,5′-tetramethyl-4,4′,4″-trihydroxytriphenylmethane, 1,1,1-tris(4-hydroxyphenyl)ethane, 1,1-bis(4-hydroxyphenyl)-1-phenylethane, 1,1-bis(4-hydroxyphenyl)-1-(4-[1-(hydroxyphenyl)-1-methylethyl]phenyl)ethane and the like; 1,2-quinonediazidesulfonic acid esters of (poly)hydroxyphenylflavans such as 2,4,4-trimethyl-2′,4′,7-trihydroxy-2-phenylflavan, 2,4,4-trimethyl-2′,4′,5′,6,7-pentahydroxy-2-phenylflavan and the like. Further examples of suitable coatings additives are described in the textbook “Lackadditive” by Johan Bieleman, Wiley-VCH, Weinheim, New York, 1998.

The compositions according to the invention are prepared by mixing of the components in apparatus conventional for this purpose.

The heat curable compositions according to the invention are outstandingly suitable as coating agents for substrates of any type.

Suitable substrates are metals (preferably metals of groups 8, 9, 10 or 11 of the periodic table, e.g. Au, Ag, Cu), oxidic materials (like glass, quartz, ceramics, SiO2), insulating materials (e.g. Si₃N₄), semiconductors (e.g. doped Si, doped Ge, and GaAs), metal alloys (e.g. on the basis of Au, Ag, Cu, etc.), semiconductor alloys, polymers (e.g. polyvinylchloride, polyolefines, like polyethylene and polypropylene, polyesters, fluoropolymers, polyamides, polyurethanes, polyalkyl(meth)acrylates, polystyrene, rubber and mixtures and composites thereof), ceramics, glass, paper, wood, cloth, concrete, ceramic, etc.

The substrate can be a flexible or inflexible solid substrate with a curved or planar geometry, depending on the requirements of the desired application.

Coated substrates can be produced, for example, by preparing a heat curable composition according to the invention in form of a solution or suspension. The choice of a solvent and the concentration depends mainly on the type of composition and on the coating process.

The solution or suspension can be uniformly applied to a substrate by methods known to a person skilled in the art. Suitable is the application for example by spreading, spraying, dipping, rolling, brushing, knifecoating, whirler-coating, curtain coating methods, reverse-roll coating, electrostatic methods, etc.

The heat curable composition of the invention may be used as a primer, surfacer, pigmented topcoat or basecoat, or as a clearcoat. It may be used as the sole coating composition or in one or more layers of a multilayer coating. It is also especially suitable for coating pretreated substrates, such as metals with conventional primers, etc. The coating composition may be applied in one step or else in two or more steps, such as in 1, 2 or 3 steps, for example. A further possibility is to apply two or more coating compositions successively, for example, one or more primers in combination with one or more topcoats, so as to give a multicoat—for example, a 2-, 3-, 4- or 5-coat—coating system. Between the individual application steps it is possible to carry out drying and/or curing steps. Depending on the nature of the coating composition and of the desired coating, the coating compositions may also be applied wet on wet.

The amount of composition applied is guided in a conventional way by the desired properties of the treated surface, and is situated typically in the range from 1 to 500 g/m², reckoned as nonvolatile constituents of the coating composition. In the case of a multicoat system the amount of coating composition is typically 1 to 200 g/m² per coat.

The curing of the epoxy resins is accomplished, preferably, thermally by heating of the composition to a temperature of preferably 5 to 300° C., more preferably 20 to 250° C., even more preferably from 50 to 230° C., and more particularly 80 to 230° C. Which temperature is suitable depends on the particular compound (a), compound (b), and optionally compounds of the composition and on the desired cure rate. A suitable temperature range can be determined in each individual case by the skilled worker on the basis, for example, of simple preliminary tests.

Alternatively the curing takes place with microwave induction.

UV-curing systems are cured by application of actinic radiation such as UV light or electron beams. In the case of dual-cure systems the general approach would be to carry out a UV curing first and then a thermal cure.

As is known, the photopolymerization of unsaturated compounds can be inhibited by atmospheric oxygen, especially in thin layers. This effect can be diminished by known conventional methods, for example application of a temporary covering layer of polyvinyl alcohol or by (pre-)exposure or (pre-)conditioning under an inert gas. Suitable inert gases are nitrogen, helium, argon, etc. In many cases it is sufficient to reduce the oxygen concentration by a stream of inert gas.

The exposure of the compositions according to the invention can be effected by means of a large number of the most diverse light sources. Both point light sources and two-dimensional emitters (lamp carpets) are suitable. Examples are: carbon arc lamps, xenon arc lamps, mercury vapour lamps, if appropriate doped with metal halides (metal halide lamps), fluorescent lamps, incandescent argon lamps, electronic flashlights and photographic floodlights. Those lamps are particularly suitable which have a comparatively high radiation intensity in the spectral region from 400 to 480 nm. The distance between the lamp and the image material according to the invention can vary depending on the application and the type or intensity of the lamp, for example between 2 cm and 150 cm.

The compositions according to the invention are particularly useful for the production of a layer of a liquid crystal display. Thus, they can be employed e.g. for producing an overcoat layer of a colour filter or an insulating layer or a dielectric layer of a liquid crystal display.

In a special embodiment, the composition according to the invention is used for to form an overcoat layer of a color filter. Color filters are an important part of a liquid crystal display panel and must satisfy various requirements. Of importance are e.g. the heat resistance and chemical resistance of the color filter. Electronic display usually contains a color filter set comprising: a green color filter having a green filter layer a blue color filter having a blue filter layer; a red color filter having a red filter layer (RGB color filters). To form liquid crystal display panels, a transparent layer (overcoat layer) is to be formed on the color filter and further processed into a transparent electrode. If the transparent electrode layer is deposited after applying the RGB color filter elements and the black matrix, an additional overcoat film as a protective layer can be applied on the color filter layer prior to deposition of the electrode layer. The production of color filters for LCDs is described e.g. in U.S. Pat. No. 5,650,263, which is incorporated herein by reference.

To form an overcoat layer of a color filter, usually a thermosetting composition is employed. The composition of the present invention can also be used as a thermosetting composition to form such overcoat layers.

Cured films of the compositions of the invention have at least one of the following advantageous properties:
excellent in flatness,
good hardness,
good chemical and/or thermal resistance,
goodtransparency, especially in a visible region,
good adhesion to various substrates,
suitability for forming transparent conductive films, e.g. an ITO film.

It is a demand of protective layers that unnecessary parts of the protective layer, for example on scribing lines for cutting the substrate and on bonding pads of solid image sensors should be easily removable from the substrate (see e.g. JP57-42009-A, JP1-130103-A and JP1-134306-A). Resins that are only cured thermally are not always optimal for this application. Now it was surprisingly found that a thermosetting composition according to the invention that includes photopolymerizable components (dual cure composition), allows to easily remove the unnecessary parts of the protective layer by photolithography.

The thermosetting compositions including photosensitive components according to the invention are also suitable for manufacturing interlayer insulating layers or dielectric layers in a liquid crystal display including an active matrix type display having a thin film transistor (TFT) as a switching device, and a passive matrix type without a switching device.

In recent years, liquid crystal displays have, for example, been widely used for pocket-type TV sets and terminal devices for communication by virtue of its small thickness and light weight. A reflection type liquid crystal display without necessity of using a back light is in particular in demand because it is ultra-thin and light-weight, and it can significantly reduce power consumption. However, even if a back light is removed out of a presently available transmission type color liquid crystal display and a light reflection plate is added to a lower surface of the display, it would cause a problem in that the efficiency of utilizing lights is low, and it is not possible to have practical brightness. As a solution to this problem, there have been suggested various reflection type liquid crystal displays for enhancing an efficiency of utilizing lights. For instance, a certain reflection type liquid crystal display is designed to include a pixel electrode having reflection function.

The reflection type liquid crystal display includes an insulating substrate and an opposing substrate spaced away from the insulating substrate. A space between the substrates is filled with liquid crystals. A gate electrode is formed on the insulating substrate, and both the gate electrode and the insulating substrate are covered with a gate insulating film. A semiconductor layer is then formed on the gate insulating film above the gate electrode. A source electrode and a drain electrode are also formed on the gate insulating film in contact with the semiconductor layer. The source electrode, the drain electrode, the semiconductor layer, and the gate electrode cooperate with one another to thereby constitute a bottom gate type TFT as a switching device. An interlayer insulating film is formed covering the source electrode, the drain electrode, the semiconductor layer, and the gate insulating film therewith. A contact hole is formed throughout the interlayer insulating film on the drain electrode. A pixel electrode made of aluminum is formed on both the interlayer insulating film and an inner sidewall of the contact hole. The drain electrode of the TFT is eventually in contact with the pixel electrode through the interlayer insulating film. The interlayer insulating layer is generally designed to have a roughened surface by which the pixel electrode acts as a reflection plate which diffuses lights to get a wider angle for viewing (angle of visibility). The reflection type liquid crystal display remarkably enhances an efficiency of using lights by virtue that the pixel electrode acts as a light reflection plate.

In the above-mentioned reflection type liquid crystal display, the interlayer insulating film is designed to have projections and recesses by photolithography. To form and control a fine shape of the projections and recesses in micrometer order for surface roughness and to form contact holes, photolithography methods using positive and negative photoresists are used. For these resists the compositions according to the invention are especially suitable.

The interlayer insulating film may also be used for a transmissive type liquid crystal displays.

The thermosetting compositions according to the invention can further be used for manufacturing column spacers in liquid crystal display panels. In liquid crystal display devices, a liquid crystal layer capable of displaying images is generally arranged between a pair of substrates in accordance with a predetermined orientation. Maintenance of a uniform distance between the substrates, that is, maintaining a uniform thickness of the liquid crystal layer, is one factor determining image quality. For this purpose, spacers are disposed in order to keep the thickness of the liquid crystal layer uniform. The distance between the substrates is generally called the “cell thickness”. The cell thickness usually represents the thickness of the liquid crystal layer, that is, the distance between two electrodes for applying an electric field to the liquid crystal in a display region.

The spacers have been formed by scattering beads. In recent years, however, spacers have been formed with high positional precision by photolithography using a photosensitive composition. Such a spacer, which is formed by use of a photosensitive composition, is called a photospacer.

Since the properties of light transmitted or reflected through the liquid crystal layer in a liquid crystal display are dependent on the cell gap, the thickness accuracy and uniformity over the pixel array are critical parameters for the performance of the liquid crystal display unit. A method of forming columns in the cell gap as spacers has been developed. In this method, columns of a resin are formed as spacers in the region between the pixel array region and the counter electrode to form a prescribed cell gap. Photosensitive materials having adhesive properties with photolithography are commonly used, for instance, in the manufacturing process of color filters. This method is advantageous compared with the conventional method using spacer beads in the points that location, number and height of the spacers may be controlled freely. In a color liquid crystal display panel, such spacers are formed in the nonimaging area under black matrix of color filter elements. Therefore, the spacers formed using photosensitive compositions do not decrease brightness and optical aperture. Photosensitive compositions for producing protective layer with spacers for color filters are disclosed in JP 2000-81701A and dry film type photoresists for spacer materials are also disclosed in JP 11-174459A and JP 11-174464A. As described in the documents, the photosensitive compositions, liquid and dry film photoresists, are comprising at least an alkaline or acid soluble binder polymer, a radically polymerizable monomer, and a radical initiator. Thermally crosslinkable components such as epoxide and oxetane are additionally included.

The steps to form spacers using a photosensitive composition are as follows:

a photosensitive composition is applied to the substrate, for instance a color filter panel and after the substrate is prebaked, it is exposed to light through a mask. Then, the substrate is developed with a developer and patterned to form the desired spacers. A postbaking is carried out to thermally cure the composition.

The photocurable thermosetting compositions according to the invention are particularly suitable for producing spacers for liquid crystal displays (as described above) and lead to cured films with excellent application properties, e.g. excellent hardness, chemical and/or thermal resistance and good deformation restorability.

The thermosetting compositions including photosensitive components according to the invention are also suitable for manufacturing color filters for a liquid crystal display including an active matrix type display having a TFT as a switching device, and a passive matrix type without a switching device and other devices such as image sensors. The color filters usually are prepared by forming red, green and blue pixels and a black matrix on a glass substrate. A particularly preferred method of use comprises adding of the coloring matters, dyes and/or pigments of red, green and blue colors to the light-sensitive resin composition of the present invention, coating of the substrate with the composition, drying of the coating with a short heat treatment, patternwise exposure of the coating to actinic radiation and subsequent development of the pattern in an aqueous alkaline developer solution and a heat treatment. Thus, by subsequently applying a red, green and blue pigmented coating, in any desired order, on top of each other with this process a color filter layer with red, green and blue color pixels can be produced.

Negative or positive resists for manufacturing color filters are disclosed in JP1995-281440, JP1996-334893, JP1997-325483, 1997-197660, JP1995-261015 and WO9418274.

### Other Potential Applications/Use

The compositions according to the invention can also be used advantageously for the following applications:

### Adhesives

for electronic or optical materials in electronic devices such as semiconductor IC, semiconductor devices, printed circuit board, LCD panel, PDP, EL, FED;

for bonding between display panel and flexible printed circuit board (FPC), or chip on FPC(COF) and tape carrier package (TCP);
for micro-bonding between semiconductor IC and circuit board: for optical component fixation
Die bonding materials for bonding an electronic component, such as a semiconductor element, and a supporting member, such as a lead frame and an insulating supporting substrate; for example, a dicing/die bonding tape, a lead frame fixing tape and a LOC fixing tape;
for hot press bonding of electric components through circuit-interconnecting hot-melt adhesive films,
anisotropic electroconductive adhesives,
pressure-sensitive adhesives and adhesive sheets.

### Sealants

for display elements such as liquid crystal panel, plasma display panel, and electroluminescence devices;
for opto-electonic semiconductor such as LED or CCD;
for electronic parts of semiconductor such as diode, transistor, IC, VLSI;
for high-density recording media such as a magneto-optical disk;
for solar battery, and optical waveguide.

### Insulating Materials

for electric or electronic parts, such as an insulating layer between circuits and insulators of printed circuit boards;
for insulated coils;
for wire insulation.

### Coating Compositions

for protective coating, decorative coating, insulating coatings, powder coating, surface-coating, textile coatings;
coating film of conventional organic solvent type paints used as an automobile topcoat paint.

### Impregnating Compositions

in the preparation of adhesives for metals, wood, cement and the like;
in the preparation of reinforced composite products, such as laminated products, filament windings, sheet molding compounds (SMC), electrical laminates, molding powders, fluidized bed powders, potting compounds, etc;
for electrical high-tension or low-tension components or electronic components;
for liquid or solid coating, typically paints, lacquers or powder coating;
Impregnating resins or impregnated tapes such as glass fiber impregnated tape

### Laminates

e.g. laminating resins for electronic components, and
copper-lined laminated sheets.

### Molding Materials,

e.g. as or in a low pressure molding compound.

### Casting Materials

e.g. as or in casting resins for the manufacture of transformers, especially of coil, e.g. for car ignition coils.

### Substrates:

e.g. substrates for semiconductor connection to be used in mounting a semiconductor element or a semiconductor integrated circuit for a wiring board (i.e. interposer), such as a TAB-type pattern processing tape and an interposer for a BGA package;
plastic substrates for displays.

### Other Uses:

printing inks, paints, color-proofing materials for printing, lacquers,
varnishes, like gloss varnish;
potting compounds,
dipping resins, especially for electric condensers,
Matrix resins, especially for encapsulating or impregnating objects,
Construction materials,

### Lenses,

Solder resist composition.

### SYNTHETIC EXAMPLES

### Synthetic Example 1

### Preparation of Potassium Benzylsulfate

71.4 g of benzyl alcohol were added dropwise to a suspension of 95.5 g of pyridine sulfur trioxide complex in 87.0 mL of tetrahydrofuran over 30 min. After stirring the reaction mixture at room temperature for 2 hours, 75.0 mL of 8 mol/L KOH aq. solution was added dropwise over 15 min. The reaction mixture was cooled down with an ice bath, and 400 mL of acetone were added to the reaction mixture. The resulting white solid was filtrated and washed with acetone twice. The solid was dried at 50° C. in vacuo to yield 122.5 g of potassium benzylsulfate as white solid. ¹H-NMR (DMSO/TMS, δ ppm), 4.74 (s, 2H), 7.20-7.35 (m, 5H).

When tetramethylammonium hydroxide was used in place of KOH aq. solution, tetramethylammonium benzylsulfate was obtained as white solid.

Other sulfates were prepared according to the afore-mentioned procedure from the corresponding alcohol.

### Synthetic Example 100

### Preparation of

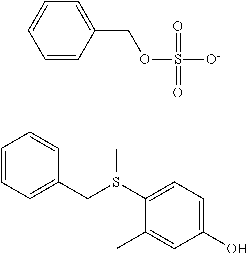 [SMILES: O=S(=O)([O-])OCc1ccccc1 ; Cc1cc(O)ccc1[S+](C)Cc1ccccc1]

5.12 g of 4-(methylthio)-m-cresol and 5.68 g of benzyl bromide were combined and stirred at room temperature for 16 h. The resulting beige solid was filtered and washed with acetone. 7.63 g of white solid were obtained.

325 mg of this solid were suspended in 3 mL of H₂O and 290 mg of tetramethylammonium benzylsulfate were added at room temperature. The resulting sulfonium benzylsulfate was extracted with ethyl acetate and 2-butanone. The organic layer was washed with water and concentrated in vacuo. The resulting solid was washed with t-butyl methyl ether, and 209 mg of white solid were obtained.

### Synthetic Example 154

### Preparation of

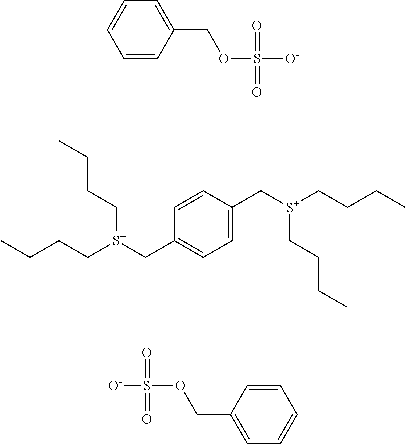 [SMILES: O=S(=O)([O-])OCc1ccccc1 ; CCCC[S+](CCCC)Cc1ccc(C[S+](CCCC)CCCC)cc1 ; O=S(=O)([O-])OCc1ccccc1]

0.35 g of p-xylene glycol and 1.10 g of butylsulfide were suspended in 0.97 g of methanesulfonic acid at room temperature and stirred for 6 days. The reaction mixture was neutralized with NaHCO₃ aq. solution, and then the aq. layer was washed with t-butyl methyl ether. To the aq. layer was added 1.70 g of potassium benzylsulfate at room temperature, and the reaction mixture was stirred for 30 min. The resulting sulfonium benzylsulfate was extracted with ethyl acetate and 2-butanone. The organic layer was washed with water and then concentrated in vacuo. The resulting resin was washed with t-butyl methyl ether, and 1.50 g of white resin were obtained.

The compounds of the formulae Ia and Ib listed in table 1 below were prepared in an analogous manner.

TABLE 1

| | | ¹H NMR |
|---|---|---|
| Sulfonium sulfates | | solvent/δ (ppm, TMS) |
| S1 | 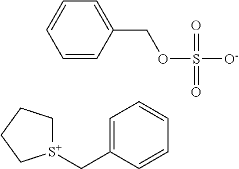 [SMILES: O=S(=O)([O-])OCc1ccccc1 ; c1ccc(C[S+]2CCCC2)cc1] | DMSO-d6/2.03-2.30 (m), 3.32- 3.51 (m), 4.53 (s), 4.74 (s), 4.93 (d), 7.21-7.35 (m), 7.40-7.51 (m), 7.51-7.58 (m) |
| S2 | 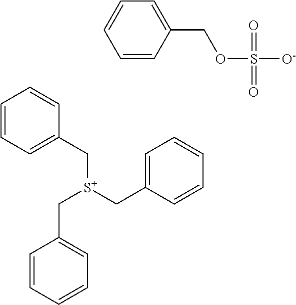 [SMILES: c1ccc(C[S+](Cc2ccccc2)Cc2ccccc2)cc1 ; O=S(=O)([O-])OCc1ccccc1] | DMSO-d6/4.74 (s), 4.76 (s), 7.21- 7.36 (m) |
| S3 | 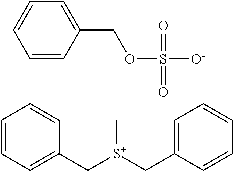 [SMILES: O=S(=O)([O-])OCc1ccccc1 ; C[S+](Cc1ccccc1)Cc1ccccc1] | DMSO-d6/2.67 (s), 4.59 (d), 4.74 (s), 4.76 (d), 7.21-7.35 (m), 7.44 (br s) |
| S4 | 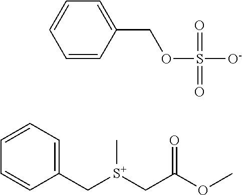 | DMSO-d6/2.89 (s), 3.60 (s), 4.45 (d), 4.51 (d), 4.72 (d), 4.75 (s), 4.77 (d), 7.21-7.35 (m), 7.40-7.50 (m) |
| S5 | 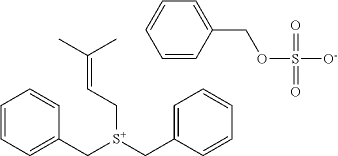 [SMILES: CC(C)=CC[S+](Cc1ccccc1)Cc1ccccc1 ; O=S(=O)([O-])OCc1ccccc1] | DMSO-d6/1.59 (s), 1.65 (s), 4.04 (d), 4.70 (s), 4.73 (s), 5.08 (br t), 7.21-7.35 (m), 7.39 (br s) |
| S6 | 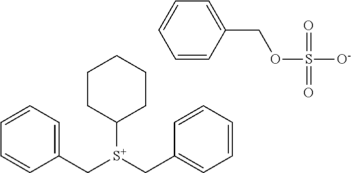 [SMILES: c1ccc(C[S+](Cc2ccccc2)C2CCCCC2)cc1 ; O=S(=O)([O-])OCc1ccccc1] | DMSO-d6/1.12-1.40 (m), 1.50- 1.66 (m), 1.71-1.85 (br d), 2.00- 2.14 (br d), 3.68 (tt), 4.71 (d), 4.76 (s), 4.88 (d), 7.21-7.35 (m), 7.37 (br s) |
| S7 | 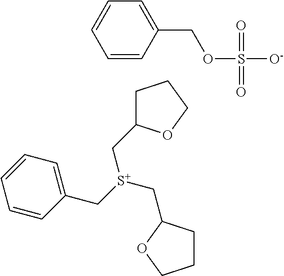 [SMILES: c1ccc(C[S+](CC2CCCO2)CC2CCCO2)cc1 ; O=S(=O)([O-])OCc1ccccc1] | DMSO-d6/1.50-1.68 (m), 1.75- 1.94 (m), 1.97-2.12 (m), 3.32-3.88 (m), 4.06-4.18 (m), 4.18-4.32 (m), 4.76 (s), 4.77-4.88 (m), 7.21-7.36 (m), 7.44-7.55 (m) |
| S8 | 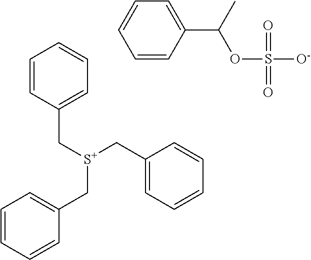 [SMILES: c1ccc(C[S+](Cc2ccccc2)Cc2ccccc2)cc1 ; CC(OS(=O)(=O)[O-])c1ccccc1] | DMSO-d6/1.40 (d), 4.76 (s), 5.17 (q), 7.16-7.37 (m) |
| S9 | 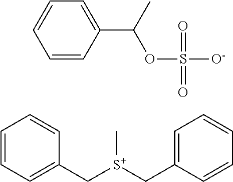 [SMILES: CC(OS(=O)(=O)[O-])c1ccccc1 ; C[S+](Cc1ccccc1)Cc1ccccc1] | DMSO-d6/1.41 (d), 4.59 (d), 4.76 (d), 5.19 (q), 7.16-7.36 (m), 7.44 (br s) |
| S10 | 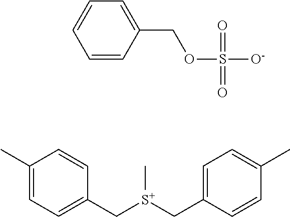 | DMSO-d6/2.31 (s), 2.50 (s), 4.51 (d), 4.69 (d), 4.74 (s), 7.21-7.37 (m) |
| S11 | 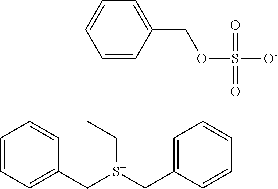 [SMILES: O=S(=O)([O-])OCc1ccccc1 ; CC[S+](Cc1ccccc1)Cc1ccccc1] | DMSO-d6/1.15 (t), 3.25 (q), 4.70 (d), 4.75 (d), 4.76 (s), 7.20-7.54 (m) |
| S12 | 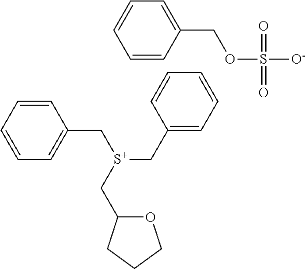 [SMILES: c1ccc(C[S+](Cc2ccccc2)CC2CCCO2)cc1 ; O=S(=O)([O-])OCc1ccccc1] | DMSO-d6/1.42-1.53 (m), 1.68- 1.84 (m), 1.86-1.98 (m), 3.35 (dd), 3.50-3.61 (m), 3.61-3.68 (m), 3.93- 4.03 (m), 4.74 (d), 4.75 (s), 4.79 (d), 7.21-7.33 (m), 7.35-7.48 (m) |
| S13 | 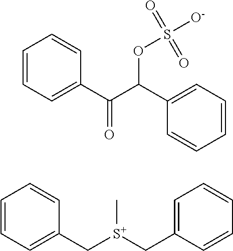 [SMILES: O=C(c1ccccc1)C(OS(=O)(=O)[O-])c1ccccc1 ; C[S+](Cc1ccccc1)Cc1ccccc1] | DMSO-d6/2.68 (s), 4.59 (d), 4.76 (d), 6.30 (s), 7.22-7.34 (m), 7.37- 7.47 (m), 7.55 (t), 7.98 (d) |
| S14 | 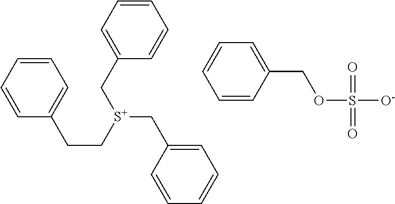 [SMILES: c1ccc(CC[S+](Cc2ccccc2)Cc2ccccc2)cc1 ; O=S(=O)([O-])OCc1ccccc1] | DMSO-d6/2.72 (dd), 3.52 (dd), 4.75 (s), 4.77 (d), 4.83 (d), 7.00 (d), 7.18-7.29 (m), 7.30 (d), 7.40-7.50 (m) |
| S15 | 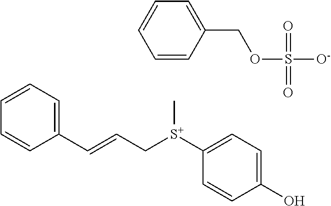 [SMILES: C[S+](C/C=C/c1ccccc1)c1ccc(O)cc1 ; O=S(=O)([O-])OCc1ccccc1] | CD3OD/3.23 (s), 4.35 (dd), 4.46 (dd), 5.01 (s), 6.14 (dt), 6.66 (dt), 7.0 (d), 7.25-7.42 (m), 7.76 (d) |
| S16 | 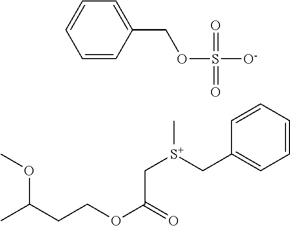 [SMILES: O=S(=O)([O-])OCc1ccccc1 ; COC(C)CCOC(=O)C[S+](C)Cc1ccccc1] | DMSO-d6/1.06 (d), 1.60-1.70 (m), 2.89 (s), 3.18 (s), 3.27-3.37 (m), 3.98-4.14 (m), 4.41-4.54 (m), 4.41- 4.54 (m), 4.74 (s), 7.22-7.35 (m), 7.39-7.49 (m) |
| S17 | 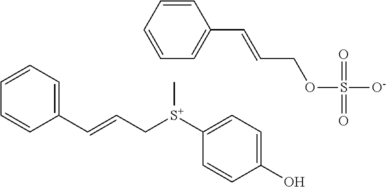 [SMILES: C[S+](C/C=C/c1ccccc1)c1ccc(O)cc1 ; O=S(=O)([O-])OC/C=C/c1ccccc1] | CD3OD/3.23 (s), 4.36 (dd), 4.47 (dd), 4.66 (d), 6.14 (dt), 6.37 (dt), 6.67 (d), 7.05 (d), 7.16-7.44 (m), 7.76 (d) |
| S18 | 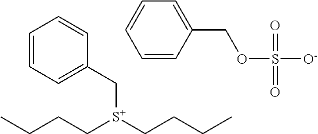 [SMILES: CCCC[S+](CCCC)Cc1ccccc1 ; O=S(=O)([O-])OCc1ccccc1] | DMSO-d6/0.83 (t), 1.25-1.37 (m), 1.46-1.68 (m), 3.19-3.32 (m), 4.75 (s), 7.23-7.34 (m), 7.43-7.54 (m) |
| S19 | 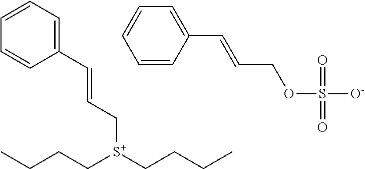 [SMILES: CCCC[S+](C/C=C/c1ccccc1)CCCC ; O=S(=O)([O-])OC/C=C/c1ccccc1] | DMSO-d6/0.89 (t), 1.34-1.46 (m), 1.66-1.76 (m), 3.21-3.35 (m), 4.30 (d), 4.38 (d), 6.28-6.40 (m), 6.56 (d), 6.94 (d), 7.22 (t), 7.27-7.43 (m), 7.53 (d) |
| S20 | 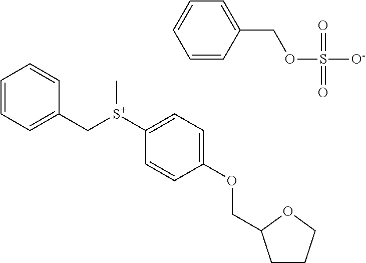 [SMILES: C[S+](Cc1ccccc1)c1ccc(OCC2CCCO2)cc1 ; O=S(=O)([O-])OCc1ccccc1] | DMSO-d6/1.60-1.71 (m), 1.77- 2.06 (m), 3.28 (s), 3.64-3.80 (m), 3.97-4.20 (m), 4.75 (s), 4.87 (d), 5.05 (d), 7.17-7.42 (m), 7.82 (d) |
| S21 | 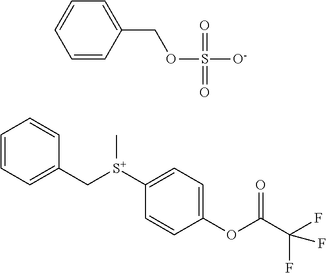 [SMILES: O=S(=O)([O-])OCc1ccccc1 ; C[S+](Cc1ccccc1)c1ccc(OC(=O)C(F)(F)F)cc1] | DMSO-d6/3.24 (s), 4.74 (s), 4.81 (d), 4.98 (d), 6.95 (d), 7.13-7.43 (m), 7.69 (d) |
| S22 | 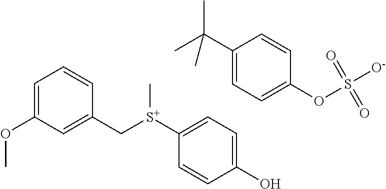 [SMILES: COc1cccc(C[S+](C)c2ccc(O)cc2)c1 ; CC(C)(C)c1ccc(OS(=O)(=O)[O-])cc1] | CD3OD/1.30 (s), 3.22 (s), 3.71 (s), 4.68 (d), 4.86 (d), 6.71 (br s), 6.78 (d), 6.95 (dd), 6.99 (d), 7.21 (d), 7.26 (t), 7.34 (d), 7.61 (d) |
| S23 | 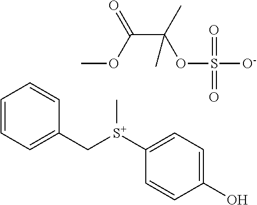 [SMILES: C[S+](Cc1ccccc1)c1ccc(O)cc1 ; COC(=O)C(C)(C)OS(=O)(=O)[O-]] | DMSO-d6/1.38 (s), 3.24 (s), 3.53 (s), 4.81 (d), 4.98 (d), 6.95 (d), 7.17 (d), 7.30-7.41 (m), 7.69 (d) |
| S24 | 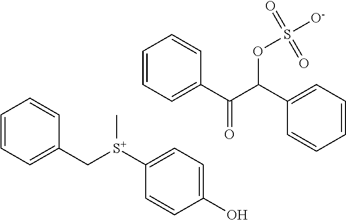 [SMILES: C[S+](Cc1ccccc1)c1ccc(O)cc1 ; O=C(c1ccccc1)C(OS(=O)(=O)[O-])c1ccccc1] | DMSO-d6/3.25 (s), 4.83 (d), 4.99 (d), 6.28 (s), 6.97 (d), 7.18 (d), 7.24-7.43 (m), 7.46 (t), 7.57 (t), 7.71 (d), 7.99 (d), 10.78 (s) |
| S25 | 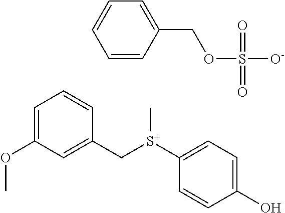 [SMILES: COc1cccc(C[S+](C)c2ccc(O)cc2)c1 ; O=S(=O)([O-])OCc1ccccc1] | DMSO-d6/3.22 (s), 3.65 (s), 4.73 (s), 4.77 (d), 4.93 (d), 6.72 (d), 6.74 (d), 6.92 (dd), 6.96 (d), 7.21-7.35 (m), 7.70 (d) |
| S26 | 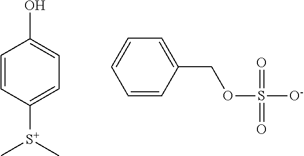 | CD₃OD/3.17 (s), 5.00 (s), 7.05 (d), 7.25-7.46 (m), 7.82 (d) |
| S27 | 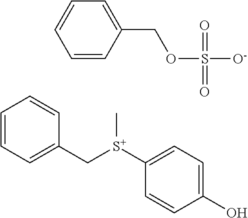 [SMILES: O=S(=O)([O-])OCc1ccccc1 ; C[S+](Cc1ccccc1)c1ccc(O)cc1] | DMSO-d6/3/23 (s), 4.73 (s), 4.80 (d), 4.97 (d), 6.94 (d), 7.16 (d), 7.21-7.40 (m), 7.68 (d) |
| S28 | 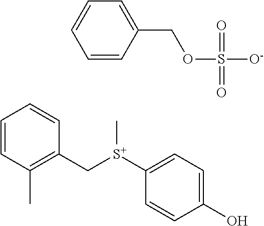 [SMILES: O=S(=O)([O-])OCc1ccccc1 ; Cc1ccccc1C[S+](C)c1ccc(O)cc1] | DMSO-d6/2.21 (s), 3.33 (s), 4.73 (s), 4.84 (d), 5.00 (d), 6.92 (d), 7.00 (d), 7.09 (t), 7.17-7.35 (m), 7.67 (d) |
| S29 | 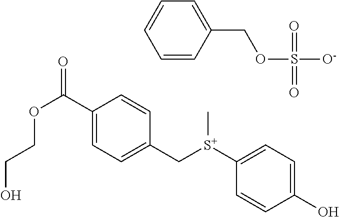 [SMILES: C[S+](Cc1ccc(C(=O)OCCO)cc1)c1ccc(O)cc1 ; O=S(=O)([O-])OCc1ccccc1] | DMSO-d6/3.26 (s), 3.66 (br s), 4.24 (t), 4.73 (s), 4.88 (d), 5.05 (d), 6.95 (d), 7.20-7.35 (m), 7.69 (d), 7.93 (d) |
| S30 | 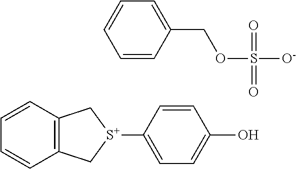 [SMILES: O=S(=O)([O-])OCc1ccccc1 ; Oc1ccc([S+]2Cc3ccccc3C2)cc1] | DMSO-d6/4.73 (s), 4.90 (d), 5.25 (d), 6.88 (d), 7.21-7.35 (m), 7.38- 7.46 (m), 7.47-7.54 (m) |
| S31 | 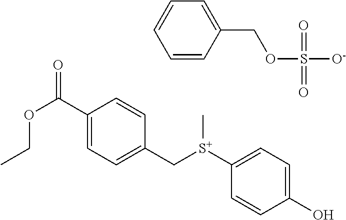 [SMILES: CCOC(=O)c1ccc(C[S+](C)c2ccc(O)cc2)cc1 ; O=S(=O)([O-])OCc1ccccc1] | DMSO-d6/1.28 (t), 3.26 (s), 4.73 (s), 4.88 (d), 5.05 (d), 6.94 (d), 7.20-7.35 (m), 7.69 (d), 7.89 (d) |
| S32 | 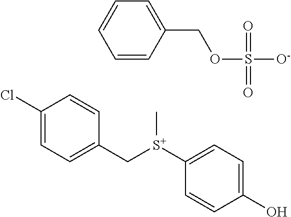 [SMILES: O=S(=O)([O-])OCc1ccccc1 ; C[S+](Cc1ccc(Cl)cc1)c1ccc(O)cc1] | DMSO-d6/3.23 (s), 4.73 (s), 4.80 (d), 4.96 (d), 6.95 (d), 7.18 (d), 7.21-7.35 (m), 7.42 (d), 7.69 (d) |
| S33 | 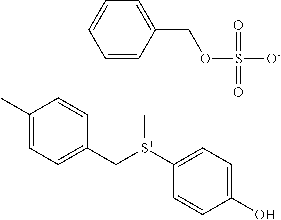 [SMILES: O=S(=O)([O-])OCc1ccccc1 ; Cc1ccc(C[S+](C)c2ccc(O)cc2)cc1] | DMSO-d6/2.25 (s), 3.21 (s), 4.73 (s), 4.77 (d), 4.92 (d), 6.95 (d), 7.05 (d), 7.14 (d), 7.21-7.35 (m), 7.69 (d) |
| S34 | 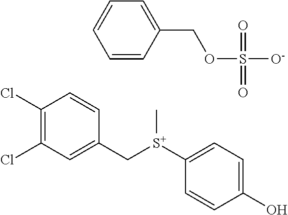 [SMILES: O=S(=O)([O-])OCc1ccccc1 ; C[S+](Cc1ccc(Cl)c(Cl)c1)c1ccc(O)cc1] | DMSO-d6/3.23 (s), 4.73 (s), 4.78 (d), 4.93 (d), 6.96 (d), 7.15 (dd), 7.20-7.34 (m), 7.45 (d), 7.64 (d), 7.70 (d) |
| S35 | 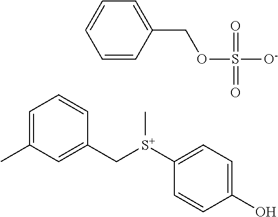 [SMILES: O=S(=O)([O-])OCc1ccccc1 ; Cc1cccc(C[S+](C)c2ccc(O)cc2)c1] | DMSO-d6/2.22 (s), 3.21 (s), 4.73 (s), 4.76 (d), 4.92 (d), 6.91-7.00 (m), 7.15-7.35 (m), 7.68 (d) |
| S36 | 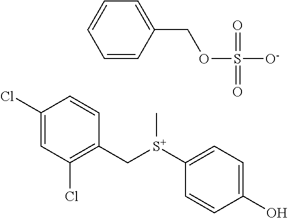 [SMILES: O=S(=O)([O-])OCc1ccccc1 ; C[S+](Cc1ccc(Cl)cc1Cl)c1ccc(O)cc1] | DMSO-d6/3.39 (s), 4.74 (s), 4.95 (d), 5.07 (d), 6.94 (d), 7.22-7.35 (m), 7.42 (dd), 7.70 (d), 7.71 (s) |
| S37 | 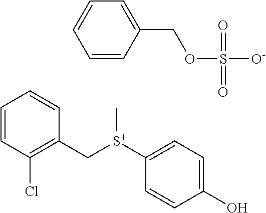 [SMILES: C[S+](Cc1ccccc1Cl)c1ccc(O)cc1 ; O=S(=O)([O-])OCc1ccccc1] | DMSO-d6/3.37 (s), 4.72 (s), 4.94 (d), 5.08 (d), 6.90 (d), 7.21-7.34 (m), 7.38 (dt), 7.48 (d), 7.67 (d) |
| S38 | 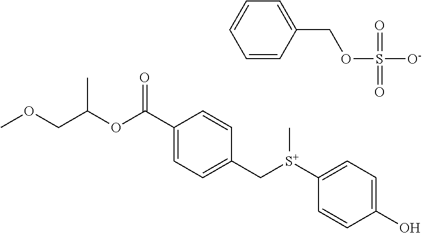 [SMILES: COCC(C)OC(=O)c1ccc(C[S+](C)c2ccc(O)cc2)cc1 ; O=S(=O)([O-])OCc1ccccc1] | DMSO-d6/1.24 (d), 3.27 (s), 3.42- 3.55 (m), 4.74 (s), 4.90 (d), 5.06 (d), 5.14-5.24 (m), 6.96 (d), 7.22- 7.38 (m), 7.71 (d), 7.90 (d) |
| S39 | 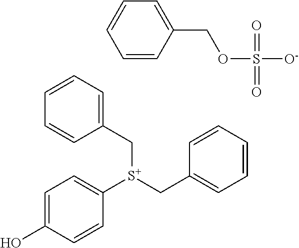 [SMILES: Oc1ccc([S+](Cc2ccccc2)Cc2ccccc2)cc1 ; O=S(=O)([O-])OCc1ccccc1] | Acetone-d6/5.07 (s), 5.24 (d), 5.43 (d), 7.09 (d), 7.20-7.46 (m), 7.78 (d) |
| S40 | 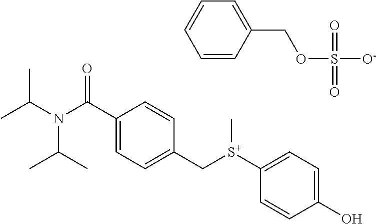 [SMILES: CC(C)N(C(=O)c1ccc(C[S+](C)c2ccc(O)cc2)cc1)C(C)C ; O=S(=O)([O-])OCc1ccccc1] | DMSO-d6/1.04 (br s), 1.38 (br s), 3.27 (s), 3.49 (br s), 4.74 (s), 4.82 (d), 5.02 (d), 6.94 (d), 7.16-7.34 (m), 7.68 (d), 10.78 (s) |
| S41 | 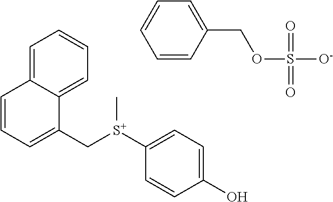 [SMILES: C[S+](Cc1cccc2ccccc12)c1ccc(O)cc1 ; O=S(=O)([O-])OCc1ccccc1] | DMSO-d6/3.38 (s), 4.74 (s), 5.26 (d), 5.52 (d), 6.87 (d), 7.19-7.41 (m), 7.56-7.69 (m), 7.95 (d), 7.98 (d), 8.32 (d) |
| S42 | 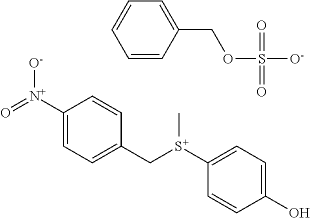 [SMILES: C[S+](Cc1ccc([N+](=O)[O-])cc1)c1ccc(O)cc1 ; O=S(=O)([O-])OCc1ccccc1] | DMSO-d6/3.28 (s), 4.73 (s), 4.96 (d), 5.10 (d), 6.96 (d), 7.22-7.36 (m), 7.47 (d), 7.71 (d), 8.21 (d) |
| S43 | 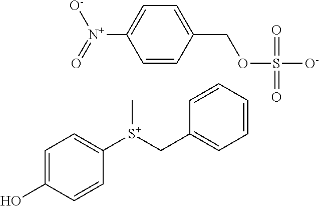 [SMILES: C[S+](Cc1ccccc1)c1ccc(O)cc1 ; O=[N+]([O-])c1ccc(COS(=O)(=O)[O-])cc1] | DMSO-d6/3.24 (s), 4.81 (d), 4.90 (s), 4.98 (d), 6.96 (d), 7.17 (d), 7.29-7.40 (m), 7.60 (d), 7.70 (d), 8.19 (d), 10.8 (br s) |
| S44 | 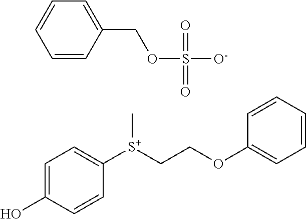 [SMILES: O=S(=O)([O-])OCc1ccccc1 ; C[S+](CCOc1ccccc1)c1ccc(O)cc1] | DMSO-d6/3.29 (s), 3.95-4.05 (m), 4.05-4.16 (m), 4.35-4.43 (m), 4.72 (s), 6.83 (d), 6.94 (t), 6.98 (d), 7.20-7.34 (m), 7.84 (d) |
| S45 | 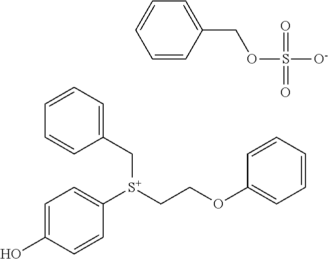 [SMILES: Oc1ccc([S+](CCOc2ccccc2)Cc2ccccc2)cc1 ; O=S(=O)([O-])OCc1ccccc1] | DMSO-d6/3.96-4.10 (m), 4.21 (t), 4.40-4.49 (m), 4.72 (s), 5.02 (d), 5.16 (d), 6.80 (d), 6.89-6.97 (m), 7.18-7.37 (m), 7.75 (d) |
| S46 | 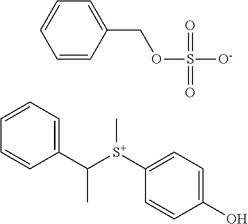 [SMILES: O=S(=O)([O-])OCc1ccccc1 ; CC(c1ccccc1)[S+](C)c1ccc(O)cc1] | DMSO-d6/1.53 (d), 1.81 (d), 3.03 (s), 3.28 (s), 4.73 (s), 5.08-5.19 (m), 6.86 (d), 7.05 (d), 7.11 (d), 7.20-7.39 (m), 7.43 (d), 7.47 (br s), 7.74 (d), 10.78 (br s), 10.88 (br s) *Mixture of stereoisomers |
| S47 | 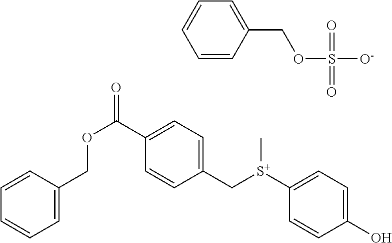 [SMILES: C[S+](Cc1ccc(C(=O)OCc2ccccc2)cc1)c1ccc(O)cc1 ; O=S(=O)([O-])OCc1ccccc1] | DMSO-d6/3.25 (s), 4.73 (s), 4.88 (d), 5.05 (d), 5.31 (s), 6.94 (d), 7.21-7.48 (m), 7.69 (d), 7.93 (d) |
| S48 | 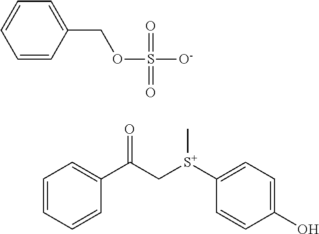 [SMILES: O=S(=O)([O-])OCc1ccccc1 ; C[S+](CC(=O)c1ccccc1)c1ccc(O)cc1] | DMSO-d6/3.25 (s), 4.73 (s), 5.76 (s), 7.02 (d), 7.21-7.36 (m), 7.59 (t), 7.75 (t), 7.92 (d), 7.99 (d), 10.78 (s) |
| S49 | 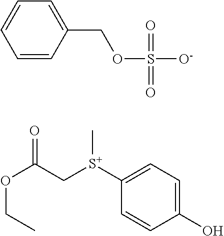 | DMSO-d6/1.12 (t), 3.25 (s), 4.05- 4.18 (m), 4.73 (s), 4.80 (d), 4.89 (d), 7.02 (d), 7.21-7.35 (m), 7.88 (d), 10.83 (br s) |
| S50 | 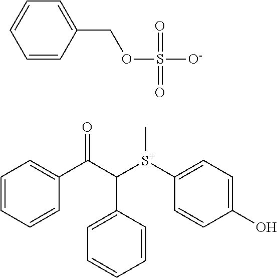 [SMILES: O=S(=O)([O-])OCc1ccccc1 ; C[S+](c1ccc(O)cc1)C(C(=O)c1ccccc1)c1ccccc1] | DMSO-d6/1.53 (d), 1.81 (d), 3.03 (s), 3.28 (s), 4.73 (s), 5.08-5.19 (m), 6.86 (d), 7.05 (d), 7.11 (d), 7.20-7.39 (m), 7.43 (d), 7.47 (br s), 7.74 (d), 10.78 (br s), 10.88 (br s) *Mixture of stereoisomers |
| S51 | 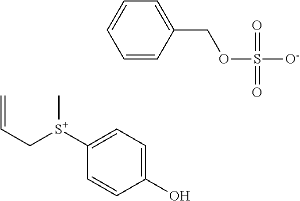 | DMSO-d6/3.20 (s), 4.24 (dd), 4.34 (dd), 4.73 (s), 5.33 (d), 5.42 (d), 5.65-5.79 (m), 7.02 (d), 7.20- 7.36 (m), 7.81 (d) |
| S52 | 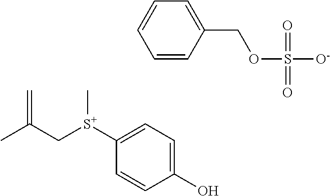 | DMSO-d6/1.73 (s), 3.22 (s), 4.27 (d), 4.36 (d), 4.73 (s), 4.89 (s), 5.06 (s), 7.01 (d), 7.21-7.35 (m), 7.86 (d), 10.80 (br s) |
| S53 | 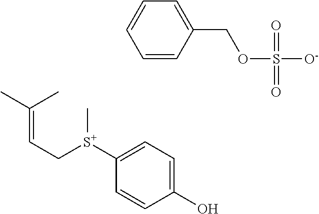 | CD3OD/1.19 (s), 3.18 (s), 4.16- 4.28 (m), 5.00 (s), 5.18 (br t), 7.05 (d), 7.26-7.42 (m), 7.73 (d) |
| S54 | 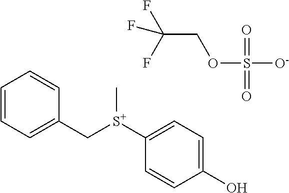 [SMILES: C[S+](Cc1ccccc1)c1ccc(O)cc1 ; O=S(=O)([O-])OCC(F)(F)F] | DMSO-d6/3.24 (s), 4.17 (q), 4.81 (d), 4.98 (d), 6.96 (d), 7.17 (d), 7.31-7.40 (m), 7.69 (d) |
| S55 | 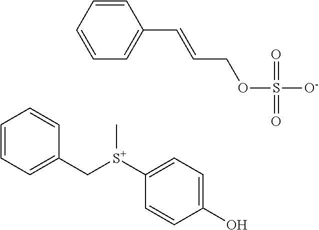 [SMILES: C[S+](Cc1ccccc1)c1ccc(O)cc1 ; O=S(=O)([O-])OC/C=C/c1ccccc1] | DMSO-d6/3.25 (s), 4.38 (d), 4.82 (d), 4.99 (d), 6.34 (dt), 6.58 (d), 6.97 (d), 7.18 (d), 7.24 (t), 7.29- 7.41 (m), 7.43 (d), 7.70 (d) |
| S56 | 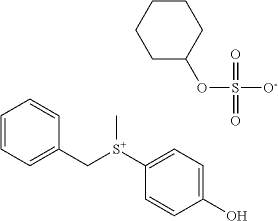 [SMILES: C[S+](Cc1ccccc1)c1ccc(O)cc1 ; O=S(=O)([O-])OC1CCCCC1] | DMSO-d6/1.05-1.32 (m), 1.35- 1.46 (m), 1.54-1.66 (m), 1.74-1.85 (m), 3.91-4.06 (m), 4.81 (d), 4.98 (d), 6.94 (d), 7.17 (d), 7.28-7.40 (m), 7.68 (d) |
| S57 | 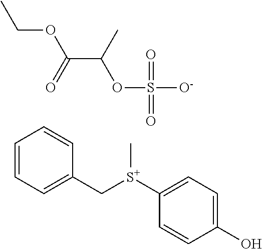 [SMILES: CCOC(=O)C(C)OS(=O)(=O)[O-] ; C[S+](Cc1ccccc1)c1ccc(O)cc1] | DMSO-d6/1.15 (t), 1.25 (d), 3.22 (s), 4.04 (q), 4.47 (q), 4.80 (d), 4.97 (d), 6.94 (d), 7.16 (d), 7.28-7.40 (m), 7.68 (d) |
| S58 | 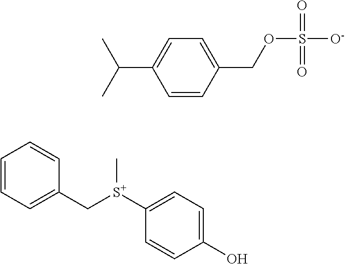 [SMILES: CC(C)c1ccc(COS(=O)(=O)[O-])cc1 ; C[S+](Cc1ccccc1)c1ccc(O)cc1] | DMSO-d6/1.17 (d), 2.85 (m), 3.23 (s), 4.89 (s), 4.81 (d), 4.98 (d), 6.95 (d), 7.14-7.24 (m), 7.30-7.40 (m), 7.69 (d) |
| S59 | 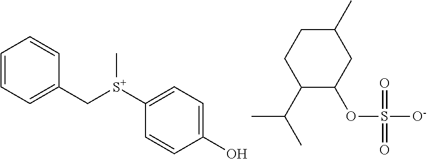 [SMILES: C[S+](Cc1ccccc1)c1ccc(O)cc1 ; CC1CCC(C(C)C)C(OS(=O)(=O)[O-])C1] | DMSO-d6/0.66-1.10 (m), 1.22- 1.36 (m), 1.54 (br t), 2.04-2.19 (m), 2.28 (br d), 3.22 (s), 3.77 (dt), 4.79 (d), 4.96 (d), 6.92 (d), 7.16 (d), 7.29-7.40 (m), 7.66 (d) |
| S60 | 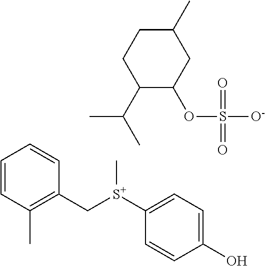 [SMILES: Cc1ccccc1C[S+](C)c1ccc(O)cc1 ; CC1CCC(C(C)C)C(OS(=O)(=O)[O-])C1] | DMSO-d6/0.66-1.10 (m), 1.22- 1.36 (m), 1.54 (br t), 2.08-2.17 (m), 2.21 (s), 2.28 (br d), 3.33 (s), 3.77 (dt), 4.83 (d), 4.99 (d), 6.90 (d), 7.01 (d), 7.09 (t), 7.19 (d), 7.24 (t), 7.66 (d) |
| S61 | 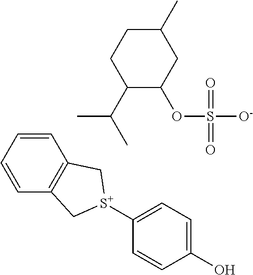 [SMILES: Oc1ccc([S+]2Cc3ccccc3C2)cc1 ; CC1CCC(C(C)C)C(OS(=O)(=O)[O-])C1] | DMSO-d6/0.67-1.10 (m), 1.22- 1.36 (m), 1.54 (br t), 2.06-2.18 (m), 2.28 (br d), 3.77 (dt), 4.90 (d), 5.25 (d), 6.88 (d), 7.38-7.54 (m) |
| S62 | 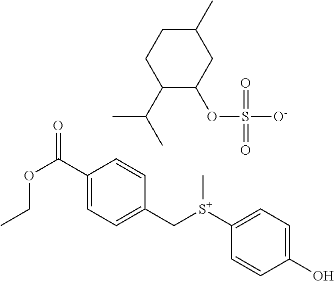 [SMILES: CCOC(=O)c1ccc(C[S+](C)c2ccc(O)cc2)cc1 ; CC1CCC(C(C)C)C(OS(=O)(=O)[O-])C1] | DMSO-d6/0.67-1.10 (m), 1.22- 1.36 (m), 1.54 (br t), 2.08-2.17 (m), 2.28 (br d), 3.33 (s), 3.77 (dt), 4.28 (d), 4.88 (d), 5.04 (d), 6.93 (d), 7.31 (d), 7.68 (d), 7.90 (d) |
| S63 | 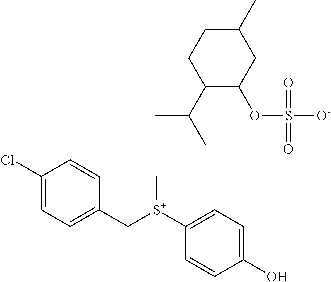 [SMILES: CC1CCC(C(C)C)C(OS(=O)(=O)[O-])C1 ; C[S+](Cc1ccc(Cl)cc1)c1ccc(O)cc1] | DMSO-d6/0.67-1.10 (m), 1.22- 1.36 (m), 1.54 (br t), 2.08-2.17 (m) 2.28 (br d), 3.23 (s), 3.78 (dt), 4.80 (d), 4.96 (d), 6.95 (d), 7.18 (d), 7.42 (d), 7.69 (d) |
| S64 | 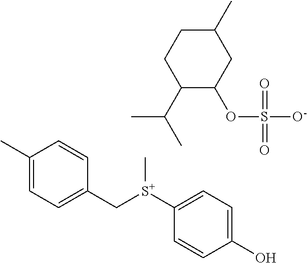 [SMILES: Cc1ccc(C[S+](C)c2ccc(O)cc2)cc1 ; CC1CCC(C(C)C)C(OS(=O)(=O)[O-])C1] | DMSO-d6/0.67-1.10 (m), 1.22- 1.36 (m), 1.54 (br t), 2.08-2.17 (m), 2.24 (s), 2.28 (br d), 3.22 (s), 3.77 (dt), 4.77 (d), 4.92 (d), 6.94 (d), 7.04 (d), 7.14 (d), 7.68 (d) |
| S65 | 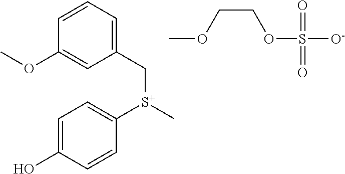 | DMSO-d6/3.21 (s), 3.22 (s), 3.42 (t), 3.65 (t), 3.76 (t), 4.76 (d), 4.92 (d), 6.69-6.77 (m), 6.90-6.99 (m), 7.25 (t), 7.70 (d) |
| S66 | 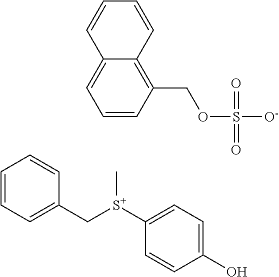 [SMILES: O=S(=O)([O-])OCc1cccc2ccccc12 ; C[S+](Cc1ccccc1)c1ccc(O)cc1] | DMSO-d6/3.22 (s), 4.79 (d), 4.96 (d), 5.15 (s), 6.93 (d), 7.15 (d), 7.28-7.38 (m), 7.43 (t), 7.47-7.56 (m), 7.68 (d), 7.86 (d), 7.90 (d), 8.16 (d) |
| S67 | 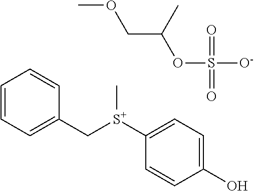 | DMSO-d6/1.10 (d), 3.22 (s), 3.24 (s), 3.19 (dd), 3.38 (dd), 4.16-4.27 (m), 4.81 (d), 4.98 (d), 6.95 (d), 7.17 (d), 7.30-7.41 (m), 7.69 (d) |
| S68 | 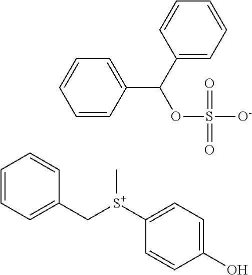 [SMILES: O=S(=O)([O-])OC(c1ccccc1)c1ccccc1 ; C[S+](Cc1ccccc1)c1ccc(O)cc1] | DMSO-d6/3.23 (s), 4.81 (d), 4.98 (d), 6.14 (s), 6.95 (s), 7.16-7.40 (m), 7.69 (d) |
| S69 | 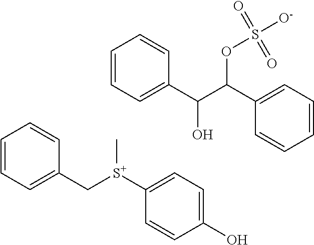 [SMILES: C[S+](Cc1ccccc1)c1ccc(O)cc1 ; O=S(=O)([O-])OC(c1ccccc1)C(O)c1ccccc1] | DMSO-d6/3.25 (s), 4.82 (d), 4.99 (d), 5.06 (br s), 5.31 (d), 5.55 (d), 6.91-7.04 (m), 7.08-7.23 (m), 7.31- 7.41 (m), 7.70 (d) |
| S70 | 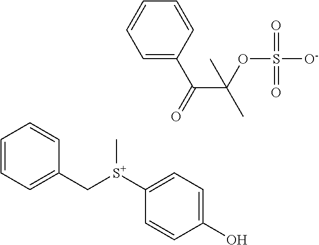 [SMILES: CC(C)(OS(=O)(=O)[O-])C(=O)c1ccccc1 ; C[S+](Cc1ccccc1)c1ccc(O)cc1] | DMSO-d6/1.48 (s), 3.23 (s), 4.81 (d), 4.98 (d), 6.96 (d), 7.17 (d), 7.30-7.38 (m), 7.40 (t), 7.48 (tH), 7.70 (d), 8.19 (d), 10.8 (br s) |
| S71 | 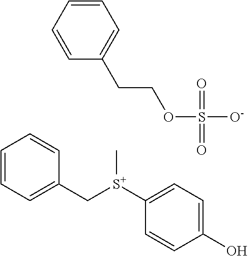 [SMILES: C[S+](Cc1ccccc1)c1ccc(O)cc1 ; O=S(=O)([O-])OCCc1ccccc1] | DMSO-d6/2.81 (t), 3.23 (s), 3.89 (t), 4.81 (d), 4.97 (d), 6.93 (d), 7.11-7.40 (m), 7.68 (d) |
| S72 | 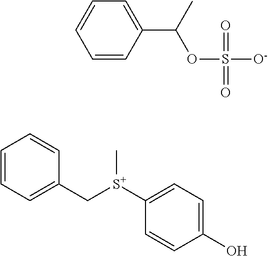 [SMILES: CC(OS(=O)(=O)[O-])c1ccccc1 ; C[S+](Cc1ccccc1)c1ccc(O)cc1] | DMSO-d6/1.41 (d), 3.24 (s), 4.82 (d), 4.98 (d), 5.18 (q), 6.96 (d), 7.15-7.40 (m), 7.70 (d), 10.8 (br s) |
| S73 | 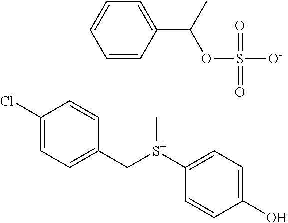 [SMILES: CC(OS(=O)(=O)[O-])c1ccccc1 ; C[S+](Cc1ccc(Cl)cc1)c1ccc(O)cc1] | DMSO-d6/1.40 (d), 3.23 (s), 4.81 (d), 4.96 (d), 5.17 (q), 6.96 (d), 7.16-7.33 (m), 7.43 (d), 7.70 (d) |
| S74 | 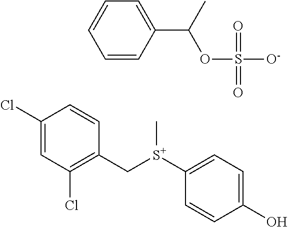 [SMILES: CC(OS(=O)(=O)[O-])c1ccccc1 ; C[S+](Cc1ccc(Cl)cc1Cl)c1ccc(O)cc1] | DMSO-d6/1.40 (d), 3.38 (s), 4.95 (d), 5.06 (d), 5.17 (q), 6.93 (d), 7.16-7.36 (m), 7.43 (d), 7.70 (d), 7.71 (s) |
| S75 | 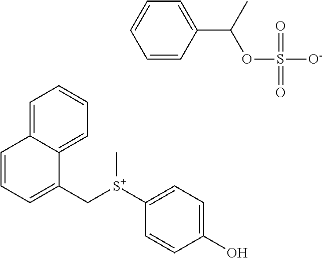 [SMILES: C[S+](Cc1cccc2ccccc12)c1ccc(O)cc1 ; CC(OS(=O)(=O)[O-])c1ccccc1] | DMSO-d6/1.40 (d), 3.38 (s), 5.18 (q), 5.27 (d), 5.52 (d), 6.87 (d), 7.16-7.35 (m), 7.37 (t), 7.55-7.70 (m), 7.95 (d), 7.98 (d), 8.32 (d) |
| S76 | 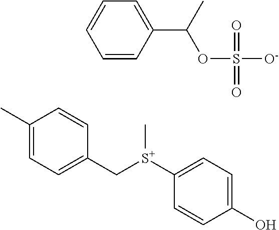 [SMILES: CC(OS(=O)(=O)[O-])c1ccccc1 ; Cc1ccc(C[S+](C)c2ccc(O)cc2)cc1] | DMSO-d6/1.40 (d), 2.25 (s), 3.21 (s), 4.77 (d), 4.92 (d), 5.17 (q), 6.96 (d), 7.04 (d), 7.14 (d), 7.17-7.34 (m), 7.70 (d), 10.77 (s) |
| S77 | 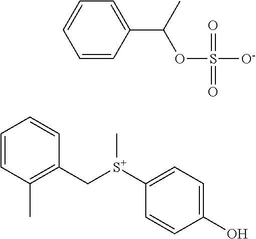 [SMILES: CC(OS(=O)(=O)[O-])c1ccccc1 ; Cc1ccccc1C[S+](C)c1ccc(O)cc1] | DMSO-d6/1.40 (d), 2.21 (s), 3.32 (s), 4.84 (d), 5.00 (d), 5.17 (q), 6.93 (d), 7.00 (d), 7.09 (t), 7.17-7.33 (m), 7.67 (d), 10.77 (s) |
| S78 | 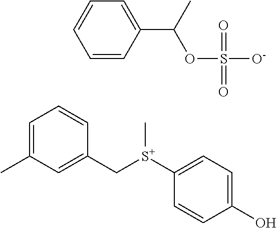 [SMILES: CC(OS(=O)(=O)[O-])c1ccccc1 ; Cc1cccc(C[S+](C)c2ccc(O)cc2)c1] | DMSO-d6/1.40 (d), 2.22 (s), 3.21 (s), 4.76 (d), 4.92 (d), 5.17 (q), 6.96 (d), 7.14-7.33 (m), 7.69 (d), 10.77 (s) |
| S79 | 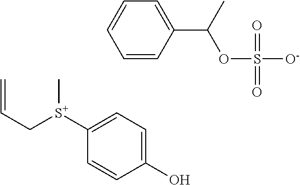 | DMSO-d6/1.40 (d), 3.20 (s), 4.24 (dd), 4.35 (dd), 5.17 (q), 5.33 (d), 5.42 (d), 7.02 (d), 7.17-7.33 (m), 7.81 (d), 10.78 (s) |
| S80 | 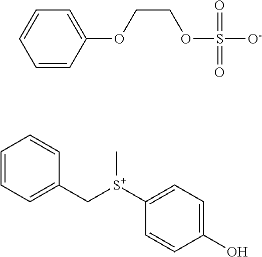 [SMILES: O=S(=O)([O-])OCCOc1ccccc1 ; C[S+](Cc1ccccc1)c1ccc(O)cc1] | DMSO-d6/3.23 (s), 3.95-4.12 (m), 4.80 (d), 4.97 (d), 6.86-6.99 (m), 7.16 (d), 7.25 (t), 7.29-7.40 (m), 7.68 (d) |
| S81 | 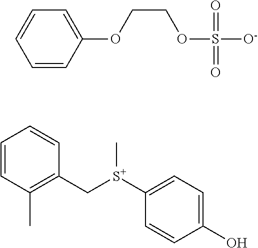 [SMILES: O=S(=O)([O-])OCCOc1ccccc1 ; Cc1ccccc1C[S+](C)c1ccc(O)cc1] | DMSO-d6/2.21 (s), 3.33 (s), 3.99 (t), 4.08 (t), 4.84 (d), 5.00 (d), 6.86- 6.96 (m), 7.00 (d), 7.08 (t), 7.16- 7.30 (m), 7.67 (d) |
| S82 | 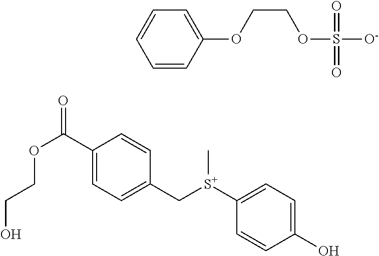 [SMILES: O=S(=O)([O-])OCCOc1ccccc1 ; C[S+](Cc1ccc(C(=O)OCCO)cc1)c1ccc(O)cc1] | DMSO-d6/3.27 (s), 3.66 (br s), 3.99 (t), 4.24 (t), 4.88 (d), 5.05 (d), 6.85-7.00 (m), 7.25 (t), 7.32 (d), 7.69 (d), 7.93 (d) |
| S83 | 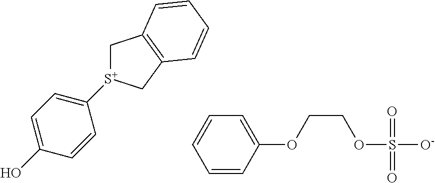 [SMILES: Oc1ccc([S+]2Cc3ccccc3C2)cc1 ; O=S(=O)([O-])OCCOc1ccccc1] | DMSO-d6/3.95-4.11 (m), 4.91 (d), 5.25 (d), 6.85-6.94 (m), 7.26 (t), 7.38-7.54 (m) |
| S84 | 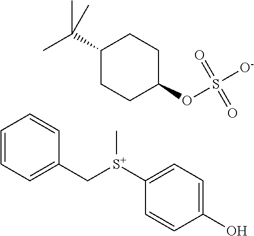 [SMILES: CC(C)(C)[C@H]1CC[C@H](OS(=O)(=O)[O-])CC1 ; C[S+](Cc1ccccc1)c1ccc(O)cc1] | DMSO-d6/0.81 (s), 0.86-1.19 (m), 1.69 (br d), 2.03 (br d), 3.24 (s), 3.77-3.92 (m), 4.82 (d), 4.98 (d), 6.95 (d), 7.18 (d), 7.30-7.42 (m), 7.69 (d) |
| S85 | 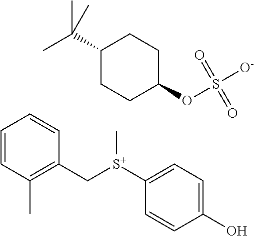 [SMILES: CC(C)(C)[C@H]1CC[C@H](OS(=O)(=O)[O-])CC1 ; Cc1ccccc1C[S+](C)c1ccc(O)cc1] | DMSO-d6/0.81 (s), 0.85-1.18 (m), 1.69 (br d), 2.03 (br d), 2.22 (s), 3.35 (s), 3.77-3.92 (m), 4.85 (d), 5.01 (d), 6.93 (d), 7.02 (d), 7.10 (t), 7.20 (d), 7.25 (t), 7.68 (d) |
| S86 | 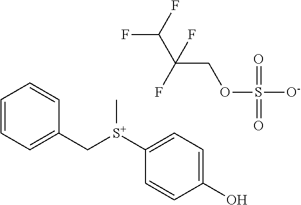 [SMILES: C[S+](Cc1ccccc1)c1ccc(O)cc1 ; O=S(=O)([O-])OCC(F)(F)C(F)F] | DMSO-d6/3.25 (s), 4.10 (tt), 4.82 (d), 4.99 (d), 6.47 (tt), 6.97 (d), 7.18 (d), 7.31-7.41 (m), 7.71 (d), 10.78 (s) |
| S87 | 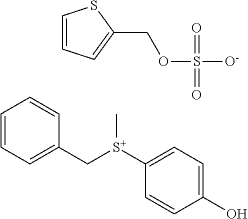 [SMILES: O=S(=O)([O-])OCc1cccs1 ; C[S+](Cc1ccccc1)c1ccc(O)cc1] | DMSO-d6/3.24 (s), 4.81 (d), 4.87 (s), 4.98 (d), 6.92-7.00 (m), 7.04 (d), 7.17 (d), 7.29-7.40 (m), 7.47 (d), 7.69 (d), 10.78 (s) |
| S88 | 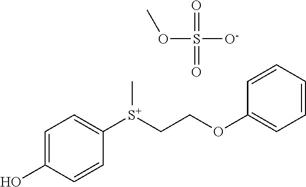 | CD3OD/3.32 (s), 3.68 (s), 3.93- 4.03 (m), 4.07-4.17 (m), 4.39-4.50 (m), 6.86 (d), 6.99 (t), 7.04 (d), 7.25 (t), 7.81 (d) |
| S89 | 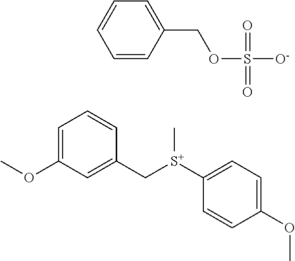 | DMSO-d6/3.25 (s), 3.65 (s), 3.84 (s), 4.74 (s), 4.82 (d), 4.96 (d), 6.72-6.77 (m), 6.93 (d), 7.17-7.36 (m), 7.85 (d) |
| S90 | 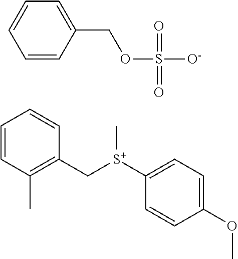 [SMILES: O=S(=O)([O-])OCc1ccccc1 ; COc1ccc([S+](C)Cc2ccccc2C)cc1] | DMSO-d6/2.22 (s), 3.37 (s), 3.82 (s), 4.73 (s), 4.90 (d), 5.03 (d), 7.01 (d), 7.09 (t), 7.13 (d), 7.18-7.36 (m), 7.82 |
| S91 | 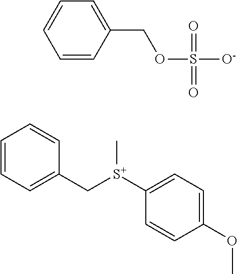 [SMILES: O=S(=O)([O-])OCc1ccccc1 ; COc1ccc([S+](C)Cc2ccccc2)cc1] | DMSO-d6/3.26 (s), 3.83 (s), 4.73 (s), 4.86 (d), 5.01 (d), 7.15-7.40 (m), 7.83 (d) |
| S92 | 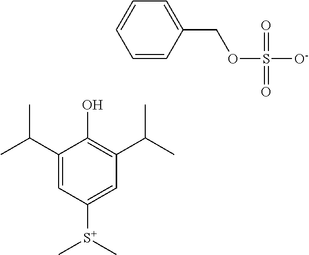 [SMILES: O=S(=O)([O-])OCc1ccccc1 ; CC(C)c1cc([S+](C)C)cc(C(C)C)c1O] | DMSO-d6/1.18 (d), 3.18 (s), 3.33 (m), 4.73 (s), 7.22-7.35 (m), 7.63 (s), 9.40 (br s) |
| S93 | 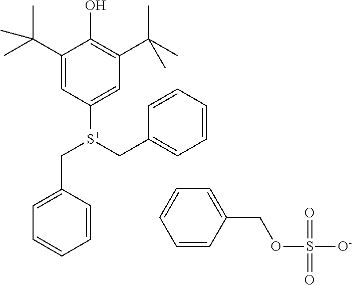 [SMILES: CC(C)(C)c1cc([S+](Cc2ccccc2)Cc2ccccc2)cc(C(C)(C)C)c1O ; O=S(=O)([O-])OCc1ccccc1] | DMSO-d6/1.29 (s), 4.76 (s), 5.08 (d), 5.19 (d), 7.22-7.41 (m), 8.21 (s) |
| S94 | 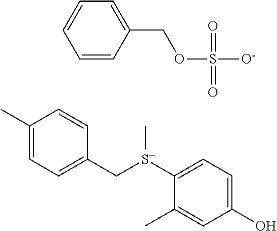 [SMILES: O=S(=O)([O-])OCc1ccccc1 ; Cc1ccc(C[S+](C)c2ccc(O)cc2C)cc1] | DMSO-d6/1.99 (s), 2.25 (s), 3.22 (s), 4.65 (d), 4.72 (s), 4.95 (d), 6.68 (d), 6.91 (dd), 7.02 (d), 7.13 (d), 7.20-7.35 (m), 7.90 (d) |
| S95 | 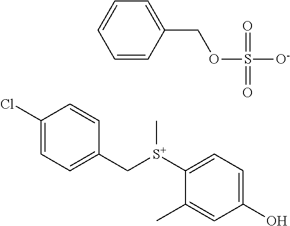 [SMILES: O=S(=O)([O-])OCc1ccccc1 ; Cc1cc(O)ccc1[S+](C)Cc1ccc(Cl)cc1] | DMSO-d6/2.05 (s), 3.25 (s), 4.72 (d), 4.74 (s), 4.99 (d), 6.71 (d), 6.93 (dd), 7.19 (d), 7.22-7.36 (m), 7.43 (d), 7.89 (d) |
| S96 | 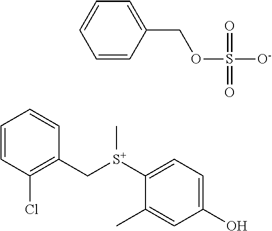 [SMILES: O=S(=O)([O-])OCc1ccccc1 ; Cc1cc(O)ccc1[S+](C)Cc1ccccc1Cl] | DMSO-d6/2.01 (s), 3.39 (s), 4.73 (s), 4.87 (d), 5.10 (d), 6.51 (s), 6.91 (d), 7.18-7.36 (m), 7.42 (t), 7.52 (d), 7.97 (d) |
| S97 | 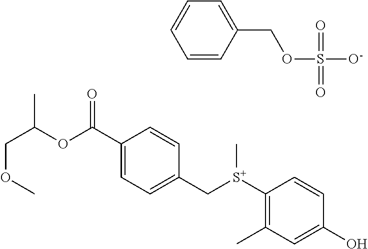 [SMILES: O=S(=O)([O-])OCc1ccccc1 ; COCC(C)OC(=O)c1ccc(C[S+](C)c2ccc(O)cc2C)cc1] | DMSO-d6/1.24 (d), 2.05 (s), 3.27 (s), 3.28 (s), 3.4-3.6 (m), 4.74 (s), 4.81 (d), 5.08 (d), 5.14-5.24 (m), 6.70 (s), 6.93 (d), 7.22-7.40 (m), 7.90 (d), 7.94 (d) |
| S98 | 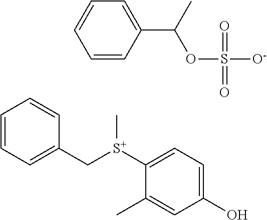 [SMILES: CC(OS(=O)(=O)[O-])c1ccccc1 ; Cc1cc(O)ccc1[S+](C)Cc1ccccc1] | DMSO-d6/1.41 (d), 1.97 (s), 3.26 (s), 4.69 (d), 5.01 (d), 5.18 (q), 6.68 (d), 6.93 (dd), 7.15 (d), 7.18- 7.42 (m), 7.93 (d) |
| S99 | 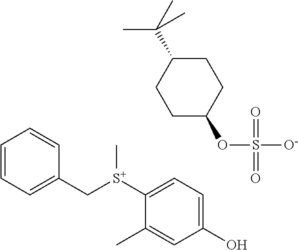 [SMILES: Cc1cc(O)ccc1[S+](C)Cc1ccccc1 ; CC(C)(C)[C@H]1CC[C@H](OS(=O)(=O)[O-])CC1] | DMSO-d6/0.81 (s), 0.86-1.18 (m), 1.69 (br d), 1.97 (s), 2.03 (br d), 3.79-3.89 (m), 4.70 (d), 5.02 (d), 6.68 (d), 6.93 (dd), 7.15 (d), 7.29- 7.46 (m), 7.93 (d) |
| S100 | 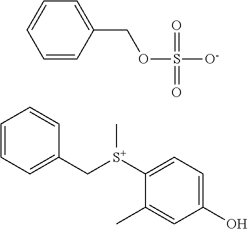 [SMILES: O=S(=O)([O-])OCc1ccccc1 ; Cc1cc(O)ccc1[S+](C)Cc1ccccc1] | DMSO-d6/1.94 (s), 3.23 (s), 4.66 (d), 4.71 (s), 4.98 (d), 6.51 (s), 6.90 (d), 7.12 (d), 7.18-7.41 (m), 7.90 (d), 10.6 (br s) |
| S101 | 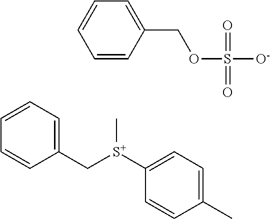 [SMILES: O=S(=O)([O-])OCc1ccccc1 ; Cc1ccc([S+](C)Cc2ccccc2)cc1] | DMSO-d6/2.38 (s), 3.27 (s), 4.73 (s), 4.88 (d), 5.03 (d), 7.18 (d), 7.22-7.40 (m), 7.46 (d), 7.77 (d) |
| S102 | 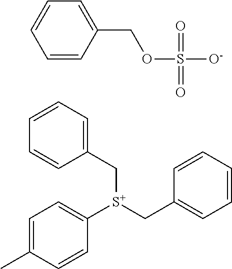 [SMILES: O=S(=O)([O-])OCc1ccccc1 ; Cc1ccc([S+](Cc2ccccc2)Cc2ccccc2)cc1] | DMSO-d6/2.35 (s), 4.73 (s), 5.11 (d), 5.22 (d), 7.21-7.36 (m), 7.40 (d), 7.76 (d) |
| S103 | 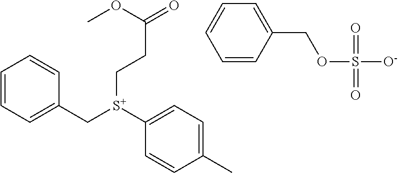 [SMILES: COC(=O)CC[S+](Cc1ccccc1)c1ccc(C)cc1 ; O=S(=O)([O-])OCc1ccccc1] | DMSO-d6/2.39 (s), 2.68-2.85 (m), 3.56 (s), 3.96 (m), 4.75 (s), 5.07 (d), 5.24 (d), 7.21-7.39 (m), 7.49 (d), 7.85 (d) |
| S104 | 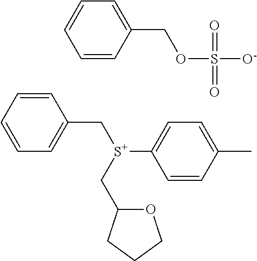 [SMILES: O=S(=O)([O-])OCc1ccccc1 ; Cc1ccc([S+](Cc2ccccc2)CC2CCCO2)cc1] | DMSO-d6/1.63-2.11 (m), 2.39 (s), 2.40 (s), 3.55-3.66 (m), 3.72-4.00 (m), 4.14 (dd), 4.16 (dd), 4.21-4.27 (m), 5.00 (d), 5.01 (d), 5.14 (d), 5.17 (d), 7.18-7.39 (m), 7.46 (d), 7.48 (d), 7.81-7.85 (d x2) *Mixture of stereoisomers |
| S105 | 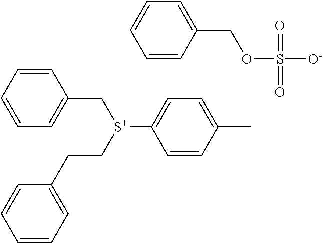 [SMILES: Cc1ccc([S+](CCc2ccccc2)Cc2ccccc2)cc1 ; O=S(=O)([O-])OCc1ccccc1] | DMSO-d6/2.39 (s), 2.76-3.00 (m), 4.02-4.16 (m), 4.74 (s), 5.02 (d), 5.17 (d), 7.16 (d), 7.19-7.38 (m), 7.48 (d), 7.82 (d) |
| S106 | 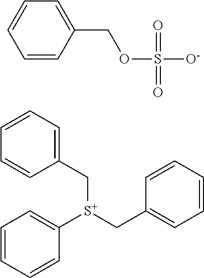 [SMILES: O=S(=O)([O-])OCc1ccccc1 ; c1ccc(C[S+](Cc2ccccc2)c2ccccc2)cc1] | Acetone-d6/5.04 (s), 5.35 (d), 5.57 (d), 7.21-7.38 (m), 7.43 (d), 7.62 (t), 7.77 (t), 8.03 (d) |
| S107 | 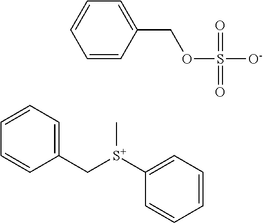 | DMSO-d6/3.30 (s), 4.75 (s), 4.91 (d), 5.07 (d), 7.16 (d), 7.21-7.39 (m), 7.64 (t), 7.75 (t), 7.88 (d) |
| S108 | 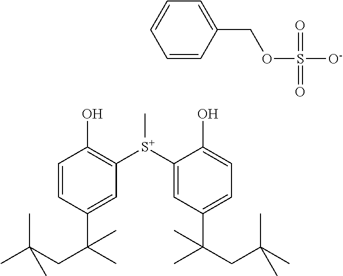 [SMILES: O=S(=O)([O-])OCc1ccccc1 ; C[S+](c1cc(C(C)(C)CC(C)(C)C)ccc1O)c1cc(C(C)(C)CC(C)(C)C)ccc1O] | Acetone-d6/0.71 (s), 1.33 (s), 1.71 (d), 1.76 (d), 3.74 (s), 4.97 (s), 7.25 (t), 7.28-7.35 (m), 7.40 (d), 7.53 (d), 7.67 (dd) |
| S109 | 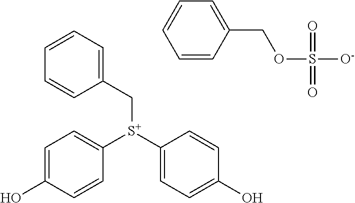 [SMILES: Oc1ccc([S+](Cc2ccccc2)c2ccc(O)cc2)cc1 ; O=S(=O)([O-])OCc1ccccc1] | CD3OD/5.00 (s), 5.31 (s), 7.02 (d), 7.24-7.43 (m), 7.73 (d) |
| S110 | 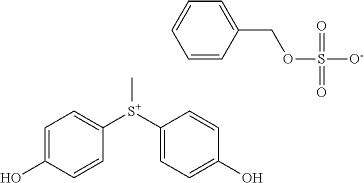 [SMILES: C[S+](c1ccc(O)cc1)c1ccc(O)cc1 ; O=S(=O)([O-])OCc1ccccc1] | CD3OD/3.54 (s), 5.00 (s), 7.04 (d), 7.24-7.42 (m), 7.75 (d) |
| S111 | 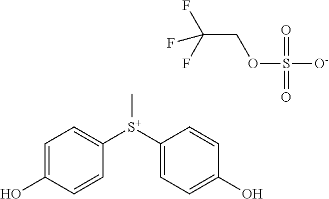 [SMILES: C[S+](c1ccc(O)cc1)c1ccc(O)cc1 ; O=S(=O)([O-])OCC(F)(F)F] | DMSO-d6/3.62 (s), 4.17 (q), 7.00 (d), 7.81 (d) |
| S112 | 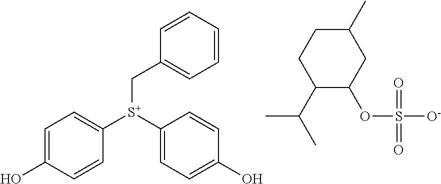 [SMILES: Oc1ccc([S+](Cc2ccccc2)c2ccc(O)cc2)cc1 ; CC1CCC(C(C)C)C(OS(=O)(=O)[O-])C1] | DMSO-d6/0.67-1.10 (m), 1.22- 1.36 (m), 1.54 (br t), 2.06-2.17 (m), 2.24 (br d), 3.77 (dt), 5.48 (s), 6.98 (d), 7.33 (br s), 7.84 (d), 10.93 (br s) |
| S113 | 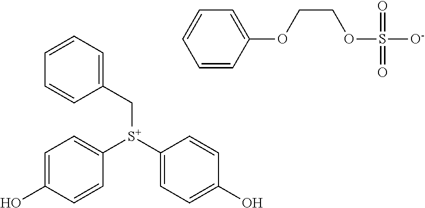 [SMILES: Oc1ccc([S+](Cc2ccccc2)c2ccc(O)cc2)cc1 ; O=S(=O)([O-])OCCOc1ccccc1] | Acetone-d6/4.17-4.26 (m), 5.56 (s), 6.89 (t), 6.94 (d), 7.17 (d), 7.25 (t), 7.33-7.49 (m), 7.90 (d) |
| S114 | 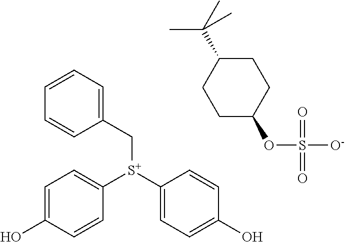 [SMILES: Oc1ccc([S+](Cc2ccccc2)c2ccc(O)cc2)cc1 ; CC(C)(C)[C@H]1CC[C@H](OS(=O)(=O)[O-])CC1] | CD3OD/0.86 (s), 0.94-1.40 (m), 1.82 (br d), 2.23 (br d), 3.99-4.24 (m), 5.31 (s), 7.02 (d), 7.26-7.42 (m), 7.73 (d) |
| S115 | 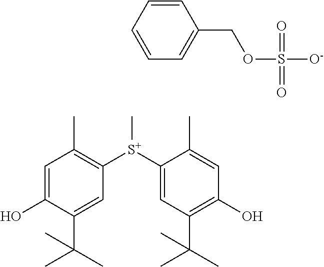 [SMILES: O=S(=O)([O-])OCc1ccccc1 ; Cc1cc(O)c(C(C)(C)C)cc1[S+](C)c1cc(C(C)(C)C)c(O)cc1C] | DMSO-d6/1.30 (s), 2.39 (s), 3.60 (s), 4.73 (s), 6.81 (s), 7.21-7.34 (m), 7.40 (s) |
| S116 | 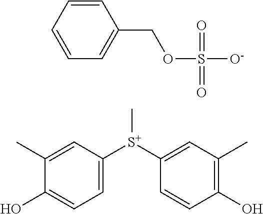 [SMILES: O=S(=O)([O-])OCc1ccccc1 ; Cc1cc([S+](C)c2ccc(O)c(C)c2)ccc1O] | DMSO-d6/2.14 (s), 3.58 (s,), 4.73 (s), 6.97 (d), 7.20-7.34 (m), 7.62 (dd), 7.73 (d) |
| S117 | 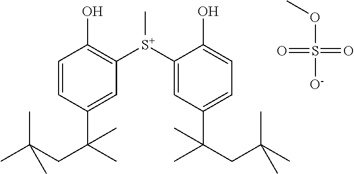 | DMSO-d6/0.63 (s), 1.24 (s), 1.59 (d), 1.66 (d), 3.34 (s), 3.55 (s), 7.01 (d), 7.30 (s), 7.59 (d) |
| S118 | 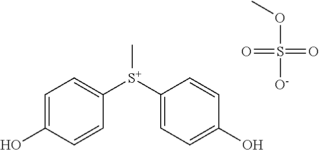 | CD3OD/3.56 (s), 3.68 (s), 7.05 (d), 7.76 (d) |
| S119 | 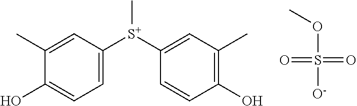 | DMSO-d6/2.15 (s), 3.35 (s,), 3.59 (s), 6.98 (d), 7.63 (dd), 7.74 (d), 10.66 (s) |
| S120 | 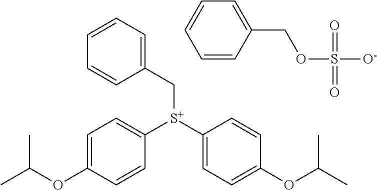 [SMILES: CC(C)Oc1ccc([S+](Cc2ccccc2)c2ccc(OC(C)C)cc2)cc1 ; O=S(=O)([O-])OCc1ccccc1] | CD3OD/1.33 (d), 4.72 (m), 5.00 (s), 5.36 (s), 7.15 (d), 7.26-7.40 (m), 7.83 (d) |
| S121 | 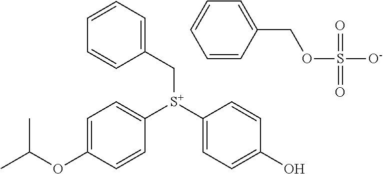 [SMILES: CC(C)Oc1ccc([S+](Cc2ccccc2)c2ccc(O)cc2)cc1 ; O=S(=O)([O-])OCc1ccccc1] | CD3OD/1.33 (d), 4.72 (m), 5.00 (s), 5.34 (s), 7.03 (d), 7.16 (d), 7.24-7.40 (m), 7.75 (d), 7.80 (d) |
| S122 | 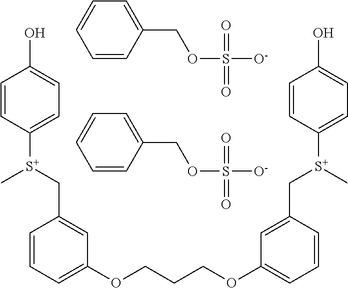 [SMILES: C[S+](Cc1cccc(OCCCOc2cccc(C[S+](C)c3ccc(O)cc3)c2)c1)c1ccc(O)cc1 ; O=S(=O)([O-])OCc1ccccc1 ; O=S(=O)([O-])OCc1ccccc1] | DMSO-d6/2.03-2.13 (m), 3.22 (s), 3.92-4.08 (m), 4.74 (s), 4.77 (d), 4.92 (d), 6.74 (d), 6.80 (br s), 6.91- 7.00 (m), 7.21-7.34 (m), 7.71 (d), 10.8 (br s) |
| S123 | 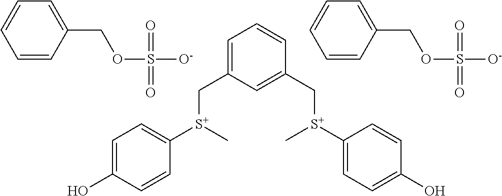 [SMILES: O=S(=O)([O-])OCc1ccccc1 ; C[S+](Cc1cccc(C[S+](C)c2ccc(O)cc2)c1)c1ccc(O)cc1 ; O=S(=O)([O-])OCc1ccccc1] | DMSO-d6/3.16 (s), 4.72 (s), 4.76 (d), 4.93 (d), 6.95 (d), 7.02-7.35 (m), 7.62 (d) |
| S124 | 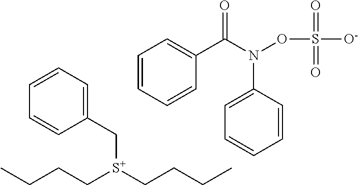 [SMILES: CCCC[S+](CCCC)Cc1ccccc1 ; O=C(c1ccccc1)N(OS(=O)(=O)[O-])c1ccccc1] | DMSO-d6/0.83 (t), 1.25-1.38 (m), 1.46-1.68 (m), 3.17-3.30 (m), 4.73 (s), 7.16 (t), 7.27-7.53 (m), 7.55 (d), 7.66 (d) |
| S125 | 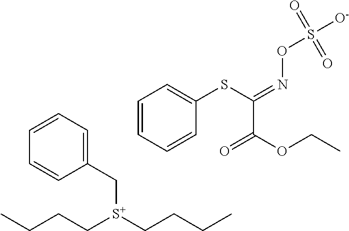 [SMILES: CCCC[S+](CCCC)Cc1ccccc1 ; CCOC(=O)/C(=N/OS(=O)(=O)[O-])Sc1ccccc1] | DMSO-d6/0.83 (t), 0.86 (t), 1.26- 1.38 (m), 1.46-1.69 (m), 3.18-3.31 (m), 3.78 (q), 4.74 (s), 7.37-7.54 (m) |
| S126 | 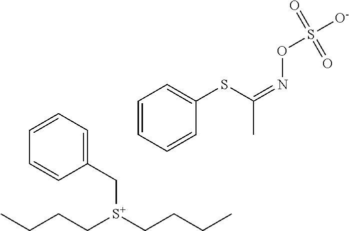 [SMILES: CCCC[S+](CCCC)Cc1ccccc1 ; C/C(=N/OS(=O)(=O)[O-])Sc1ccccc1] | DMSO-d6/0.83 (t), 1.25-1.38 (m), 1.45-1.69 (m), 1.68 (s), 3.18-3.32 (m), 4.74 (s), 7.41-7.53 (m), 7.58 (d) |
| S127 | 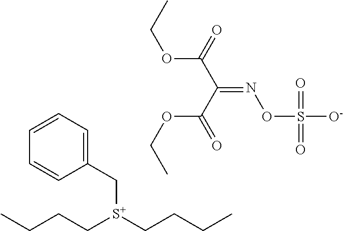 [SMILES: CCCC[S+](CCCC)Cc1ccccc1 ; CCOC(=O)C(=NOS(=O)(=O)[O-])C(=O)OCC] | DMSO-d6/0.83 (t), 1.18-1.38 (m), 1.46-1.69 (m), 3.17-3.31 (m), 4.28 (q), 4.74 (s), 7.43-7.55 (m) |
| S128 | 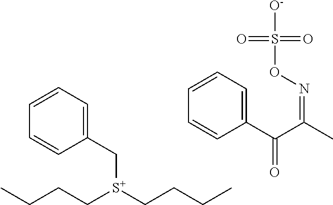 [SMILES: CCCC[S+](CCCC)Cc1ccccc1 ; C/C(=N/OS(=O)(=O)[O-])C(=O)c1ccccc1] | DMSO-d6/0.83 (t), 1.26-1.38 (m), 1.45-1.68 (m), 2.02 (s), 3.17-3.31 (m), 4.73 (s), 7.42-7.54 (m), 7.63 (t), 7.97 (d) |
| S129 | 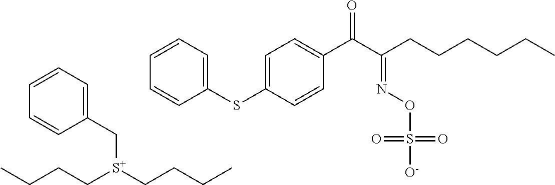 [SMILES: CCCC[S+](CCCC)Cc1ccccc1 ; CCCCCC/C(=N\OS(=O)(=O)[O-])C(=O)c1ccc(Sc2ccccc2)cc1] | DMSO-d6/0.76-0.88 (m), 1.13- 1.69 (m), 2.52 (t), 3.17-3.31 (m), 4.74 (s), 7.19 (d), 7.40-7.59 (m), 7.89 (d) |
| S130 | 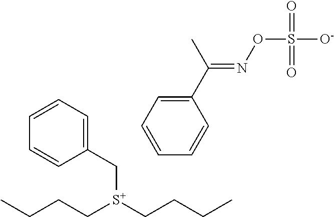 [SMILES: CCCC[S+](CCCC)Cc1ccccc1 ; C/C(=N\OS(=O)(=O)[O-])c1ccccc1] | DMSO-d6/0.83 (t), 1.25-1.37 (m), 1.45-1.68 (m), 2.15 (s), 3.18-3.32 (m), 4.74 (s), 7.36-7.42 (m), 7.42- 7.53 (m), 7.62-7.69 (m) |
| S131 | 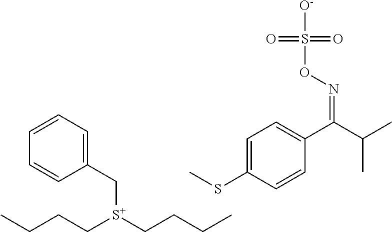 [SMILES: CCCC[S+](CCCC)Cc1ccccc1 ; CSc1ccc(/C(=N\OS(=O)(=O)[O-])C(C)C)cc1] | DMSO-d6/0.83 (t), 1.01 (d), 1.25- 1.38 (m), 1.45-1.68 (m), 2.47 (s), 2.76-2.89 (m), 3.18-3.32 (m), 4.74 (s), 7.15 (d), 7.26 (d), 7.42-7.54 (m) |
| S132 | 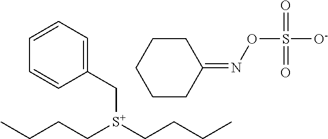 [SMILES: CCCC[S+](CCCC)Cc1ccccc1 ; O=S(=O)([O-])ON=C1CCCCC1] | DMSO-d6/0.83 (t), 1.26-1.38 (m), 1.44-1.69 (m), 2.14 (t), 2.31 (t), 3.18-3.32 (m), 4.74 (s), 7.42-7.55 (m) |
| S133 | 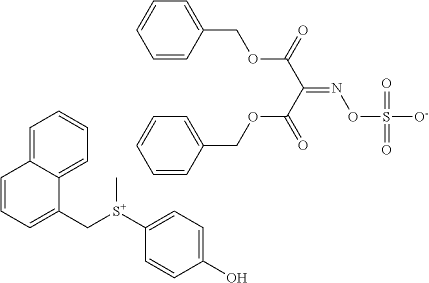 [SMILES: C[S+](Cc1cccc2ccccc12)c1ccc(O)cc1 ; O=C(OCc1ccccc1)C(=NOS(=O)(=O)[O-])C(=O)OCc1ccccc1] | DMSO-d6/3.38 (s), 5.27 (d), 5.31 (s), 5.34 (s), 5.53 (d), 6.68 (d), 7.22 (d), 7.28-7.43 (m), 7.56-7.69 (m), 7.95 (d), 7.98 (d), 8.32 (d), 10.74 (s) |
| S134 | 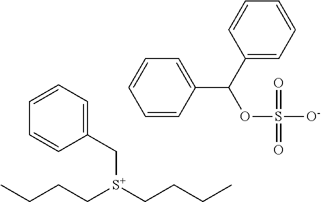 [SMILES: CCCC[S+](CCCC)Cc1ccccc1 ; O=S(=O)([O-])OC(c1ccccc1)c1ccccc1] | DMSO-d6/0.83 (t), 1.25-1.38 (m), 1.45-1.68 (m), 3.17-3.31 (m), 4.74 (s), 6.14 (s), 7.15-7.21 (m), 7.23- 7.32 (m), 7.42-7.53 (m) |
| S135 | 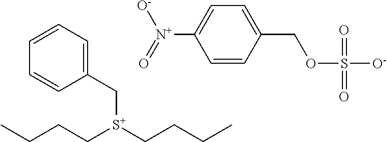 [SMILES: CCCC[S+](CCCC)Cc1ccccc1 ; O=[N+]([O-])c1ccc(COS(=O)(=O)[O-])cc1] | DMSO-d6/0.83 (t), 1.25-1.39 (m), 1.46-1.69 (m), 3.17-3.33 (m), 4.74 (s), 4.90 (s), 7.42-7.54 (m), 7.60 (d), 8.18 (d) |
| S136 | 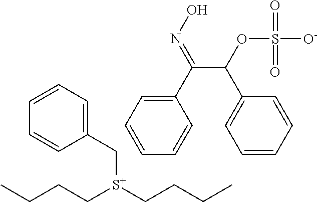 [SMILES: CCCC[S+](CCCC)Cc1ccccc1 ; O=S(=O)([O-])OC(/C(=N\O)c1ccccc1)c1ccccc1] | DMSO-d6/0.83 (t), 1.25-1.39 (m), 1.46-1.69 (m), 3.17-3.33 (m), 4.74 (s), 5.96 (s), 7.07-7.30 (m), 7.41- 7.54 (m), 10.87 (br s) |
| S137 | 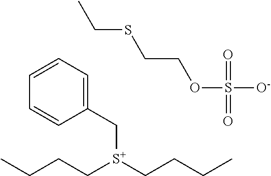 | DMSO-d6/0.84 (t), 1.15 (t), 1.25- 1.39 (m), 1.46-1.69 (m), 2.50 (q), 2.65 (t), 3.17-3.33 (m), 3.79 (t), 4.74 (s), 7.42-7.54 (m) |
| S138 | 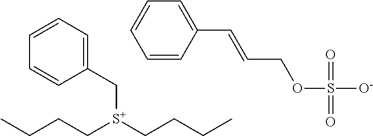 [SMILES: CCCC[S+](CCCC)Cc1ccccc1 ; O=S(=O)([O-])OC/C=C/c1ccccc1] | DMSO-d6/0.83 (t), 1.15 (t), 1.25- 1.39 (m), 1.46-1.69 (m), 3.17-3.33 (m), 4.38 (d), 6.33 (dt), 6.56 (d), 7.22 (t), 7.31 (t), 7.41 (d), 7.43-7.55 (m) |
| S139 | 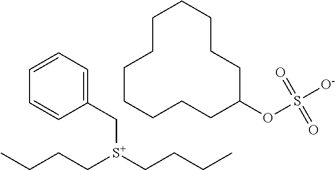 [SMILES: CCCC[S+](CCCC)Cc1ccccc1 ; O=S(=O)([O-])OC1CCCCCCCCCCC1] | DMSO-d6/0.83 (t), 1.14-1.43 (m), 1.43-1.69 (m), 3.17-3.33 (m), 4.13- 4.22 (m), 4.74 (s), 7.42-7.55 (m) |
| S140 | 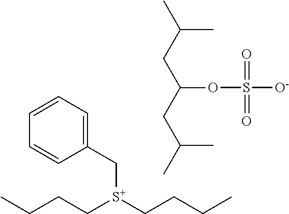 [SMILES: CCCC[S+](CCCC)Cc1ccccc1 ; CC(C)CC(CC(C)C)OS(=O)(=O)[O-]] | DMSO-d6/0.76-0.88 (m), 1.10- 1.20 (m), 1.26-1.38 (m), 1.39-1.75 (m), 3.17-3.33 (m), 4.09-4.18 (m), 4.74 (s), 7.42-7.55 (m) |
| S141 | 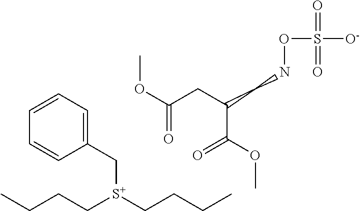 | DMSO-d6/0.83 (t), 1.26-1.38 (m), 1.45-1.69 (m), 3.17-3.32 (m), 3.55 (s), 3.59 (s), 3.76 (s), 4.74 (s), 7.41-7.55 (m) |
| S142 | 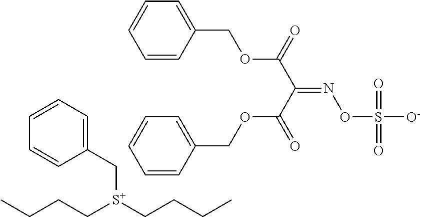 [SMILES: CCCC[S+](CCCC)Cc1ccccc1 ; O=C(OCc1ccccc1)C(=NOS(=O)(=O)[O-])C(=O)OCc1ccccc1] | DMSO-d6/0.83 (t), 1.25-1.37 (m), 1.45-1.68 (m), 3.17-3.31 (m), 4.73 (s), 5.30 (s), 5.32 (s), 7.29-7.40 (m), 7.43-7.53 (m) |
| S143 | 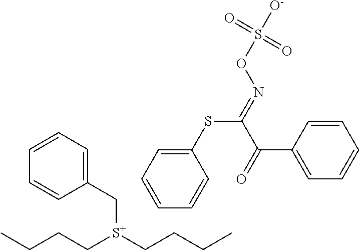 [SMILES: CCCC[S+](CCCC)Cc1ccccc1 ; O=C(/C(=N/OS(=O)(=O)[O-])Sc1ccccc1)c1ccccc1] | DMSO-d6/0.83 (t), 1.25-1.37 (m), 1.45-1.68 (m), 3.17-3.31 (m), 4.73 (s), 7.19 (t), 7.27 (t), 7.34 (d), 7.43- 7.53 (m), 7.65 (t), 7.76 (d) |
| S144 | 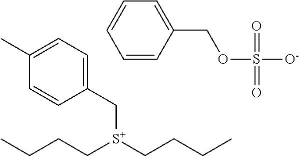 [SMILES: CCCC[S+](CCCC)Cc1ccc(C)cc1 ; O=S(=O)([O-])OCc1ccccc1] | DMSO-d6/0.84 (t), 1.25-1.38 (m), 1.47-1.70 (m), 2.31 (s), 3.13-3.28 (m), 4.69 (s), 4.73 (s), 7.21-7.35 (m), 7.38 (d) |
| S145 | 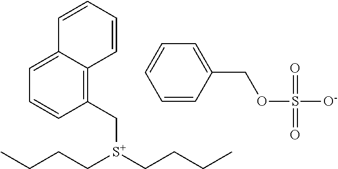 [SMILES: CCCC[S+](CCCC)Cc1cccc2ccccc12 ; O=S(=O)([O-])OCc1ccccc1] | DMSO-d6/0.75 (t), 1.16-1.31 (m), 1.31-1.61 (m), 3.28-3.44 (m), 4.74 (s), 5.24 (s), 7.20-7.35 (m), 7.57 (dd), 7.63 (t), 7.70 (t), 7.79 (d), 8.04 (d), 8.07 (d), 8.30 (d) |
| S146 | 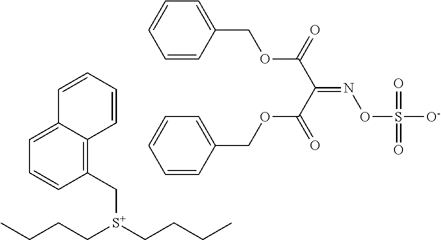 [SMILES: CCCC[S+](CCCC)Cc1cccc2ccccc12 ; O=C(OCc1ccccc1)C(=NOS(=O)(=O)[O-])C(=O)OCc1ccccc1] | DMSO-d6/0.77 (t), 1.19-1.32 (m), 1.32-1.63 (m), 3.28-3.44 (m), 5.24 (s), 5.31 (s), 5.34 (s), 7.38-7.42 (m), 7.59 (dd), 7.65 (t), 7.72 (t), 7.79 (d), 8.05 (d), 8.08 (d), 8.31 (d) |
| S147 | 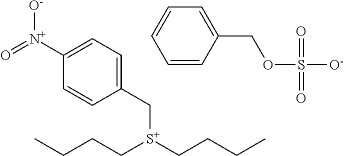 [SMILES: CCCC[S+](CCCC)Cc1ccc([N+](=O)[O-])cc1 ; O=S(=O)([O-])OCc1ccccc1] | DMSO-d6/0.85 (t), 1.27-1.39 (m), 1.50-1.72 (m), 3.22-3.39 (m), 4.74 (s), 4.88 (s), 7.20-7.34 (m), 7.80 (d), 8.32 (d) |
| S148 | 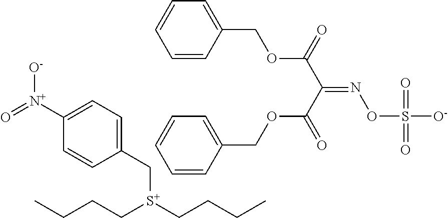 [SMILES: CCCC[S+](CCCC)Cc1ccc([N+](=O)[O-])cc1 ; O=C(OCc1ccccc1)C(=NOS(=O)(=O)[O-])C(=O)OCc1ccccc1] | DMSO-d6/0.85 (t), 1.27-1.39 (m), 1.50-1.72 (m), 3.21-3.28 (m), 4.87 (s), 5.30 (s), 5.32 (s), 7.45-7.56 (m), 7.80 (d), 8.32 (d) |
| S149 | 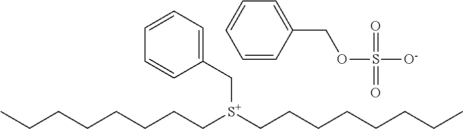 [SMILES: CCCCCCCC[S+](CCCCCCCC)Cc1ccccc1 ; O=S(=O)([O-])OCc1ccccc1] | DMSO-d6/0.84 (t), 1.12-1.34 (m), 1.47-1.69 (m), 3.18-3.32 (m), 4.73 (s), 7.20-7.34 (m), 7.37-7.53 (m) |
| S150 | 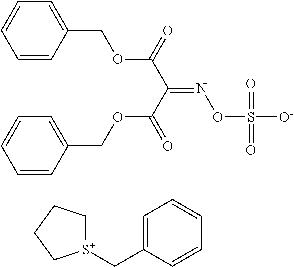 [SMILES: O=C(OCc1ccccc1)C(=NOS(=O)(=O)[O-])C(=O)OCc1ccccc1 ; c1ccc(C[S+]2CCCC2)cc1] | DMSO-d6/2.06-2.29 (m), 3.30- 3.51 (m), 4.52 (s), 5.31 (s), 5.34 (s), 7.29-7.42 (m), 7.43-7.58 (m) |
| S151 | 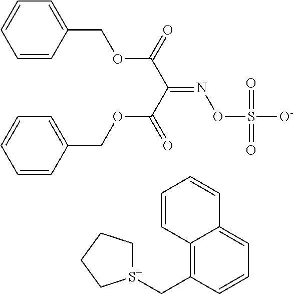 [SMILES: O=C(OCc1ccccc1)C(=NOS(=O)(=O)[O-])C(=O)OCc1ccccc1 ; c1ccc2c(C[S+]3CCCC3)cccc2c1] | DMSO-d6/2.11-2.47 (m), 3.31- 3.51 (m), 4.98 (s), 5.31 (s), 5.33 (s), 7.29-7.42 (m), 7.57 (dd), 7.65 (t), 7.71 (t), 7.78 (d), 8.05 (d), 8.07 (d), 8.43 (d) |
| S152 | 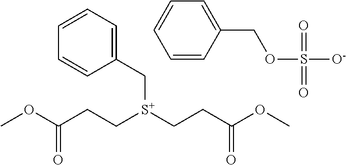 | DMSO-d6/2.88 (t), 3.38-3.62 (m), 3.61 (s), 4.73 (s), 4.82 (s), 7.21- 7.35 (m), 7.44-7.54 (m) |
| S153 | 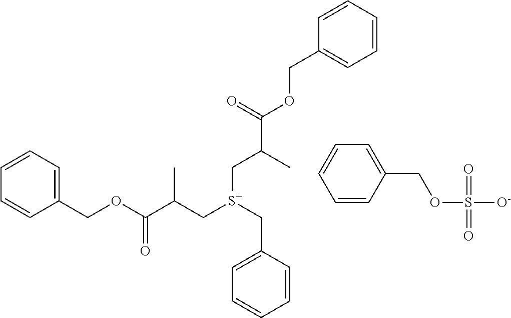 [SMILES: CC(C[S+](Cc1ccccc1)CC(C)C(=O)OCc1ccccc1)C(=O)OCc1ccccc1 ; O=S(=O)([O-])OCc1ccccc1] | DMSO-d6/1.11-1.20 (m), 2.84- 3.80 (m), 4.78-4.94 (m), 5.04-5.16 (m), 7.21-7.40 (m), 7.40-7.50 (m) |
| S154 | 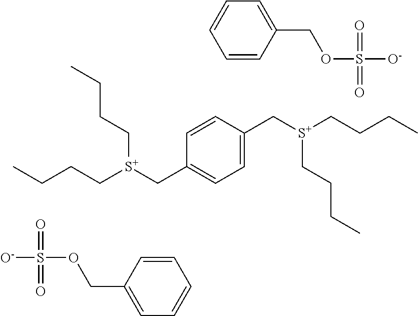 [SMILES: O=S(=O)([O-])OCc1ccccc1 ; CCCC[S+](CCCC)Cc1ccc(C[S+](CCCC)CCCC)cc1 ; O=S(=O)([O-])OCc1ccccc1] | DMSO-d6/0.84 (t), 1.25-1.38 (m), 1.47-1.70 (m), 3.19-3.35 (m), 4.74 (s), 4.78 (s), 7.21-7.35 (m), 7.62 (s) |
| S155 | 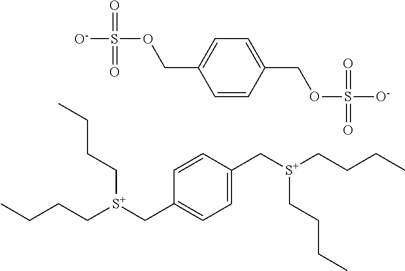 [SMILES: CCCC[S+](CCCC)Cc1ccc(C[S+](CCCC)CCCC)cc1 ; O=S(=O)([O-])OCc1ccc(COS(=O)(=O)[O-])cc1] | DMSO-d6/0.84 (t), 1.25-1.38 (m), 1.47-1.70 (m), 3.19-3.35 (m), 4.73 (s), 4.7 (s), 7.26 (s), 7.59 (s) |
| C1** | 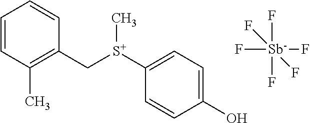 | |

**San-Aid SI-80 (registry number: 141651-31-2), CA Index Name: Sulfonium, (4-hydroxyphenyl)methyl[(2-methylphenyl)methyl]-, (OC-6-11)-hexafluoroantimonate(1-) (1:1), available from Sanshin Chemical Industry Co., Ltd.,

### USE EXAMPLES

### Thermal Curing Tests of Epoxy Formulation

### Example 1

### Epoxy Formulation

100 parts by weight SU-8 (solid content: 30%, product of Micro Chem, cyclohexanone)
0.15 parts by weight Sulfonium sulfate of the formulae Ia or Ib

### Thermal Curing Tests of Epoxy Formulation

The sulfonium sulfate of synthetic example 1 was added to a solution of SU-8 and mixed. The mixture was applied to a silicon wafer using a spin coater (1H-DX2, MI-KASA). The solvent was removed by heating at 80° C. for 2 min in a convection oven. The thickness of the dry film was approximately 1.5 μm. The coating was further baked at 230° C. for 30 min and for 60 min. The conversion of epoxy group in baking was determined by measuring IR absorption at 910 cm⁻¹, with a FT-IR spectrometer (FT-720, HORIBA) before and after baking. The higher the conversion, the more active is the tested sulfonium sulfate. The results of the tests were given in table 2.

Examples 2 to 132 were carried out in the same manner using a sulfonium sulfate of table 1

### Comparative Example 1

Comparative Example 1 was carried out in the same manner as that of Example 1 except that C1 of table 1 was used as initiator.

TABLE 2

| Compound of synthetic | Epoxy conversion (%) | |
|---|---|---|
| example | 230° C. for 30 min | 230° C. for 60 min |
| S1 | 84.1 | 100 |
| S2 | 89.1 | 100 |
| S3 | 82.6 | 100 |
| S4 | 96.3 | 100 |
| S5 | 88.3 | 100 |
| S6 | 83.0 | 100 |
| S7 | 78.9 | 100 |
| S8 | 90.5 | 100 |
| S9 | 82.9 | 100 |
| S10 | 81.2 | 100 |
| S11 | 78.7 | 100 |
| S20 | 72.3 | 100 |
| S21 | 98.7 | 100 |
| S22 | 97.4 | 100 |
| S23 | 93.1 | 100 |
| S24 | 80.9 | 100 |
| S25 | 87.7 | 100 |
| S26 | 92.5 | 100 |
| S27 | 100 | 100 |
| S28 | 93.1 | 100 |
| S29 | 91.5 | 100 |
| S30 | 99.5 | 100 |
| S31 | 96.1 | 100 |
| S32 | 88.4 | 100 |
| S33 | 90.1 | 100 |
| S34 | 93.6 | 100 |
| S35 | 91.8 | 100 |
| S36 | 99.4 | 100 |
| S37 | 96.3 | 100 |
| S38 | 90.0 | 100 |
| S39 | 94.5 | 100 |
| S40 | 84.0 | 100 |
| S41 | 95.4 | 100 |
| S42 | 92.9 | 100 |
| S43 | 90.6 | 100 |
| S44 | 82.2 | 100 |
| S45 | 91.7 | 100 |
| S46 | 97.7 | 100 |
| S47 | 89.5 | 100 |
| S48 | 85.7 | 100 |
| S49 | 78.3 | 99.8 |
| S50 | 78.5 | 100 |
| S51 | 92.0 | 100 |
| S52 | 89.0 | 100 |
| S53 | 76.8 | 100 |
| S54 | 89.2 | 100 |
| S55 | 93.5 | 100 |
| S56 | 69.1 | 99.6 |
| S57 | 97.7 | 100 |
| S58 | 88.3 | 100 |
| S59 | 85.8 | 100 |
| S60 | 86.9 | 100 |
| S61 | 94.8 | 100 |
| S62 | 88.8 | 100 |
| S63 | 78.5 | 100 |
| S64 | 83.5 | 100 |
| S65 | 70.1 | 100 |
| S66 | 98.3 | 100 |
| S67 | 70.7 | 95.4 |
| S68 | 97.7 | 100 |
| S69 | 75.6 | 99.4 |
| S70 | 97.2 | 100 |
| S71 | 84.6 | 100 |
| S72 | 99.3 | 100 |
| S73 | 97.6 | 100 |
| S74 | 93.8 | 100 |
| S75 | 90.1 | 100 |
| S76 | 99.6 | 100 |
| S77 | 98.3 | 100 |
| S78 | 100 | 100 |
| S79 | 98.3 | 100 |
| S80 | 97.8 | 100 |
| S81 | 98.1 | 100 |
| S82 | 88.5 | 100 |
| S83 | 95.0 | 100 |
| S84 | 79.6 | 99 |
| S85 | 90.3 | 100 |
| S86 | 77.5 | 100 |
| S87 | 91.2 | 100 |
| S88 | 59.6 | 89.5 |
| S89 | 98.7 | 100 |
| S90 | 97.0 | 100 |
| S91 | 96.4 | 100 |
| S92 | 73.8 | 98.6 |
| S93 | 71.2 | 100 |
| S94 | 99.3 | 100 |
| S95 | 94.4 | 100 |
| S96 | 94.6 | 100 |
| S97 | 93.1 | 100 |
| S98 | 99.2 | 100 |
| S99 | 73.5 | 98.5 |
| S100 | 48.8 | 100 |
| S101 | 91.5 | 100 |
| S102 | 81.7 | 100 |
| S103 | 74.8 | 100 |
| S104 | 77.2 | 100 |
| S105 | 72.1 | 100 |
| S106 | 88.8 | 100 |
| S107 | 91.9 | 100 |
| S108 | 70.2 | 96.0 |
| S109 | 86.1 | 100 |
| S110 | 71.0 | 98.2 |
| S111 | 83.8 | 99.2 |
| S112 | 84.0 | 100 |
| S113 | 92.0 | 100 |
| S114 | 90.8 | 100 |
| S115 | 65.3 | 91.1 |
| S116 | 73.8 | 96.9 |
| S117 | 74.2 | 98.4 |
| S118 | 72.0 | 100 |
| S119 | 68.6 | 93.3 |
| S120 | 66.8 | 100 |
| S121 | 71.9 | 100 |
| S122 | 72.0 | 100 |
| S123 | 100 | 100 |
| S124 | 55.5 | 93.3 |
| S125 | 62.4 | 95.5 |
| S126 | 66.6 | 100 |
| S127 | 62.9 | 97.9 |
| S128 | 66.7 | 97.0 |
| S129 | 57.9 | 92.2 |
| S130 | 68.1 | 99.0 |
| S131 | 68.2 | 99.7 |
| S132 | 68.7 | 99.8 |
| S133 | 62.4 | 95.3 |
| S134 | 69.1 | 100 |
| S135 | 63.6 | 97.3 |
| S136 | 61.9 | 96.2 |
| S137 | 61.7 | 95.7 |
| S138 | 63.9 | 99 |
| S139 | 70.5 | 100 |
| S140 | 62 | 97.6 |
| S141 | 63.2 | 96.8 |
| S142 | 62.9 | 93.1 |
| S143 | 64.3 | 100 |
| S144 | 77.7 | 100 |
| S145 | 61.3 | 97.3 |
| S146 | 63.7 | 97.9 |
| S147 | 63.5 | 96.8 |
| S148 | 58.2 | 91.6 |
| S149 | 62.8 | 96 |
| S150 | 67.7 | 96.3 |
| S151 | 72.2 | 99.5 |
| S152 | 69.7 | 100 |
| S153 | 56.9 | 92.5 |
| S154 | 77.8 | 100 |
| S155 | 72.6 | 100 |
| C1 | 84.6 | 88.6 |

1. A heat-curable composition, comprising:
at least one compound which is capable of undergoing cationic polymerization; and
at least one sulfonium sulfate selected from the group consisting of compounds of the formulae (Ia) and (Ib): 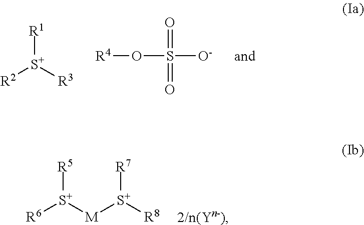
wherein:
Yⁿ⁻ is a monovalent or divalent anion selected from 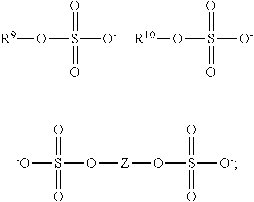
n is one or two;
R¹ is C₁-C₂₀-alkyl, C₃-C₂₀-cycloalkyl, heterocycloalkyl, a group A or a group B, where C₁-C₂₀-alkyl may be substituted by one or more identical or different radicals R^{1a} and/or may be interrupted by one or more non-adjacent groups selected from —O—, —S—, —C(O)— and —N(R^{N})—,
where
R^{1a} is F, Cl, Br, I, CN, SR¹⁹, OR²⁰, COR²¹, COOR²², CONR²³R²⁴, C₃-C₂₀-cycloalkyl or heterocycloalkyl, where the two last-mentioned radicals may be interrupted by one or more CO groups, and/or may carry one or more identical or different radicals R^{1ab},
where
R^{1ab} is F, Cl, Br, I, C₁-C₁₂-alkyl, C₁-C₁₂-haloalkyl, CN, SR¹⁹, OR²⁰, COR²¹, COOR²² or CONR²³R²⁴;
where C₃-C₂₀-cycloalkyl and heterocycloalkyl may be interrupted by one or more CO groups and/or may be substituted by one or more identical or different radicals R^{1b},
where
R^{1b} is F, Cl, Br, I, C₁-C₁₂-alkyl, C₁-C₁₂-haloalkyl, CN, SR¹⁹, OR²⁰, COR²¹, COOR²² or CONR²³R²⁴;
where
the group of the formula A is 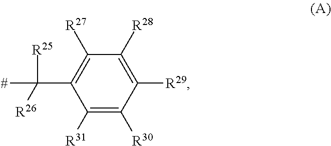
in which
# is the point of attachment to the sulfonium atom, and
where
the group of the formula B is 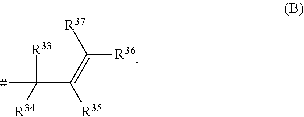
in which
# is the point of attachment to the sulfonium atom,
with the proviso that R¹ is the group A or the group B, if R² and R³ are both selected from the group consisting of C₁-C₂₀-alkyl; C₁-C₂₀-alkyl substituted by one or more radicals R^{2a}; C₁-C₂₀-alkyl which is interrupted by one or more non-adjacent groups selected from —O—, —S—, —C(O)—, and —N(R^{N)}); C₁-C₂₀-alkyl which is interrupted by one or more non-adjacent groups selected from —O—, —S—, —C(O)—, and —N(R^{N)}) and substituted by one or more radicals R^{2a}; C₃-C₂₀-cycloalkyl; C₃-C₂₀-cycloalkyl interrupted by one or more CO groups; C₃-C₂₀-cycloalkyl substituted by one or more radicals R^{2b}; and C₃-C₂₀-cycloalkyl interrupted by one or more CO groups and substituted by one or more radicals R^{2b};
R² and R³ are selected independently of one another from C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
where C₁-C₂₀-alkyl, C₂-C₂₀-alkenyl and C₂-C₂₀-alkynyl may be substituted by one or more identical or different radicals R^{2a} and/or may be interrupted by one or more non-adjacent groups selected from —O—, —S—, —C(O)— and —N(R^{N})—,
where C₃-C₂₀-cycloalkyl and heterocycloalkyl may be interrupted by one or more CO groups, and/or may carry one or more identical or different radicals R^{2b},
where C₆-C₂₀-aryl and heteroaryl may be substituted by one or more identical or different radicals R^{2c},
where
R^{2a} is selected from F, Cl, Br, I, CN, SR¹⁰, OR²⁰, COR²¹, COOR²², CONR²³R²⁴, C₃-C₂₀-cycloalkyl and heterocycloalkyl, where the two last-mentioned radicals may be interrupted by one or more CO groups and/or may be substituted by one or more identical or different radicals R^{2ab}, and also from the group consisting of heteroaryl and C₆-C₁₀-aryl, where the two last-mentioned radicals may be substituted by one or more identical or different radicals R^{2ac},
where
R^{2ab} has one of the meanings indicated for R^{1ab},
R^{2ac} is F, Cl, Br, I, C₁-C₁₂-alkyl, C₁-C₁₂-haloalkyl, CN, NO₂, SR¹⁹, OR²⁰, COR²¹, COOR²² or CONR²³R²⁴;
R^{2b} is F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl or heteroaryl where the two last-mentioned radicals may be substituted by one or more identical or different radicals R^{2bc},
where
R^{2bc} has one of the meanings indicated for R^{2ac};
R^{2c} is F, Cl, Br, I, C₁-C₁₂-alkyl, C₁-C₁₂ haloalkyl, CN, NO₂, SR¹⁹, OR²⁰, COR²¹, COOR²², CONR²³R²⁴, phenyl,
C₃-C₁₀-cycloalkyl or heterocycloalkyl where the two last-mentioned radicals may be interrupted by one or more CO groups;
or
R¹ and R² or R¹ and R³ may together form a straight-chain C₂-C₆-alkylene group, a straight-chain C₂-C₆-alkenylene group, or a —(CH₂)ₐ—C₆H₄—(CH₂)_{b} group, where a and b are an integer from 0 to 10 and the sum of a and b is 1 to 10, where alkylene, alkenylene and the alkylene moiety of —(CH₂)ₐ—C₆H₄—(CH₂)_{b} may be substituted by one or more identical or different radicals R³² and/or may be interrupted by one or more non-adjacent groups selected from —O—, —S—, —C(O)— and —N(R^{N})—;
or
R² and R³ may together form a straight-chain C₂-C₆-alkylene, a straight-chain C₂-C₆-alkenylene, or a straight-chain —(CH₂)_{c}—C₆H₄—(CH₂)_{d} group, where c and d are an integer from 0 to 10 and the sum of c and d is 1 to 10, where alkylene, alkenylene and the alkylene moiety of —(CH₂)_{c}—C₆H₄—(CH₂)_{d} may be substituted by one or more identical or different radicals R³² and/or may be fused to 1 or 2 phenyl rings and/or may be interrupted by one or more non-adjacent groups selected from —O—, —S—, —C(O)— and —N(R^{N})—;
R⁴ is C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² or —N═CR¹³R¹⁴,
where C₁-C₂₀-alkyl, C₂-C₂₀-alkenyl and C₂-C₂₀-alkynyl may be substituted by one or more identical or different radicals R^{4a} and/or may be interrupted by one or more non-adjacent groups selected from —O—, —S—, —C(O)— and —N(R^{N})—,
where C₃-C₂₀-cycloalkyl and heterocycloalkyl may be interrupted by one or more CO groups and/or may be substituted by one or more identical or different radicals R^{4b}, and where C₆-C₂₀-aryl and heteroaryl may be substituted by one or more identical or different radicals R^{4c},
where
R^{4a} is selected from F, Cl, Br, I, CN, SR¹⁹, OR²⁰, COR²¹, COOR²², CONR²³R²⁴, C₃-C₂₀-cycloalkyl and heterocycloalkyl where the 2 last-mentioned radicals may be interrupted by one or more CO groups and/or may be substituted by one or more identical or different radicals R^{4ab}, and also from the group consisting of heteroaryl and C₆-C₁₀-aryl, where the two last-mentioned radicals may be substituted by one or more identical or different radicals R^{4ac},
where
R^{4ab} has one of the meanings indicated for R^{1ab},
R^{4ac} has one of the meanings indicated for R^{2ac}, and
in addition, if 2 radicals R^{4a} are geminally bound, the 2 radicals R^{4a} together may also form an N-hydroxyimino group;
R^{4b} is F, Cl, Br, I, C₁-C₁₂-alkyl, CN, SR¹⁹, OR²⁰, COR²¹, COOR²², CONR²³R²⁴, C₆-C₁₀-aryl or heteroaryl, where the two last-mentioned radicals may be substituted by one or more identical or different radicals R^{4bc},
where
R^{4bc} has one of the meanings indicated for R^{2bc};
R^{4c} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where two last-mentioned radicals may be interrupted by one or more CO groups;
R⁵, R⁶, R⁷ and R⁸ are selected independently of one another from C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
where C1-C20-alkyl, C2-C20-alkenyl and C2-C20-alkynyl may be substituted by one or more identical or different radicals R^{5a} and/or may be interrupted by one or more non-adjacent groups selected from —O—, —S—, —C(O)— and —N(RN)—,
where C3-C20-cycloalkyl and heterocycloalkyl may be interrupted by one or more CO groups and/or may be substituted by one or more identical or different radicals R5b, where C6-C20-aryl and heteroaryl may be substituted by one or more identical or different radicals R^{5c}, where
R^{5a} has one of the meanings indicated for R^{2a},
R^{5b} has one of the meanings indicated for R^{2b},
R^{5c} has one of the meanings indicated for R^{2c};
or
R⁵ and R⁶ and/or R⁷ and R⁸ may together form a straight-chain C₂-C₆-alkylene, a straight-chain C₂-C₆-alkenylene or a straight-chain —(CH₂)_{c}—C₆H₄—(CH₂)_{d} group, where c and d are an integer from 0 to 10 and the sum of c and d is 1 to 10, where alkylene, alkenylene and the alkylene moiety of —(CH₂)_{c}—C₆H₄—(CH₂)_{d} may be substituted by one or more identical or different radicals R³² and/or may be fused to 1 or 2 phenyl rings and/or may be interrupted by one or more non-adjacent groups selected from —O—, —S—, —C(O)— and —N(R^{N})—;
R⁹ and R¹⁰ are independently of one another selected from C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² and —N═CR¹³R¹⁴, where C₁-C₂₀-alkyl, C₂-C₂₀-alkenyl and C₂-C₂₀-alkynyl may be substituted by one or more identical or different radicals R^{9a} and/or may be interrupted by one or more non-adjacent groups selected from —O—, —S—, —C(O)— and —N(R^{N})—, where C₃-C₂₀-cycloalkyl and heterocycloalkyl may be interrupted by one or more CO groups and/or may be substituted by one or more identical or different radicals R^{9b}, where C₆-C₂₀-aryl and heteroaryl may be substituted by one or more identical or different radicals R^{9c}, where
R^{9a} has one of the meanings indicated for R^{4a},
R^{9b} has one of the meanings indicated for R^{4b},
R^{9c} has one of the meanings indicated for R^{4c};
R¹¹ and R¹² are independently of one another selected from hydrogen, C₁-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, C₂-C₂₀-alkanoyl, C₃-C₂₀-alkenoyl and C₆-C₁₀-aroyl,
where C₁-C₂₀-alkyl, C₂-C₂₀-alkenyl and C₂-C₂₀-alkynyl may be substituted by one or more identical or different radicals R^{11a} and/or may be interrupted by one or more non-adjacent groups selected from —O—, —S—, —C(O)— and —N(R^{N})—,
where C₃-C₂₀-cycloalkyl and heterocycloalkyl may be interrupted by one or CO groups and/or may be substituted by one or more identical or different radicals R^{11b},
where C₆-C₂₀-aryl and heteroaryl may be may be substituted by one or more identical or different radicals R^{11c},
where C₂-C₂₀-alkanoyl and C₃-C₂₀-alkenoyl may be substituted by one or more identical or different radicals R^{11d},
where C₆-C₁₀-aroyl may be substituted by one or more identical or different radicals R^{11e},
R^{11a} has one of the meanings indicated for R^{2a},
R^{11b} has one of the meanings indicated for R^{2b},
R^{11c} has one of the meanings indicated for R^{2c},
R^{11d} is F, Cl, Br, I, CN, NO₂, SR¹⁹, OR²⁰, COR²¹, COOR²² or CONR²³R²⁴;
R^{11e} is F, Cl, Br, I, C₁-C₁₂-alkyl, C₁-C₁₂-haloalkyl, CN, NO₂, SR¹⁹, OR²⁰, COR²¹, COOR²² or CONR²³R²⁴;
or
R¹¹ and R¹² may together form a straight-chain C₂-C₅-alkylene or a straight-chain C₂-C₅-alkenylene chain, where alkylene and alkenylene may be substituted by one or more identical or different radicals R^{11f} and/or may be interrupted by one or more non-adjacent groups selected from —O—, —S—, —C(O)— and —N(R^{N})—,
or
R¹¹ and R¹² may together form an o-phenylenedicarbonyl or 1,8-naphthalenedicarbonyl group, where the two last mentioned radicals may be substituted by one or more identical or different radicals R^{11f}, where
R^{11f} has one of the meanings indicated for R^{11e};
R¹³ and R¹⁴ are, independently of one another, selected from hydrogen, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aroyl, C₆-C₂₀-aryl and heteroaryl,
where C₁-C₂₀-alkyl, C₂-C₂₀-alkenyl and C₂-C₂₀-alkynyl may be substituted by one or more identical or different radicals R^{13a} and/or may be interrupted by one or more non-adjacent groups selected from —O—, —S— —C(O)— and —N(R^{N})—,
where
C₃-C₂₀-cycloalkyl and heterocycloalkyl may be interrupted by one or more CO groups and/or may be substituted by one or more identical or different radicals R^{13b},
where
C₆-C₂₀-aroyl, C₆-C₂₀-aryl and C₅-C₂₀-heteroaryl may be substituted by one or more identical or different radicals R^{13c},
where
R^{13a} is selected from F, Cl, Br, I, CN, SR¹⁹, OR²⁰, COR²¹, COOR²², CONR²³R²⁴, C₃-C₂₀-cycloalkyl and heterocycloalkyl where the 2 last-mentioned radicals may be interrupted by one or more CO groups and/or may be substituted by one or more identical or different radicals R^{13ab}, and also from the group consisting of phenyl and phenyl which is substituted by one or more identical or different radicals R^{13ac},
where
R^{13ab} has one of the meanings indicated for R^{1ab},
R^{13ac} has one of the meanings indicated for R^{2ac};
R^{13b} is F, Cl, Br, I, C₁-C₁₂-alkyl, C₁-C₁₂-haloalkyl, CN, SR¹⁹, OR²⁰, COR²¹, COOR²², CONR²³R²⁴, phenyl or phenyl which is substituted by one or more identical or different radicals R^{13bc}, where
R^{13bc} has one of the meanings indicated for R^{2ac};
R^{13c} has one of the meanings indicated for R^{4c};
or
R¹³ and R¹⁴ may together form a straight-chain C₂-C₆-alkylene or a straight-chain C₂-C₆-alkenylene chain, where alkylene and alkenylene may be substituted by one or more identical or different radicals R³² and/or may be interrupted by one or more non-adjacent groups selected from —O—, —S—, —C(O)— and —N(R^{N})—;
R¹⁹ and R²⁰ are selected independently of one another from hydrogen, C₁-C₂₀-alkyl, C₂-C₁₂-alkenyl, C₃-C₁₀-cycloalkyl, heterocycloalkyl, where the two last-mentioned radicals may be interrupted by one or more CO groups, C₁-C₂₀-alkyl which is interrupted by one or more non-adjacent groups selected from —O—, —S—, —C(O)— and —N(R^{N})—, C₁-C₈-alkyl substituted by one or more identical or different radicals R^{19a}, —(CH₂CH₂O)ₘH with m being 1-20, —(CH₂CH₂O)ₙ(CO)—(C₁-C₈-alkyl) with n being 1-20, C₂-C₈-alkanoyl, C₂-C₈-haloalkanoyl, C₃-C₆-alkenoyl, benzoyl where the last-mentioned radical may be substituted by one or more radicals selected independently of one another from F, Cl, Br, I, C₁-C₆-alkyl, OH and C₁-C₄-alkoxy, phenyl, naphthyl, where the two last-mentioned radicals may be substituted by one or more identical or different radicals R^{19c},
or phenyl or naphthyl which forms a 5- or 6-membered ring via the phenyl ring to which SR¹⁹ or OR²⁰, respectively, is attached via a single bond, C₁-C₄-alkylene, O, S, CO or NR²³,
where
R^{19a} is F, Cl, Br, I, OH, SH, CN, C₃-C₁₀-cycloalkyl, heterocycloalkyl, phenyl, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl),
R^{19c} is F, Cl, Br, I, C₁-C₁₂-alkyl, C₁-C₁₂-haloalkyl, C₁-C₁₂-alkoxy, phenyl-C₁-C₃-alkyloxy, phenoxy, C₁-C₁₂-alkylsulfanyl, phenylsulfanyl, —(CO)O(C₁-C₈-alkyl), (CO)N(C₁-C₈-alkyl)₂ or phenyl;
R²¹ is selected independently of one another from hydrogen, C₁-C₂₀-alkyl, C₂-C₁₂-alkenyl, C₁-C₂₀-alkyl which is interrupted by one or more non-adjacent groups selected from —O—, —S—, —CO— and —N(R^{N})—, C₁-C₈-alkyl substituted by one or more identical or different radicals R^{21a}, —(CH₂CH₂O)ₒH with o being 1-20, —(CH₂CH₂O)ₚ(CO)—(C₁-C₈-alkyl) with p being 1-20, C₃-C₁₀-cycloalkyl, heterocycloalkyl, where the two last-mentioned radicals may be interrupted by one or more CO groups, C₆-C₂₀-aryl and heteroaryl, where the two last-mentioned radicals may be substituted by one or more radicals identical or different radicals R^{21c},
where
R^{21a} is F, Cl, Br, I, OH, SH, CN, phenyl, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl), and
R^{21c} has one of the meanings indicated for R^{19c};
R²² is selected independently of one another from hydrogen, C₁-C₂₀-alkyl, C₂-C₁₂-alkenyl, C₂-C₂₀-alkyl which is interrupted by one or more non-adjacent groups selected from —O—, —S—, —C(O)— and —NR^{N}—, C₁-C₈-alkyl substituted by one or more identical or different radicals R^{22a}, —(CH₂CH₂O)_{q}H with q being 1-20, —(CH₂CH₂O)ᵣ(CO)—(C₁-C₈-alkyl) with r being 1-20, C₃-C₁₀-cycloalkyl, heterocycloalkyl, where the two last-mentioned radicals may be interrupted by one or more CO groups, phenyl and naphthyl, where the two last-mentioned radicals may be substituted by one or more identical or different radicals R^{22c},
where
R^{22a} is F, Cl, Br, I, OH, SH, CN, C₃-C₆ alkenoxy, —OCH₂CH₂CN, —OCH₂CH₂(CO)O(C₁-C₈-alkyl), —O(CO)—(C₁-C₈-alkyl), —O(CO)-phenyl, —(CO)OH, —(CO)O(C₁-C₈-alkyl), phenyl or naphthyl, where the two last-mentioned radicals may be substituted by one or more identical or different radicals R^{22ac},
where
R^{22ac} has one of the meanings indicated for R^{19c};
R^{22c} has one of the meanings indicated for R^{19c};
R²³ and R²⁴ are, independently of one another, selected from hydrogen, OR²⁰, C₁-C₂₀-alkyl, C₂-C₁₂-alkenyl, C₂-C₂₀-alkyl which is interrupted by one or more non-adjacent groups selected from —O—, —S—, —C(O)— and —NR^{N}—, C₁-C₈-alkyl substituted by one or more identical or different radicals R^{23a}, —(CH₂CH₂O)ₛH with s being 1-20, —(CH₂CH₂O)ₜ(CO)—(C₁-C₈-alkyl) with t being 1-20, C₂-C₈alkanoyl, C₂-C₈-haloalkanoyl, C₃-C₆-alkenoyl, benzoyl which may be substituted by one or more identical or different radicals selected from F, Cl, Br, I, C₁-C₆-alkyl, —OH and C₁-C₄-alkoxy, C₃-C₁₀-cycloalkyl, heterocycloalkyl, where the two last-mentioned radicals may be interrupted by one or more CO groups, phenyl and naphthyl, where the two last-mentioned radicals may be substituted by one or more identical or different radicals R^{23c},
where
R^{23a} is F, Cl, Br, I, OH, SH, CN, phenyl, C₃-C₆-alkenoxy, —OCH₂CH₂CN, —OCH₂CH₂(CO)O(C₁-C₈-alkyl), —O(CO)—(C₁-C₈-alkyl), —O(CO)-phenyl, —(CO)OH or —(CO)O(C₁-C₈-alkyl),
R^{23c} has one of the meanings indicated for R^{19c};
or
R²³ and R²⁴ together may form a C₂-C₅-alkylene group, which may be interrupted by one or more non-adjacent groups selected from —O—, —S—, —C(O)— and —N(R^{N})—;
R²⁵ and R²⁶ are, each independently of one another, selected from hydrogen, F, Cl, Br, CN, NO₂, SR¹⁹, OR²⁰, COR²¹, COOR²², CONR²³R²⁴, C₁-C₂₀-alkyl, C₃-C₂₀-cycloalkyl, heterocycloalkyl, C₆-C₂₀-aryl and heteroaryl,
where
C₁-C₂₀-alkyl may be interrupted by one or more non-adjacent groups selected from —O—, —S—, —C(O)— and —N(R^{N})— and/or may be substituted by one or more identical or different radicals R^{25a},
where
C₃-C₂₀-cycloalkyl and heterocycloalkyl may be interrupted by one or more CO groups and/or may be substituted by one or more identical or different radicals R^{25b}, and
where
C₆-C₂₀-aryl and heteroaryl may be substituted by one or more identical or different radicals R^{25c},
where
R^{25a} has one of the meanings indicated for R^{13a};
R^{25b} has one of the meanings indicated for R^{13b};
R^{25c} has one of the meanings indicated for R^{13c};
R²⁷, R²⁸, R²⁹, R³⁰ and R³¹ are, each independently of one another, selected from hydrogen, F, Cl, Br, I, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
where
C₁-C₂₀-alkyl, C₂-C₂₀-alkenyl and C₂-C₂₀-alkynyl may be substituted one or more radicals identical or different radicals R^{27a} and/or may be interrupted by one or more non-adjacent groups selected from —O—, —S—, —C(O)— and —N(R^{N})—,
where
C₃-C₂₀-cycloalkyl and heterocycloalkyl may be interrupted by one or more CO groups and/or may be substituted by one or more identical or different radicals R^{27b},
where
C₆-C₂₀-aryl and heteroaryl may be substituted by one or more identical or different radicals R^{27c},
where
R^{27a} has one of the meanings indicated for R^{13a};
R^{27b} has one of the meanings indicated for R^{13b};
R^{27c} has one of the meanings indicated for R^{13c};
or
two radicals R²⁷ and R²⁸, R²⁸ and R²⁹, R²⁹ and R³⁰ and/or R³⁰ and R³¹ may together form a straight-chain C₂-C₆-alkylene or a straight-chain C₂-C₆-alkenylene group, where the alkylene group and the alkenylene group may be substituted by one or more identical or different radicals R³² and/or may be fused to 1 or 2 C₆-C₁₀-aryl rings and/or may be interrupted by one or more non-adjacent groups selected from —O—, —S—, —C(O)— and —N(R^{N})—,
or
R²⁵ and R²⁷ may together form a C₂-C₆-alkylene chain, where alkylene may be substituted by one or more radicals R³² and/or may be interrupted by one or more non-adjacent groups selected from —O—, —S—, —C(O)— and —N(R^{N})—,
or
R²⁵ and R²⁷ may together form a 1,2-phenylene group, where 1,2-phenylene may be substituted by one or more identical or different radicals R³²;
R³² is F, Cl, Br, I, CN, NO₂, SR¹⁹, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl;
where
C₁-C₂₀-alkyl, C₂-C₂₀-alkenyl and C₂-C₂₀-alkynyl may be interrupted by one or more non-adjacent groups selected from —O—, —S—, —C(O)— and —N(R^{N})— and/or may be substituted one or more radicals identical or different R^{32a},
where
C₃-C₂₀-cycloalkyl and heterocycloalkyl may be interrupted by one or more CO groups and/or may be substituted by one or more identical or different radicals R^{32b},
where
C₆-C₂₀-aryl and heteroaryl may be substituted by one or more radicals identical or different R^{32c},
where
R^{32a} has one of the meanings indicated for R^{13a};
R^{32b} has one of the meanings indicated for R^{13b}; and
R^{32c} has one of the meanings indicated for R^{13c};
R³³ and R³⁴ are, each independently of one another are selected from hydrogen, F, Cl, Br, I, CN, NO₂, SR¹⁹, OR²⁰, COR²¹, COOR²², CONR²³R²⁴, C₁-C₂₀-alkyl, C₃-C₂₀-cycloalkyl, heterocycloalkyl, C₆-C₂₀-aryl and heteroaryl,
where
C₁-C₂₀-alkyl may be may be substituted by one or more radicals R^{33a} and/or may be interrupted by one or more non-adjacent groups selected from —O—, —S—, —C(O)— and —N(R^{N})—,
where
C₃-C₂₀-cycloalkyl and heterocycloalkyl may be interrupted by one or more CO groups and/or may be substituted by one or more identical or different radicals R^{33b}, and
where
C₆-C₂₀-aryl and heteroaryl may be substituted by one or more identical or different radicals R^{33c},
where
R^{33a} has one of the meanings indicated for R^{13a};
R^{33b} has one of the meanings indicated for R^{13b};
R^{33c} has one of the meanings indicated for R^{13c};
R³⁵, R³⁶ and R³⁷, each independently of one another are selected from hydrogen, F, Cl, Br, I, CN, NO₂, SR¹⁰, OR²⁰, COR²¹, COOR²², CONR²³R²⁴, C₁-C₂₀-alkyl, C₂-C₂₀-alkenyl, C₂-C₂₀-alkynyl, C₃-C₂₀-cycloalkyl, heterocycloalkyl, C₆-C₂₀-aryl and heteroaryl,
where
C₁-C₂₀-alkyl, C₂-C₂₀-alkenyl and C₂-C₂₀-alkynyl may be substituted by one or more identical or different radicals R^{35a} and/or may be interrupted by one or more non-adjacent groups selected from —O—, —S—, —C(O)— and —N(R^{N})—,
where
C₃-C₂₀-cycloalkyl and heterocycloalkyl may be substituted by one or more identical or different radicals R^{35b}, and
where
C₆-C₂₀-aryl and heteroaryl may be substituted by one or more identical or different radicals R^{35c},
where
R^{35a} has one of the meanings indicated for R^{27a};
R^{35b} has one of the meanings indicated for R^{27b};
R^{35c} has one of the meanings indicated for R^{17c};
or
R³⁵ and R³⁶ may together form a straight-chain C₂-C₆-alkylene or a straight-chain C₂-C₆-alkenylene group, where alkylene and alkenylene may be substituted by one or more radicals identical or different R³² and/or may be interrupted by one or more non-adjacent groups selected from —O—, —S—, —C(O)— and —N(R^{N})—,
or
two radicals R³³ and R³⁵, R³³ and R³⁷, R³⁴ and R³⁵ and/or R³⁴ and R³⁷ may together form a straight-chain C₂-C₆-alkylene group, where the alkylene group may be substituted by one or more identical or different radicals R³² and/or may be interrupted by one or more non-adjacent groups selected from —O—, —S—, —C(O)— and —N(R^{N})—;
M is a divalent radical selected from C₁-C₂₀-alkylene, C₂-C₂₀-alkenylene, C₂-C₂₀-alkynylene, C₃-C₂₀-cycloalkylene, heterocycloalkylene, C₆-C₂₀-arylene and heteroarylene, where C₁-C₂₀-alkylene, C₂-C₂₀-alkenylene and C₂-C₂₀-alkynylene may be substituted by one or more identical or different radicals R^{Ma} and/or may be interrupted by one or more identical or different non-adjacent groups R^{Mi},
where
C₃-C₂₀-cycloalkylene and heterocycloalkylene may be interrupted by one or more CO groups and/or may be substituted by one or more radicals
R^{Mb};
where
C₆-C₂₀-arylene and heteroarylene may be substituted by one or more radicals R^{Mc},
where
R^{Mi} is selected from —O—, —S—, —C(O)—, OC(O)—, —N(R^{N})—, C₃-C₂₀-cycloalkylene, —O—C₃-C₂₀-cycloalkylene, —O—C₃-C₂₀-cycloalkylene-O—, heterocycloalkylene, C₆-C₂₀-arylene, —O—C₆-C₂₀-arylene, —O—C₆-C₂₀-arylene-O—, —S—C₆-C₂₀-arylene, —S—C₆-C₂₀-arylene-S— and heteroarylene, where each cycloalkylene and heterocycloalkylene may be interrupted by one or more CO groups and/or may be substituted by one or more identical or different radicals R^{Mib}, and
where
each arylene and heteroarylene may be substituted by one or more radicals R^{Mic},
R^{Ma} is F, Cl, Br, I, CN, SR¹⁹, OR²⁰, COR²¹, COOR²², CONR²³R²⁴, C₆-C₁₀-aryl or heteroaryl where the 2 last-mentioned radicals may be substituted by one or more identical or different radicals selected from C₁-C₁₂-alkyl, C₁-C₁₂-haloalkyl, F, Cl, Br, I, CN, NO₂, SR¹⁹, OR²⁰, COR²¹, COOR²² and CONR²³R²⁴;
R^{Mib} is F, Cl, Br, I, C₁-C₁₂-alkyl, C₁-C₁₂-haloalkyl, CN, NO₂, SR¹⁹, OR²⁰, COR²¹, COOR²², CONR²³R²⁴ or phenyl;
R^{Mic} is F, Cl, Br, I, C₁-C₁₂-alkyl, C₁-C₁₂-haloalkyl, CN, NO₂, SR¹⁹, OR²⁰, COR²¹, COOR²², CONR²³R²⁴ or phenyl;
R^{Mb} is F, Cl, Br, I, C₁-Cᵤ-alkyl, C₁-C₁₂-haloalkyl, CN, SR¹⁹, OR²⁰, COR²¹, COOR²²; CONR²³R²⁴, C₆-C₁₀-aryl or heteroaryl, where the 2 last-mentioned radicals may be substituted by one or more identical or different radicals selected from C₁-C₁₂-alkyl, C₁-C₁₂-haloalkyl, F, Cl, Br, I, CN, NO₂, SR¹⁹, OR²⁰, COR²¹, COOR²² or CONR²³R²⁴;
R^{Mc} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where the two last-mentioned radicals may be interrupted by one or more CO groups;
Z is C₁-C₂₀-alkylene or C₆-C₂₀-arylene,
where
C₁-C₂₀-alkylene may be interrupted by one or more nonadjacent groups R^{Zi} and/or may be substituted by one or more identical or different radicals R^{Za}, and where C₆-C₂₀-arylene may be substituted by one or more radicals R^{Zc},
where
R^{Zi} has one of the meanings indicated for R^{Mi},
R^{Za} has one of the meanings indicated for R^{Ma},
R^{Zc} has one of the meanings indicated for R^{Mc},
R^{N} is selected independently of one another from hydrogen, C₁-C₂₀ alkyl, C₁-C₁₀-alkanoyl, C₆-C₁₀-aroyl, C₁-C₂₀-alkylsulfonyl, C₂-C₂₀-alkenylsulfonyl, C₆-C₁₀-arylsulfonyl, C₃-C₁₀-cycloalkyl, heterocycloalkyl, C₆-C₁₀-aryl and heteroaryl, where C₃-C₁₀-cycloalkyl and heterocycloalkyl may be interrupted by one or more CO groups, and the tautomers or stereoisomers thereof.

2. The heat-curable composition according to claim 1,
where R¹ is selected from the group of the formula A, 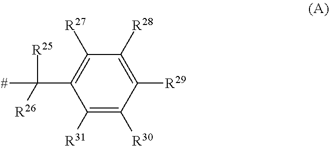
where
R²⁵ and R²⁶ are each independently of one another selected from hydrogen, C₁-C₁₂-alkyl and phenyl; and
R²⁷, R²⁸, R²⁹, R³⁰ and R³¹ are each independently of one another selected from hydrogen, F, Cl, Br, I, NO₂, OR²⁰, COOR²², CONR²³R²⁴, C₁-C₁₂-alkyl, C₂-C₁₂-alkenyl and phenyl, or
two radicals R²⁷ and R²⁸, and/or R²⁸ and R²⁹ and/or R²⁹ and R³⁰ and/or R³⁰ and R³¹ bound on adjacent carbon atoms may be together a group selected from —CH₂CH₂CH₂—, —CH₂CH₂CH₂CH₂— and —CH═CH—CH═CH—, thus forming, together with the carbon atoms to which they are bound, a 5- or 6-membered ring;
and also from the group consisting of the group of the formula B 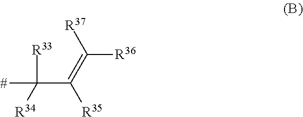
where
R³³ and R³⁴ are each independently of one another selected from hydrogen, C₁-C₁₂-alkyl and phenyl; and
R³⁵, R³⁶ and R³⁷ are independently of one another selected from hydrogen, F, Cl, C₁-C₁₂-alkyl, C₂-C₁₂-alkenyl and phenyl;
where R²⁰, R²², R²³ and R²⁴ are as defined in claim 1.

3. The heat-curable composition according to claim 1, where R¹ is selected from
a C₃-C₁₂-cycloalkyl which may be substituted by one or more identical or different radicals selected from F, Cl, Br, I, C₁-C₁₂-alkyl, OR²⁰, COR²¹, COOR²² and CONR²³R²⁴; and also from the group consisting of
a C₁-C₁₂-alkyl which may be substituted by one or more radicals selected from F, Cl, Br, I, OR²⁰, COR²¹, COOR²², CONR²³R²⁴, C₃-C₁₂-cycloalkyl and heterocyclyl,
where R²¹, R²², R²², R²³ and R²⁴ are as defined in claim 1.

4. The heat-curable composition according to claim 1, wherein R¹ is naphthylmethyl; benzyl which is optionally substituted by one or two radicals selected from nitro, fluorine, chlorine, C₁-C₄-alkyl, C₁-C₄-alkoxy, C₁-C₄-alkoxycarbonyl, C(O)O—(C₁-C₄-alkyl-OH) and C(O)N(C₁-C₄-alkyl)₂; C₃-C₈-cycloalkyl; C₁-C₆-alkyl; C₁-C₄-alkoxy-(CO)—C₁-C₄-alkyl; (5- or 6-membered saturated heterocycloalkyl)-C₁-C₄-alkyl; phenoxy-C₁-C₄-alkyl; prop-2-en-1-yl, 3-phenyl-prop-2-en-1-yl, 2-(C₁-C₄-alkyl)-prop-2-en-1-yl; or 3-(C₁-C₄-alkyl)-prop-2-en-1-yl.

5. The heat-curable composition according to claim 1, wherein R² and R³ are independently of one another selected from the group consisting of
C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴,
C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl,
phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴, and
phenyl, which is unsubstituted or substituted by one, two, three, four or five radicals selected from F, Cl, Br, I, C₁-C₁₀-alkyl, SR¹⁹ and OR²⁰, and
wherein R¹⁹, R²⁰, R²², R²³ and R²⁴ are as defined in claim 1.

6. The heat-curable composition according to claim 5, wherein R² and R³ are independently of one another selected from the group consisting of C₁-C₈-alkyl; phenyl-C₁-C₆-alkyl, where the alkyl moiety of the last mentioned radical is substituted by benzoyl; naphthyl-C₁-C₆-alkyl; (5- or 6-membered saturated heterocyclyl)-C₁-C₆-alkyl, phenoxy-C₁-C₆-alkyl, benzoyl-C₁-C₆-alkyl, C₁-C₄-alkoxy-C(═O)—C₁-C₆-alkyl, C₁-C₄-alkoxy-C₁-C₄-alkoxy-C(═O)—C₁-C₆-alkyl, benzyloxycarbonyl-C₁-C₆-alkyl, phenyl and phenyl-C₁-C₆-alkyl, where the aromatic ring in the two last-mentioned radicals may be substituted by 1, 2, 3, 4 or 5 radicals which, independently of one another, are selected from the group consisting of F, Cl, Br, I, OH, NO₂, C₁-C₁₀-alkyl, C₁-C₄-alkoxy, (5- or 6-membered saturated heterocycloalkyl)-C₁-C₄-alkoxy, C₁-C₄-fluoroalkanoyloxy, hydroxy-C₁-C₄-alkoxycarbonyl, C₁-C₄-alkoxycarbonyl, C₁-C₄-alkoxy-C₁-C₄-alkoxycarbonyl, benzyloxycarbonyl and C(═O)N(C₁-C₈-alkyl)₂.

7. The heat-curable composition according to claim 1, wherein R¹ and R² or R² and R³ or R¹ and R³ in formula (Ia) together with the sulfur atom to which they are bound, form a 5- or 6-membered, saturated heterocycle, which is optionally fused to one phenyl ring.

8. The heat-curable composition according to claim 1, where R⁴ is selected from the group consisting of NR¹¹R¹²; —N═CR¹³R¹⁴; C₁-C₁₂-alkyl, C₂-C₁₂-alkenyl, where the two last-mentioned radicals may be substituted by one or more identical or different radicals R^{4a} selected from F, Cl, Br, I, OR²⁰, COR²¹, COOR²², C₃-C₂₀-cycloalkyl, heterocyclyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴ and where cycloalkyl and heterocyclyl may be interrupted by one or more CO groups, and 2 geminally bound radicals R^{4a} together may also form an N-hydroxyimino group; and phenyl, which may be substituted by one or more C₁-C₁₂-alkyl, F, Cl, Br, I, NO₂ or COOR²², where R¹¹, R¹², R¹³, R¹⁴, R¹⁹, R²⁰, R²¹, R²², R²³ and R²⁴ are as defined in claim 1.

9. The heat-curable composition according to claim 8, wherein R⁴ is selected from the group consisting of C₁-C₄-alkoxy-C₁-C₆-alkyl, C₁-C₄-alkylsulfanyl-C₁-C₆-alkyl, C₁-C₄-alkoxycarbonyl-C₁-C₆-alkyl, C₁-C₆-fluoroalkyl, (5- or 6-membered heteroaryl)-C₁-C₆-alkyl, naphthyl-C₁-C₆-alkyl, phenoxy-C₁-C₆-alkyl, nitro-phenyl-C₁-C₆-alkyl, C₁-C₆-alkyl which may be substituted by 1, 2, 3 or 4 radicals selected from OH, N-hydroxyimino, and benzoyl, phenyl-C₃-C₆-alkenyl and C₃-C₁₂-cycloalkyl, where the cyclic moiety in the two last-mentioned radicals may be substituted by 1, 2, 3, 4 or 5 radicals of a C₁-C₄-alkyl.

10. The heat-curable composition according to claim 8, wherein:
R⁴ is —N═CR¹³R¹⁴, such that R¹³ and R¹⁴ are, independently of one another, selected from the group consisting of C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, (phenylsulfanyl)-benzoyl, (phenylsulfanyl)phenyl, or R¹³ and R¹⁴ together with the carbon atom to which they are bound form a C₅-C₈-cycloalkyl ring, or R⁴ is —NR¹¹R¹², where R¹¹ is phenyl and R¹² is benzoyl.

11. The heat-curable composition according to claim 1, wherein:
R¹ is a group of the formula A; a group of the formula B; C₃-C₈-cycloalkyl; C₁-C₆-alkyl; C₁-C₄-alkoxy-(CO)—C₁-C₄-alkyl; (5- or 6-membered saturated heterocycloalkyl)-C₁-Cₐ-alkyl; or phenoxy-C₁-Cₐ-alkyl;
R² is C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₁₀-alkyl, C₁-C₄-alkoxy, C₁-Cₐ-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; phenyl; phenyl which is substituted by 1, 2, 3, 4 or 5 radicals selected from OH and C₁-C₁₀-alkyl;
R³ is C₁-C₈-alkyl; C₁-C₄-alkoxy-C₁-C₆-alkyl; benzyloxycarbonyl-C₁-C₄-alkyl; phenyl; phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy and C₁-C₁₀-alkyl; phenyl-C₁-Cₐ-alkyl; phenyl-C₁-C₄-alkyl, where the phenyl moiety is substituted by 1, 2, 3, 4 or 5 radicals selected from C₁-C₄-alkyl such as 4-methylbenzyl;
R⁴ is C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)phenyl-C₁-C₆-alkyl; nitro-phenyl-C₁-C₆-alkyl; C₁-C₁₂-alkyl which may be substituted by 1, 2, 3 or 4 radicals selected from OH, N-hydroxyimino, benzoyl, phenyl and phenoxy; phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl; NR¹¹R¹²; or —N═CR¹³R¹⁴;
where the group A, the group B, R¹¹, R¹²; R¹³ and R¹⁴ are as defined in claim 1.

12. The composition according to claim 1, wherein:
R¹ is a group of the formula A or a group of the formula B;
R² C₁-C₈-alkyl; C₁-C₄-alkoxy-C₁-C₄-alkyl; C₁-C₄-alkoxy-C₁-C₄-alkoxy-C(═O)—C₁-C₆-alkyl; (5-or 6-membered heterocycloalkyl)-C₁-C₄-alkyl; naphthalene-C₁-C₄-alkyl, phenyl-C₁-C₄-alkyl; phenyl-C₁-C₄-alkyl, where the phenyl moiety is substituted by 1, 2, 3, 4 or 5 radicals selected from nitro, chlorine, hydroxy, C₁-C₄-alkoxy, C₁-C₄-alkoxycarbonyl, C₁-C₄-alkoxy-C₁-C₄-alkoxycarbonyl, hydroxy-C₁-C₄-alkoxycarbonyl, benzyloxycarbonyl and C(═O)N(C₁-C₈-alkyl)₂; benzoyl-C₁-C₄-alkyl; phenoxy-C₁-C₄-alkyl; benzyloxycarbonyl-C₁-C₄-alkyl; phenyl; phenyl which is substituted by 1, 2, 3, 4 or 5 radicals selected from OH and C₁-C₁₀-alkyl;
R³ is C₁-C₈-alkyl; C₁-C₄-alkoxy-C₁-C₆-alkyl; benzyloxycarbonyl-C₁-C₄-alkyl; phenyl; phenyl which is substituted by 1, 2, 3, 4 or 5 radicals selected from OH, C₁-C₄-fluoroalkanoyloxy, (5- or 6-membered heterocycyloalkyl)-C₁-C₄-alkoxy, C₁-C₆-alkoxy and C₁-C₁₀-alkyl; phenyl-C₁-C₄-alkyl; phenyl-C₁-C₄-alkyl, where the phenyl moiety is substituted by 1, 2, 3, 4 or 5 radicals selected from C₁-C₄-alkyl such as 4-methylbenzyl; R⁴ is C₁-C₄-alkoxy-C₁-C₆-alkyl; C₁-C₄-alkylsulfanyl-C₁-C₆-alkyl; C₁-C₄-alkoxycarbonyl-C₁-C₆-alkyl; C₁-C₆-fluoroalkyl; (5- or 6-membered heteroaryl)-C₁-C₆-alkyl; naphthyl-C₁-C₆-alkyl; phenoxy-C₁-C₆-alkyl; phenyl-C₁-C₆-alkyl; (C₁-C₄-alkyl)-phenyl-C₁-C₆-alkyl;
nitro-phenyl-C₁-C₆-alkyl; C₁-C₁₂-alkyl which may be substituted by 1, 2, 3 or 4 radicals selected from OH, N-hydroxyimino, benzoyl, phenyl and phenoxy;
phenyl-C₃-C₆-alkenyl, C₃-C₁₂-cycloalkyl, where the cyclic moiety in the two last-mentioned radicals may be substituted by 1, 2, 3, 4 or 5 radicals selected from C₁-C₄-alkyl; NR¹¹R¹²; or —N═CR¹³R¹⁴;
where the group A and the group B are as defined in claim 1 or 2 and R¹¹, R¹², R¹³ and R¹⁴ are as defined in claim 1.

13. The heat-curable composition according to claim 1, wherein R⁵, R⁶, R⁷ and R⁸ are independently of one another selected from
C₁-C₁₂-alkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 identical or different radicals selected from F, Cl, Br, I, NO₂, C₁-C₁₂-alkyl, OR²⁰, COOR²² and CONR²³R²⁴,
C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴, and
phenyl, which is unsubstituted or substituted by one, two, three, four or five radicals selected from F, Cl, Br, I, C₁-C₁₀-alkyl, SR¹⁹ and OR²⁰,
where R¹⁹, R²⁰, R²⁰, R²², R²³ and R²⁴ are as defined in claim 1.

14. The heat-curable composition according to claim 1, where R⁹ and R¹⁰ are independently of one another selected from the group consisting of
NR¹¹R¹², —N═CR¹³R¹⁴,
C₁-C₁₂-alkyl, C₂-C₁₂-alkenyl, where the two last-mentioned radicals may be substituted by one or more identical or different radicals selected from F, Cl, Br, I, SR¹⁹, OR²⁰, COR²¹, COOR²², C₃-C₂₀-cycloalkyl, heterocycloalkyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴, and where cycloalkyl and heterocycloalkyl may be interrupted by one or more CO groups, and
phenyl, which may be is substituted by one or more C₁-C₁₂-alkyl, F, Cl, Br, I, NO₂ or COOR²²,
where R¹¹, R¹², R¹³, R¹⁴, R¹⁹, R²⁰, R²¹, R²², R²³ and R²⁴ are as defined in claim 1.

15. The heat-curable composition according to claim 1, wherein M in is selected from the group consisting of phenylene which may be substituted by one or more radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl; and also from the group consisting of C₁-C₁₂-alkylene which may be substituted by one or more identical or different radicals selected from F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl, heteroaryl or C₆-C₁₀-aryl which is substituted by one or more identical or different radicals selected from F, Cl, Br, I, C₁-C₁₂-alkyl, C₁-C₁₂-haloalkyl, CN, NO₂, SR¹⁹, OR²⁰, COR²¹, COOR²² and CONR²³R²⁴, and/or may be interrupted by one or more non-adjacent groups selected from —O—, —S—, —O-phenylen- and -phenylene-, where 2 last-mentioned groups for their part may be substituted by one or more identical or different radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl, where R¹⁹, R²⁰, R²², R²³ and R²⁴ are as defined in claim 1.

16. The heat-curable composition according to claim 1, wherein in the compound of the formula Ib
R⁵, R⁶, R⁷ and R⁸ are independently of one another selected from C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;
C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, OR²⁰, COOR²² and CONR²³R²⁴; and
phenyl, which is unsubstituted or substituted by one, two, three, four or five radicals selected from F, Cl, Br, I, C₁-C₁₀-alkyl, SR¹⁹ and OR²⁰;
or R⁵ and R⁶ or R⁷ and R⁸ together with the sulfur atom to which they are bound, form a 5- or 6-membered, saturated heterocycle, which may be fused to one phenyl ring;
R⁹, R¹⁰ are, independently of one another selected from NR¹¹R¹²;
—N═CR¹³R¹⁴, wherein R¹³ and R¹⁴ are, independently of one another, selected from C₁-C₈-alkyl, phenyl, phenylsulfanyl, C₁-C₄-alkoxycarbonyl, C₁-C₄-alkoxycarbonyl-C₁-C₄-alkyl, benzyloxycarbonyl, benzoyl, C₁-C₄-alkylsulfanylphenyl, phenylsulfanyl-benzoyl or R¹³ and R¹⁴ together with the carbon atom to which they are bound form a C₅-C₈-cycloalkyl ring;
C₁-C₁₂-alkyl, C₂-C₁₂-alkenyl, where the two last-mentioned radicals may be substituted by one or more identical or different radicals R^{4a} selected from F, Cl, Br, I, OR²⁰, COR²¹, COOR²², C₃-C₂₀-cycloalkyl, heterocycloalkyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴ and where cycloalkyl and heterocycloalkyl may be interrupted by one or more CO groups and in addition 2 geminally bound radicals R^{4a} together may also form an N-hydroxyimino group; and
phenyl, which may be substituted by one or more C₁-C₁₂-alkyl, F, Cl, Br, I, NO₂ or COOR²²;
M is C₂-C₈-alkylene interrupted by one, two, three, four, five or six non-adjacent groups selected from —O—, —S—, —O-phenylen and phenylene, where the last mentioned groups may be substituted by 1, 2, 3 or 4 radicals selected from C₁-C₁₂alkyl, C₁-C₁₂-haloalkyl, CN, NO₂, SR¹⁹, OR²⁰, COR²¹, COOR²², CONR²³R²⁴ and phenyl. In particular, M is C₂-C₈-alkylene which is interrupted by one phenylen group or C₂-C₈-alkylene which is interrupted by 1, 2, 3 or four groups selected from oxygen and —O-phenylene, where R¹¹, R¹², R¹⁹, R²⁰, R²², R²³ and R²⁴ are as defined in claim 1.

17. The heat curable composition according to claim 1, wherein in the compound of the formula Ib
R⁵, R⁶, R⁷ and R⁸ are independently of one another selected from C₁-C₁₂-alkyl, which is unsubstituted or substituted by one or more radicals selected from F, Cl, Br, I, OR²⁰, COR²¹, COOR²², CONR²³R²⁴, heterocycloalkyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴;
C₃-C₁₂-cycloalkyl, which is unsubstituted or substituted by one or more radicals selected from F, Cl, Br, I, OR²⁰, COR²¹, COOR²², CONR²³R²⁴, heterocyclyl, C₃-C₈-cycloalkyl, phenyl and naphthyl, where the two last-mentioned radicals are unsubstituted or substituted by 1, 2, 3, 4, or 5 radicals selected from F, Cl, Br, I, NO₂, C₁-C₁₂-alkyl, OR²⁰, COOR²² and CONR²³R²⁴; and
phenyl, which is unsubstituted or substituted by one, two, three, four or five radicals selected from F, Cl, Br, I, C₁-C₁₀-alkyl, SR¹⁹ and OR²⁰;
or R⁵ and R⁶ or R⁷ and R⁸ together with the sulfur atom to which they are bound, form a 5- or 6-membered, saturated heterocycle, which may be fused to one phenyl ring;
M is C₂-C₈-alkylene interrupted by one, two, three, four, five or six non-adjacent groups selected from —O—, —S—, —O-phenylen and phenylene, where the last mentioned groups may be substituted by 1, 2, 3 or 4 radicals selected from C₁-C₁₂-alkyl, C₁-C₁₂-haloalkyl, CN, NO₂, SR¹⁹, OR²⁰, COR²¹, COOR²², CONR²³R²⁴ and phenyl. In particular, M is C₂-C₈-alkylene which is interrupted by one phenylen group or C₂-C₈-alkylene which is interrupted by 1, 2, 3 or four groups selected from oxygen and —O-phenylene; and
Z is C₁-C₁₀-alkylene or C₁-C₁₀-alkylene which is substituted by one or more, e.g. 1, 2 or 3, non-adjacent groups R^{Zi} selected from O, S, phenylene, —O-phenylene and —O-phenylene-O; in particular R^{Zi} is phenylen.

18. The heat-curable composition according to claim 1, wherein the compound which is capable of undergoing cationic polymerization has at least one group selected from an epoxy group, oxetane group and vinyl ether group.

19. The heat-curable composition according to claim 1, comprising at least one further component selected from solvent, reactive diluents, photoinitiators, pigments, dispersants, ethylenically unsaturated compounds, binder being different from compounds (a) and different from ethylenically unsaturated compounds, sensitizer, thermal curing promoters being different from compounds of formulae Ia and Ib, further additives and mixtures.

20. The heat-curable composition according to claim 19, wherein the ethylenically unsaturated compound is an acrylic monomer.

21. The heat-curable composition according to claim 1, wherein the compound which is capable of undergoing cationic polymerization is an epoxy resin.

22. A compound of the formula (Ia): 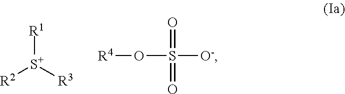
wherein:
R¹, R² and R³ are as defined in claim 1;
R⁴ is selected from C₁-C₂-alkyl, C₃-C₂₀-alkyl, C₂-C₂₀-alkenyl, C₂-C₂₀-alkynyl, C₃-C₂₀-cycloalkyl, heterocycloalkyl, C₆-C₂₀-aryl, heteroaryl, —NR¹¹R¹² and —N═CR¹³R¹⁴,
where C₁-C₂-alkyl is substituted by one or more radicals identical or different radicals R^{4a},
where C₃-C₂₀-alkyl, C₂-C₂₀-alkenyl and C₂-C₂₀-alkynyl may be substituted by one or more identical or different radicals R^{4a} and/or may be interrupted by one or more non-adjacent groups selected from —O—, —S—, —C(O)— and —N(R^{N})—,
where C₃-C₂₀-cycloalkyl and heterocycloalkyl may be interrupted by one or more CO groups and/or may be substituted by one or more identical or different radicals R^{4b}, where C₆-C₂₀-aryl and heteroaryl may be substituted by one or more identical or different radicals R^{4c}, where
R^{4a} is F, Cl, Br, I, CN, SR¹⁹, OR²⁰, COR²¹, COOR²², CONR²³R²⁴, C₃-C₂₀-cycloalkyl, heterocycloalkyl where the 2 last-mentioned radicals may be interrupted by one or more CO groups and/or may be substituted by one or more identical or different radicals R^{4ab},
heteroaryl or C₆-C₁₀-aryl, where the two last-mentioned radicals may be substituted by one or more identical or different radicals R^{4ac}, where
R^{4ab} is as defined in claim 1,
R^{4ac} is as defined in claim 1, and
in addition, if 2 radicals R^{4a} are geminally bound, the 2 radicals R^{4a} together may also form an N-hydroxyimino group;
R^{4b} is F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀aryl or heteroaryl, where the two last-mentioned radicals may be substituted by one or more identical or different radicals R^{4bc}, where
R^{4bc} is as defined in claim 1,
R^{4c} is F, Cl, Br, I, C₁-C₁₂-alkyl, C₁-C₁₂-haloalkyl, CN, NO₂, SR¹⁹, OR²⁰, COR²¹, COOR²², CONR²³R²⁴, phenyl, C₃-C₁₀-cycloalkyl or heterocycloalkyl, where two last-mentioned radicals may be interrupted by one or more CO groups;
where R^{N}, R¹¹; R¹², R¹³, R¹⁴, R¹⁹, R²⁰, R²¹, R²², R²³ and R²⁴ are as defined in claim 1,
and the stereoisomers and tautomers thereof,
except for compounds of the formula (Ia) wherein R¹ is methyl, R² is benzyl, R³ is 4-hydroxyphenyl and R⁴ is n-dodecyl.

23. The compound of claim 22, wherein:
R¹ is selected from C₃-C₁₂-cycloalkyl; C₃-C₁₂-cycloalkyl which is substituted by OR²⁰; C₃-C₁₂-cycloalkyl which is substituted by COR²¹; C₃-C₁₂-cycloalkyl which is substituted by COOR²²; C₃-C₁₂-cycloalkyl which is substituted by CONR²³R²⁴; C₁-C₁₂-alkyl; haloalkyl; C₁-C₁₂-alkyl which is substituted by 5- or 6-membered saturated heterocyclyl; C₁-C₁₂-alkyl which is substituted by OR²⁰; C₁-C₁₂-alkyl which is substituted by COR²¹; C₁-C₁₂-alkyl which is substituted by COOR²²; C₁-C₁₂-alkyl which is substituted by CONR²³R²⁴; the group of the formula A and the group of the formula B, where the group of the formula A and the group of the formula B are as defined in claim 2 and R²⁰, R²¹, R²³ and R²⁴ are as defined in claim 1;
R² and R^{3a} are independently of one another selected from C₁-C₈-alkyl; phenyl-C₁-C₄-alkyl, where the alkyl moiety of phenylalkyl is substituted by benzoyl; naphthyl-C₁-C₄-alkyl; (5- or 6-membered saturated heterocyclyl)-C₁-C₄-alkyl, phenoxy-C₁-C₄-alkyl, benzoyl-C₁-C₄-alkyl, C₁-C₄-alkoxy-C(═O)—C₁-C₄-alkyl, C₁-C₄-alkoxy-C₁-C₄-alkoxy-C(═O)—C₁-C₄-alkyl, benzyloxycarbonyl-C₁-C₄-alkyl, phenyl and phenyl-C₁-C₆-alkyl, where the aromatic ring in the two last-mentioned radicals may be substituted by 1, 2, 3, 4 or 5 radicals which, independently of one another, are selected from the group consisting of F, Cl, Br, I, OH, NO₂, C₁-C₁₀-alkyl, C₁-C₄-alkoxy, heterocyclyl-C₁-C₄-alkoxy, C₁-C₄-haloalkylcarbonyloxy, hydroxy-C₁-C₄-alkoxycarbonyl, C₁-C₄-alkoxycarbonyl, alkoxy-C₁-C₄-alkoxycarbonyl, benzyloxycarbonyl and C(═O)N(C₁-C₈-alkyl)₂;
or
R¹ and R² or R² and R³ together with the sulfur atom to which they are bound, form a 5- or 6-membered, saturated heterocycle, which may be fused to one phenyl ring; and
R⁴ is selected from NR¹¹R¹²; —N═CR¹³R¹⁴;
C₁-C₂-alkyl which is substituted by one or more identical or different radicals selected from F, Cl, Br, I, SR¹⁹, OR²⁰, COOR²², thienyl, benzoyl, N-hydroxyimino, phenyl or naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴;
C₃-C₁₂-alkyl, C₂-C₁₂-alkenyl, where the two last-mentioned radicals may be substituted by one or more F, Cl, Br, I, OR²⁰, COR²¹, COOR²², heterocyclyl, phenyl or naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴;
C₃-C₁₂-cycloalkyl, which may be substituted by one or more C₁-C₁₂-alkyl; and
phenyl, which may be is substituted by one or more C₁-C₁₂-alkyl, F, Cl, Br, I, NO₂ or COOR²²,
where R^{N}, R¹¹, R¹², R¹³, R¹⁴, R¹⁹, R²⁰, R²¹, R²², R²³ and R²⁴ are as defined in claim 1.

24. A compound of the formula (Ib): 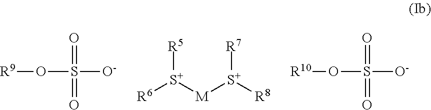
wherein:
R⁵, R⁶, R⁷ and R⁸ are as defined in claim 1;
R⁹ and R¹⁰ are as defined in claim 1; and
M is as defined in claim 1
and the stereoisomers and tautomers thereof,
except for compounds of the formula (Ib) wherein R⁵, R⁶, R⁷ and R⁸ are each ethyl, M is 1,4-CH₂—C₆H₄—CH₂ and R⁹ and R¹⁰ are each n-dodecyl.

25. The compound of claim 24, wherein:
R⁵, R⁶, R⁷ and R⁸ are independently of one another selected from —NR¹¹R¹²; —N═CR¹³R¹⁴; C₁-C₁₂-alkyl, C₂-C₁₂-alkenyl, where the two last-mentioned radicals may be substituted by one or more identical or different radicals selected from F, Cl, Br, I, OR²⁰, COR²¹, COOR²², heterocyclyl, phenyl and naphthyl, where the aromatic ring of the two last-mentioned radicals may be substituted by one or more identical or different radicals selected from F, Cl, Br, I, C₁-C₁₂-alkyl, C₁-C₁₂-haloalkyl, NO₂, SR¹⁹, OR²⁰, COR²¹, COOR²² and CONR²³R²⁴; and phenyl, which may be is substituted by one or more identical or different radicals selected from C₁-C₁₂-alkyl, F, Cl, Br, I, NO₂ or COOR²²;
M is C₁-C₁₂-alkylene, which may be substituted by one or more radicals selected from F, Cl, Br, I, C₁-C₁₂-alkyl, C₁-C₁₂-haloalkyl, CN, SR¹⁹, OR²⁰, COR²¹, COOR²², CONR²³R²⁴, C₆-C₁₀-aryl, heteroaryl or C₆-C₁₀-aryl, and/or may be interrupted by one or more non-adjacent groups selected from —O—, —S—, —O-phenylen and phenylene where the 2 last-mentioned groups may be substituted by one or more identical or different radicals selected from F, Cl, Br, I, C₁-C₁₂-alkyl, C₁-C₁₂-haloalkyl, SR¹⁹, OR²⁰, COR²¹, COOR²², CONR²³R²⁴ and phenyl; and
R⁹ and R¹⁰ are selected from NR¹¹R¹²; —N═CR¹³R¹⁴; C₁-C₁₂-alkyl, C₂-C₁₂-alkenyl, where the two last-mentioned radicals may be substituted by one or more identical or different radicals selected from F, Cl, Br, I, OR²⁰, COR²¹, COOR²², C₃-C₂₀-cycloalkyl, heterocyclyl where the 2 last-mentioned radicals may be interrupted by one or more CO groups, phenyl and naphthyl, where the aromatic ring of the two last-mentioned radicals may be substituted by one or more F, Cl, Br, I, C₁-C₁₂-alkyl, C₁-C₁₂-haloalkyl, NO₂, SR¹⁹, OR²⁰, COR²¹, COOR²² or CONR²³R²⁴, and phenyl, which may be is substituted by one or more C₁-C₁₂-alkyl, F, Cl, Br, I, NO₂ or COOR²².

26. A method for curing a cationic polymerizable composition, the method comprising applying a composition comprising
at least one compound which is capable of undergoing cationic polymerization; and
at least one sulfonium sulfate selected from compounds of the formulae Ia and Ib as defined in claim 1
to a substrate and exposing the composition to treatment with heat.

27. A layer of a liquid crystal display, comprising the heat-curable composition of claim 1.

28. An overcoat layer of a colour filter or an insulating layer or a dielectric layer, the overcoat layer comprising the layer of claim 27.

29. A column spacer, comprising the heat-curable composition of claim 1, said column spacer being suitable for liquid crystal display panels.

30. A composition or article, comprising the heat-curable composition of claim 1, wherein said composition or article is selected from the group consisting of an adhesive, a sealant, an insulating material, a coating composition, an impregnating composition, a laminate, a molding material, a casting material and a substrate for electronic applications.

31. A composition or article, comprising the heat-curable composition of claim 1, wherein said composition or article is selected from the group consisting of a printing ink, a paint, a lacquer, a color-proofing material for printing, a varnish, a potting compound, a dipping resin, a matrix resin, a construction material, a lens and a solder resist composition.
